(19) United States
(12) Patent Application Publication
(10) Pub. No.: US 2021/0013536 A1
(43) Pub. Date: Jan. 14, 2021

(54) MEMBRANES FOR AQUEOUS REDOX FLOW BATTERIES

(71) Applicants: SEPION TECHNOLOGIES, INC., Emeryville, CA (US); FORM ENERGY INC., Somerville, MA (US)

(72) Inventors: Jessica H. GOLDEN, Berkeley, CA (US); Peter David FRISCHMANN, Oakland, CA (US); Brett Anthony HELMS, Oakland, CA (US); Katelyn RIPLEY, Queensbury, NY (US); Jessa SILVER, Roxbury, MA (US); Wei XIE, Everett, MA (US)

(21) Appl. No.: 16/914,012

(22) Filed: Jun. 26, 2020

Related U.S. Application Data
(63) Continuation-in-part of application No. 16/456,571, filed on Jun. 28, 2019.
(60) Provisional application No. 62/951,769, filed on Dec. 20, 2019.
(60) Provisional application No. 62/692,355, filed on Jun. 29, 2018.
(60) Provisional application No. 62/692,414, filed on Jun. 29, 2018.
(60) Provisional application No. 62/716,578, filed on Aug. 9, 2018.

(51) Int. Cl. H01M 8/18; C08G 73/02; H01M 8/0228; H01M 8/08; H01M 8/0221

(52) U.S. Cl. CPC H01M 8/188; C08G 73/0273; C08G 73/0253; H01M 2300/0082; H01M 8/08; H01M 8/0221; H01M 2300/0094; H01M 8/0228

(57) ABSTRACT

The present invention provides a membrane comprising a polyamine polymer. In another embodiment, the present invention provides an electrochemical cell comprising a membrane of the present invention; a positive electrode; and a negative electrode. In another embodiment, the present invention provides a composition comprising a polyamine polymer of Formula J, I or II.

### CROSS-REFERENCES TO RELATED APPLICATIONS

This application (i) claims under 35 U.S.C. § 119(e)(1) the benefit of U.S. Provisional Patent Application No. 62/951,769 entitled “Electrostatic Membranes” filed Dec. 20, 2019; and, (ii) is a continuation-in-part of U.S. patent application Ser. No. 16/456,571 entitled “Aqueous Polysulfide-Based Electrochemical Cell” filed Jun. 28, 2019, which claims under 35 U.S.C. § 119(e)(1) the benefit of U.S. Provisional Patent Application No. 62/692,355 entitled “Aqueous Sulfur-Polysulfide Electrochemical Cell” filed Jun. 29, 2018, U.S. Provisional Patent Application No. 62/692,414 entitled “Polysulfide-Ferrocyanide Electrochemical Cell” filed Jun. 29, 2018, and U.S. Provisional Application No. 62/716,578 entitled “Aqueous Polysulfide-Permanganate Electrochemical Cell” filed Aug. 9, 2018. The entire contents of all five applications are hereby incorporated by reference for all purposes.

### BACKGROUND OF THE INVENTION

The invention herein describes the design and application of polymers including tertiary amine functional groups in the polymer backbone, including Tröger's base (TB) type polymeric membranes of intrinsic microporosity, in order to achieve a product which efficiently sieves ions and particulates by size in an electrolyte or solvent. The present invention describes the incorporation of zwitterionic functionalities by alkylation of the tertiary amine site on TB polymers. Combined with membrane treatment methods such as crosslinking to mitigate swelling and solvent treatment, the present invention decreases the membrane area-specific resistance (ASR) relative to native TB polymers, a metric critical for the economical application of membranes in electrochemical applications, these materials demonstrate low ASR while blocking large ions from permeating the membrane.

Polymers of intrinsic microporosity (PIMs) are a burgeoning class of materials with promise in a variety of applications in which highly selective small-molecule permeability is needed. Rotationally constrained bonds in the backbones of these polymers create kinks in the polymer chains, which result in the formation of free-volume micropores in the solid state. The polymer's microporosity is therefore intrinsic, and generally independent of the membrane wet casting process, unlike in dense materials wherein pores must be engineered into the films during the casting or coating process. Combined with the utilization of low-cost starting materials and a facile step-growth polymerization reaction, a low-cost polymer membrane with high intrinsic microporosity can be achieved.

Tröger's base (TB) polymers are a subset of PIMs wherein the polymer backbone is composed of a repeating TB structural motif (FIG. 1). The benzene rings can be tethered to a linker moiety via either a single bond, or through a fused ring system, and the rings may be substituted by a variety of functional groups, though these are typically restrained to electron donating groups, as the Tröger's base condensation reaction requires an electron rich aromatic ring. Tröger's base polymers and copolymers thereof can be formed by first forming a Tröger's base-containing unit and polymerizing it with a linker moiety, or from the Tröger's base condensation of an aromatic diamine monomer. The synthesis of TB polymers by the latter method is described in the invention by McKeown (U.S. Pat. No. 9,018,270B2). TB polymers combining a high degree of rigidity in the polymer backbone coupled with a high free volume offer excellent size-sieving properties which have been exploited in the literature for the purposes of gas separations. Key to obtaining a high degree of size selectivity in addition to permeability is the rigidity of the polymer backbone. Thus, polymer chains which limit rotation or flexion in the backbone offer better size-sieving properties than equally porous but more flexible polymer materials, as demonstrated with gas separation experiments. The strained, V-shaped TB moiety imparts rigidity due to restricted rotations and a resistance to flexion which gives TB polymers exceptional permeability and size-selectivity. Apparent BET surface areas for known TB polymers and copolymers are presented in FIG. 2, where it can be seen that the more rigid the monomeric unit, the higher, in general, is the apparent BET surface area, an experimental indicator of microporosity. When linker units with rotatable single-bonds (such as o-Tol TB and the three TB-polyimide copolymers) are added, the apparent BET surface area is reduced relative to rigid aromatic linkers.

Another important quality in membranes for size-sieving is mechanical robustness. Mechanical properties key to the application of polymeric materials for membrane separation processes include elongation at break and tensile strength. The commonly employed commercial material Nafion 117 has a tensile strength of 43 MPa and an elongation at break of 225% in the hydrated film. PIM-1, the spirobisindane-based archetypal PIM material has a comparable tensile strength of 43.3-49.7 MPa but is much less elastic, demonstrating an elongation at break of only 10.2-15.8%, and its physical properties deteriorate with chemical modification such as crosslinking, oxidation, or plasma treatment. Polyimides are known for their excellent physical properties, although they are dense materials and typically demonstrate poor permeability; the commercial polyimide Matrimid has a tensile strength of 72.28 MPa and an elongation at break of 19.4%. In TB polymers, the highly rigid ethanoanthrance, triptycene, and spirobisindane linker moieties reduce the mechanical robustness relative to the TB-polyimide copolymers, which take advantage of the combination of the size-sieving abilities of TB polymers and the physical properties of polyimides.

There are a few literature reports which use TB polymers in solution-based separations processes. In each of these cases, the size-sieving properties of this material are displayed in an aqueous environment. Moreover, when in the presence of acid, the tertiary amines intrinsic to the TB backbone are protonated, making the polymer overall cationic. The quaternization of TB polymer at low pH is shown to add a secondary sieving property based on electrostatic screening, wherein the polymer behaves as anion exchange membrane. Alkylation of the TB polymer to form a cationic backbone wherein the tertiary amines have been quaternized is described in the invention by McKeown (U.S. Pat. No. 9,018,270B2).

In a solvent-based application, the uptake of solvent must be considered for its effect on the swelling of the membrane. Logically, a swollen membrane can be expected to have larger pores, and thus the size-sieving effect of the membrane pore size can be diminished with increasing solvent uptake. In aqueous applications, the uptake of water (WU), measured as a % mass increase in the hydrated film versus the dry film, is an indicator of the swelling of pores within the membrane. It has been shown that in methylated quaternized TB membranes, given the same ion exchange capacity (0.81-0.91 mmol/g) and with increasing porosity, the WU significantly increases, from low 8.6% in the essentially non-porous flexible TB derivative DPM-TB, to 36% in the moderately porous o-Tol TB, to 81% in the highly porous Trip-TB. In these systems, non-nucleophilic bases such as Cl⁻ and HCO₃⁻ are shown to migrate through the TB polymer via a vehicular transport mechanism, while nucleophilic bases such as OH⁻ are shown to migrate through both vehicular and Grotthuss transport mechanisms, where the latter mechanism, being thermally activated due to its dependence on molecular rotation, becomes more dominant at higher temperatures. When the ion exchange capacity is low, the cationic sites within the PIM are far apart and therefore require more thermal energy to induce enough molecular motion for their hydration shells to overlap. There is a rapid increase in conductivity of o-Tol TB at 50° C., which is thought to be due to the barrier to chain mobility being overcome enough for the hydration shells of adjacent quaternized ammonium groups to overlap, facilitating Grotthuss-type anion hopping. At 30° C., the o-Tol TB material demonstrated a hydroxide conductivity of σ_{OH}_{^{−}}=23.5 mS/cm. In an analogous report, a multicationic alkylation procedure is employed which affects simultaneous alkylation and crosslinking upon a DMP/o-Tol TB copolymer, resulting in hydroxide conductivity as high as 104 mS/cm at elevated temperature. Size-selective experiments demonstrating pore size integrity have not yet been demonstrated in the literature, and it has further been shown that under alkaline aqueous conditions, TB polymer membranes decompose over time, becoming less rigid and less ion-conductive. In order to achieve a stable, long-lived membrane for commercial application under the conditions of alkaline aqueous ion-sieving, simultaneous improvements to membrane stability, porosity, and conductivity must be established.

Aqueous electrochemical cells demand much of their membranes. In order to affect commercial utility in the intended embodiment, the membrane must be inexpensive, it must be chemically robust under aqueous electrolytic conditions (usually in either acid or base), it must be mechanically robust enough to endure high pressures from cell assembly and osmotic pressure imbalances across the cell, and most importantly, it must selectively conduct charge-balancing anions and screen against active species to mitigate capacity fade.

In the present invention, a family of TB polymer membranes designed to meet the above criteria for use in alkaline aqueous electrolyte is described. These materials demonstrate stable ion selectivity at pH>12, as measured by the retention of ion transport properties, measured using ASR and diffusive permeability (D_{eff}) values, over time. They also exhibit mechanical durability toward the conditions of cell assembly and operation.

The present invention comprises a Tröger's base polymer membrane which is chemically and physically modified in order to affect rapid ion transport.

### BRIEF SUMMARY OF THE INVENTION

In one embodiment, the present invention provides a membrane comprising a polyamine polymer.

In another embodiment, the present invention provides a membrane comprising a quaternary polyamine polymer.

In another embodiment, the present invention provides an electrochemical cell comprising a membrane of the present invention; a positive electrode; and a negative electrode.

In another embodiment, the present invention provides a composition comprising a polyamine polymer of Formula J.

In another embodiment, the present invention provides a composition comprising a quaternary polyamine polymer of Formula I.

In another embodiment, the present invention provides An electrochemical cell comprising: a) a posolyte comprising a positive electrode active material dissolved in an electrolyte; b) a negolyte comprising a polysulfide compound dissolved in an electrolyte; c) an ion-permeable membrane configured to electrically insulate the negolyte from the posolyte; and d) wherein the membrane comprises: (i) a polymer; (ii) a protective layer disposed on a posolyte side of the polymer and configured to reduce oxidation of the polymer by the positive electrode active material; and (iii) wherein the protective layer comprises manganese oxide.

In another embodiment, the present invention provides an electrochemical cell comprising: a) a posolyte comprising a positive electrode active material dissolved in an electrolyte; b) an negolyte comprising a polysulfide compound dissolved in an electrolyte; c) an ion-permeable membrane configured to electrically insulate the negolyte from the posolyte; and d) wherein the membrane comprises an anion exchange membrane (AEM), a cation exchange membrane (CEM), a zwitterionic membrane, a porous membrane with average pore diameter smaller than 10 nanometers, a polybenzimidazole-based membrane, a polysulfone-based membrane, a polyetherketone-based membrane, a membrane including polymers of intrinsic microporosity (PIM), or a combination thereof.

In another embodiment, the present invention provides an electrochemical cell comprising: a) a posolyte comprising a positive electrode active material dissolved in an electrolyte; wherein the positive electrode active material comprises a manganese-based compound; b) a negolyte comprising a polysulfide compound dissolved in an electrolyte; c) an ion-permeable membrane configured to electrically insulate the negolyte from the posolyte; and d) wherein the membrane comprises: (i) a composite membrane comprising an inorganic material and an organic material; and (ii) wherein the organic material comprises a polyether ether ketone (PEEK), a polysulfone, a polystyrene, a polypropylene, a polyethylene, or any combination thereof.

### BRIEF DESCRIPTION OF THE DRAWINGS

FIG. 1 shows Tröger's base (TB) polymers include a Tröger's base structural motif in the backbone of the polymer. The benzene rings can be tethered to a linker moiety via either a single bond, or through a fused ring system, and the rings may be substituted by a variety of functional groups. Tertiary amines may be alkylated as described in the Invention section below to increase conductivity and decrease area-specific resistance (ASR).

FIG. 2 shows TB polymers with their reported apparent BET surface areas.

FIG. 3A-3B shows Nyquist Impedance spectra obtained by potentiometric electrochemical impedance spectroscopy of untreated polymer in its pristine state (FIG. 3A), and after soaking for 48 h in 2M NaOH, and a TB membrane which has been expanded by reagent alcohol treatment (FIG. 3B). FIG. 3C shows various solvent treatment effects on the area-specific resistance (ASR) of TB polymer membranes. FIG. 3D shows effects of alcohol treatment are accomplished within 4 hours of treatment and no significant change is observed after 48 hours of refluxing.

FIG. 4 shows TB membranes are hydrophobic and thus have high area-specific resistance (ASR) when untreated. When alkylated with a neutral or anionic ligand (to yield a cationic or zwitterionic membrane, respectively), the ASR decreases significantly, but the permeability of large ions likewise increases. To minimize the permeability of large ions while keeping the ASR low, the membrane can be crosslinked, thus holding the pores to a smaller dimensionality.

FIG. 5 shows ASR vs % electrolyte uptake (by mass) in TB membranes.

FIG. 6 shows a general tertiary-amine containing rigid polymer backbone moiety.

FIG. 7 is a schematic of an electrochemical cell, according to various embodiments of the present disclosure.

FIG. 8 shows sulfonation of PIM-3 with acetyl sulfate to yield a cation exchange polymer. The proton can be exchanged with various cations, affecting solubility and film formation.

FIG. 9A-9B shows alkylation of the tertiary amine in a TB polymer is achieved by refluxing the polymer in reagent alcohol with 3 eq. alkylating agent for 24 hours. In an example FIG. 9A shows dimethyl sulfate was used as the alkylating agent to achieve a cationic polymer. FIG. 9B shows propane sultone was utilized to achieve a zwitterionic (overall neutral) polymer.

FIG. 10 shows diazide and diiodo crosslinkers utilized in the development of crosslinked membranes are illustrated. The reaction schemes leading to crosslinking of example polymer o-Tol TB are shown.

FIG. 11 shows ion transport properties of polymer-MnO₂ composites of the present invention compared to commercially available membranes, via lower diffusive permeability (cm²/s) values.

FIG. 12 shows X-ray spectroscopy images of an example membrane.

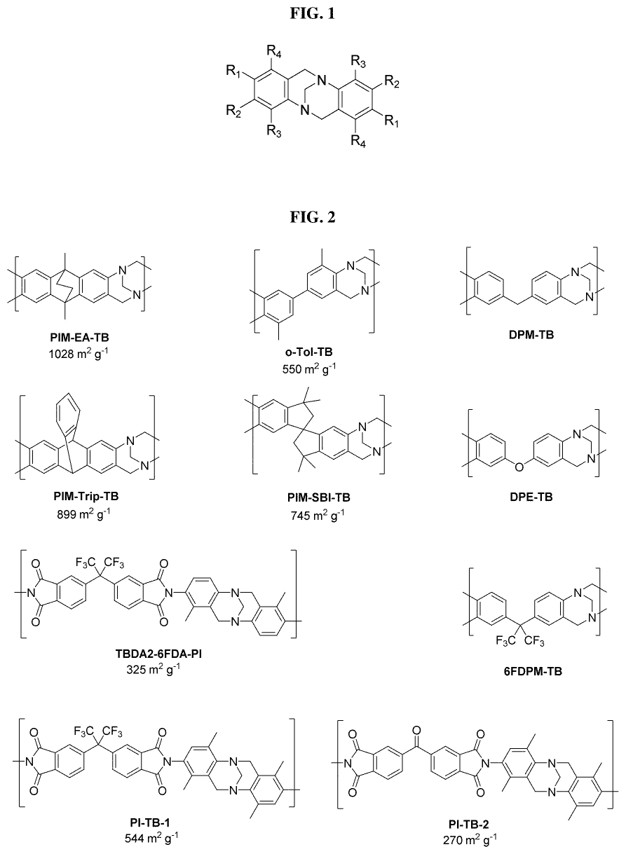

### DETAILED DESCRIPTION OF THE INVENTION

### I. Definitions

Unless specifically indicated otherwise, all technical and scientific terms used herein have the same meaning as commonly understood by those of ordinary skill in the art to which this invention belongs. In addition, any method or material similar or equivalent to a method or material described herein can be used in the practice of the present invention. For purposes of the present invention, the following terms are defined.

As used herein, unless stated otherwise, room temperature is 25° C. And, standard ambient temperature and pressure is 25° C. and 1 atmosphere. Unless expressly stated otherwise all tests, test results, physical properties, and values that are temperature dependent, pressure dependent, or both, are provided at standard ambient temperature and pressure, this would include viscosities.

Generally, the term “about” and the symbol “˜” as used herein unless stated otherwise is meant to encompass a variance or range of ±10%, the experimental or instrument error associated with obtaining the stated value, and preferably the larger of these.

As used herein, unless specified otherwise, the recitation of ranges of values, a range, from about “x” to about “y”, and similar such terms and quantifications, serve as merely shorthand methods of referring individually to separate values within the range. Thus, they include each item, feature, value, amount or quantity falling within that range. As used herein, unless specified otherwise, each and all individual points within a range are incorporated into this specification, and are a part of this specification, as if they were individually recited herein.

As used herein, unless expressly stated otherwise terms such as “at least”, “greater than”, also mean “not less than”, i.e., such terms exclude lower values unless expressly stated otherwise.

The Background of the Invention section is intended to introduce various aspects of the art, which may be associated with embodiments of the present inventions. Thus, the discussion in this section provides a framework for better understanding the present inventions, and is not to be viewed as an admission of prior art.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, processes, compositions, applications, and materials set forth in this specification may be used for various other fields and for various other activities, uses and embodiments. Additionally, these embodiments, for example, may be used with: existing systems, processes, compositions, applications, and materials; may be used with systems, therapies, processes, compositions, applications, and materials that may be developed in the future; and with systems, therapies, processes, compositions, applications, and materials that may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. For example, the components of an embodiment having A, A′ and B and the components of an embodiment having A′, C and D can be used with each other in various combination, e.g., A, C, D, and A. A″ C and D, etc., in accordance with the teaching of this specification. The scope of protection afforded the present inventions should not be limited to a particular embodiment, example, configuration or arrangement that is set forth in a particular embodiment, example, or in an embodiment in a particular figure.

“A,” “an,” or “the” as used herein not only include aspects with one member, but also include aspects with more than one member. For instance, the singular forms “a,” “an,” and “the” include plural referents unless the context clearly dictates otherwise. Thus, for example, reference to “a cell” includes a plurality of such cells and reference to “the agent” includes reference to one or more agents known to those skilled in the art, and so forth.

“Membrane” refers to a layer that is permeable to a first species of the electrolyte while substantially impermeable to a second species of the electrolyte. The membrane can be of any suitable material that can provide the selective permeability, such as polymers of the present invention. “Substantially impermeable” refers to less than 10% of the second species passing through the membrane, or less than 1%, or less than 0.1%, or less than 0.01%, or less than 0.001% of the second species passing through the membrane layer.

“Polymer” refers to a molecule composed of many repeated subunits or monomers. Polymers can be classified as naturally occurring or synthetic. Examples of synthetic polymers include, but are not limited to, low-density polyethylene, high-density polyethylene, polypropylene, polystyrene, polyvinyl chloride, polyacrylonitrile, phenol formaldehyde resin, polychloroprene, neoprene, polyamide, nylon, polyvinyl butyral, polytetrafluoroethlene, Teflon, Tröger's base, synthetic rubber, silicone, thermoplastic polyurethanes, polysiloxane, and polyphosphazene.

“Quaternary polyamine” refers to an organic compound with two or more nitrogen groups, wherein at least one nitrogen is quaternary, i.e., having four covalent bonds.

“Quaternary polyamine polymer” refers to a polymer composed of subunits each having two or more nitrogen groups, and wherein at least one nitrogen is quaternary. For example, quaternary polyamine polymers of the present invention can include, but are not limited to, Tröger's base polymers.

“Copolymer” refers to a polymer comprising two or more monomers. Copolymers are classified based on the arrangement of the monomer units along the chain. Copolymers of the present invention can be linear or branched copolymers. Linear copolymers have a single main chain and include, but are not limited to, alternating copolymers, block copolymers, and statistical copolymers. Alternating copolymers have regular alternating A and B monomer units, and is often described by the formula -(-A-B-)ₙ-, wherein n is an integer. Block copolymers comprise two or more homopolymer subunits covalently linked together. For example, diblock copolymers have two distinct homopolymer subunits and triblock copolymers have three homopolymer subunits. Statistical copolymers comprises a sequence of monomer residues, and are commonly referred to as random copolymers. Branched copolymers have a single main chain with one or more polymeric side chains, and include, but are not limited to, grafted copolymers, and star shaped copolymers. Grafted copolymers have a main chain formed from one type of monomer and branches are formed from a second monomer. Star shaped copolymers have multiple polymer chains connected to a center core.

“Zwitterion” or “Zwitterionic” refers to a molecule with two or more functional groups, of which at least one has a positive electrical charge and one has a negative electrical charge, and the net charge of the entire molecule is zero.

“Monoatomic ions” refers to ions consisting of exactly one atom.

“Monovalent ions” refers to ions with a valence of one, which can form one covalent bond.

“Polyvalent ions” refer to ions with a valence of two or more, which can form two or more covalent bonds. Polyvalent ions include, but are not limited to polysulfide in its various forms such as S₂²⁻, S₄²⁻, S₈²⁻.

“Ionic transition metal” refers to elements of the periodic table that are in the transition metal block and are either negatively or positively charged as a result of having more or fewer electrons in the valence shell than is present for the neutral metallic element. Transition metals useful in the present invention include, but are not limited to, Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. One of skill in the art will appreciate that the metals described above can each adopt several different oxidation states, all of which are useful in the present invention. In some instances, the most stable oxidation state is formed, but other oxidation states are useful in the present invention.

“Acid/base dissociation products of water” refers to H₃O⁺ and ⁻OH ions respectively.

“Permeate” refers to the ability of a compound, ion, molecule, or atom to diffuse through a permeable barrier, such as a membrane of the present invention.

“Diffusive permeability” refers to the rate it takes a compound, ion, molecule or atom to diffuse through a permeable barrier, such as a membrane of the present invention. Diffusive permeability can be reported as area per time, such as, but not limited to cm²/s. Diffusive permeability can be measured by methods known by one of skill in the art. For example, diffusive permeability can be measured by feeding one side of a measurement cell with a test gas or compound, and the permeated gas or compound is carried to the detector by a sweep gas. In another example, diffusive permeability can be measured through intermittent contact. This method involves taking a sample of the test chemical and placing it on the surface of the material whose permeability is being observed while adding or removing specific amounts of the test chemical. After a known amount of time, the material is analyzed to find the concentration of the test chemical present through its structure. The amount of time and analysis of the test material leads to determining the cumulative permeation of the test chemical.

“Conductivity” refers to a material's ability, such as the membrane of the present invention, to conduct electric current. Conductivity can be reported as Siemens per distance, such as, but not limited to Siemens per meter (S/m), and milliSiemens per centimeter (mS/cm). Conductivity of a solution of electrolyte can be measured by determining the resistance of the solution between two flat or cylindrical electrodes separated by a fixed distance. The resistance can be measured by a conductivity meter.

“Electrolyte” refers to an aqueous or non-aqueous ionic solution of the electrochemical application, comprising ions such as metal ions and protons as well as anions, which provides ionic communication between the positive and negative electrodes.

“Electrochemical applications” refers to processes wherein an electric current is produced by a chemical reaction, wherein electrons are transferred directly between molecules and/or atoms in oxidation-reduction reactions.

“Alkyl” refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₃₋₁₀, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted.

“Alkylene” refers to a straight or branched, saturated, aliphatic radical having the number of carbon atoms indicated, and linking at least two other groups, i.e., a divalent hydrocarbon radical. can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₃₋₁₀, C₄₋₅, C₄₋₆ and C₅₋₆. The two moieties linked to the alkylene can be linked to the same atom or different atoms of the alkylene group. For instance, a straight chain alkylene can be the bivalent radical of —(CH₂)—, where n is 1, 2, 3, 4, 5 or 6. Representative alkylene groups include, but are not limited to, methylene, ethylene, propylene, isopropylene, butylene, isobutylene, sec-butylene, pentylene and hexylene. Alkylene groups can be substituted or unsubstituted.

“Alkenyl” refers to a straight chain or branched hydrocarbon having at least 2 carbon atoms and at least one double bond. Alkenyl can include any number of carbons, such as C₂, C₂₋₃, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₆, C₅, C₅₋₆, and C₆. Alkenyl groups can have any suitable number of double bonds, including, but not limited to, 1, 2, 3, 4, 5 or more. Examples of alkenyl groups include, but are not limited to, vinyl (ethenyl), propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. Alkenyl groups can be substituted or unsubstituted.

“Alkenylene” refers to an alkenyl group, as defined above, linking at least two other groups, i.e., a divalent hydrocarbon radical. The two moieties linked to the alkenylene can be linked to the same atom or different atoms of the alkenylene. Alkenylene groups include, but are not limited to, ethenylene, propenylene, isopropenylene, butenylene, isobutenylene, sec-butenylene, pentenylene and hexenylene. Alkenylene groups can be substituted or unsubstituted.

“Alkynyl” refers to either a straight chain or branched hydrocarbon having at least 2 carbon atoms and at least one triple bond. Alkynyl can include any number of carbons, such as C₂, C_{2_3}, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₆, C₅, C₅₋₆, and C₆. Examples of alkynyl groups include, but are not limited to, acetylenyl, propynyl, 1-butynyl, 2-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. Alkynyl groups can be substituted or unsubstituted.

“Alkynylene” refers to an alkynyl group, as defined above, linking at least two other groups, i.e., a divalent hydrocarbon radical. The two moieties linked to the alkynylene can be linked to the same atom or different atoms of the alkynylene. Alkynylene groups include, but are not limited to, ethynylene, propynylene, isopropynylene, butynylene, sec-butynylene, pentynylene and hexynylene. Alkynylene groups can be substituted or unsubstituted.

“Alkoxy” refers to an alkyl group having an oxygen atom that connects the alkyl group to the point of attachment: alkyl-O—. As for alkyl group, alkoxy groups can have any suitable number of carbon atoms, such as C₁₋₆. Alkoxy groups include, for example, methoxy, ethoxy, propoxy, iso-propoxy, butoxy, 2-butoxy, iso-butoxy, sec-butoxy, tert-butoxy, pentoxy, hexoxy, etc. The alkoxy groups can be further substituted with a variety of substituents described within. Alkoxy groups can be substituted or unsubstituted.

“Halogen” refers to fluorine, chlorine, bromine and iodine.

“Haloalkyl” refers to alkyl, as defined above, where some or all of the hydrogen atoms are replaced with halogen atoms. As for alkyl group, haloalkyl groups can have any suitable number of carbon atoms, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₃₋₁₀, C₄₋₅, C₄₋₆ and C₅₋₆. For example, haloalkyl includes trifluoromethyl, fluoromethyl, etc. In some instances, the term “perfluoro” can be used to define a compound or radical where all the hydrogens are replaced with fluorine. For example, perfluoromethyl refers to 1,1,1-trifluoromethyl.

“Haloalkoxy” refers to an alkoxy group where some or all of the hydrogen atoms are substituted with halogen atoms. As for an alkyl group, haloalkoxy groups can have any suitable number of carbon atoms, such as C₁₋₆. The alkoxy groups can be substituted with 1, 2, 3, or more halogens. When all the hydrogens are replaced with a halogen, for example by fluorine, the compounds are per-substituted, for example, perfluorinated. Haloalkoxy includes, but is not limited to, trifluoromethoxy, 2,2,2,-trifluoroethoxy, perfluoroethoxy, etc.

“Cycloalkyl” refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norbornane, [2.2.2]bicyclooctane, decahydronaphthalene and adamantane. Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted.

“Bicyclic cycloalkyl” refers to a cycloalkyl which comprises two joined rings. Representative bicyclic cycloalkyls include spirocyclic compounds, wherein two rings share only one single atom, fused bicyclic compounds, wherein two rings share two adjacent atoms, and bridged bicyclic compounds, wherein the two rings share three or more atoms. Bicyclic cycloalkyls contain from 5 to 12 ring atoms, or the number of atoms indicated. Bicyclic cycloalkyls can include any number of carbons, such as C₅₋₂₀, C₆₋₂₀, C₇₋₂₀, C₈₋₂₀, C₉₋₂₀, C₁₀₋₂₀, C₆₋₁₂, C₇₋₁₂, C₈₋₁₂, C₉₋₁₂, or C₁₀₋₁₂. Spirocyclic compounds can include any number of carbons, such as C₅₋₂₀, C₆₋₂₀, C₇₋₂₀, C₈₋₂₀, C₅₋₁₂, C₆₋₁₂, C₇₋₁₂, and C₈₋₁₂.

“Aryl” refers to an aromatic ring system having any suitable number of ring atoms and any suitable number of rings. Aryl groups can include any suitable number of ring atoms, such as, 6, 7, 8, 9, 10, 11, 12, 13, 14, 15 or 16 ring atoms, as well as from 6 to 10, 6 to 12, or 6 to 14 ring members. Aryl groups can be monocyclic, fused to form bicyclic or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted.

“Arylene” refers to an aryl group, as defined above, linking at least two other groups. The two moieties linked to the aryl can be linked to the same atom or different atoms of the aryl. Arylene groups can be substituted or unsubstituted.

“Heteroaryl” refers to a monocyclic or fused bicyclic or tricyclic aromatic ring assembly containing 5 to 16 ring atoms, where from 1 to 5 of the ring atoms are a heteroatom such as N, O or S. Additional heteroatoms can also be useful, including, but not limited to, B, Al, Si and P. The heteroatoms can also be oxidized, such as, but not limited to, —S(O)— and —S(O)₂—. Heteroaryl groups can include any number of ring atoms, such as, 5 to 6, 5 to 8, 6 to 8, 5 to 9, 5 to 10, 5 to 11, or 5 to 12 ring members. Any suitable number of heteroatoms can be included in the heteroaryl groups, such as 1, 2, 3, 4, or 5, or 1 to 2, 1 to 3, 1 to 4, 1 to 5, 2 to 3, 2 to 4, 2 to 5, 3 to 4, or 3 to 5. Heteroaryl groups can have from 5 to 8 ring members and from 1 to 4 heteroatoms, or from 5 to 8 ring members and from 1 to 3 heteroatoms, or from 5 to 6 ring members and from 1 to 4 heteroatoms, or from 5 to 6 ring members and from 1 to 3 heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted.

The heteroaryl groups can be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinoazoline, cinnoline includes 3- and 4-cinnoline, benzothiophene includes 2- and 3-benzothiophene, and benzofuran includes 2- and 3-benzofuran.

Some heteroaryl groups include those having from 5 to 10 ring members and from 1 to 3 ring atoms including N, O or S, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, isoxazole, indole, isoindole, quinoline, isoquinoline, quinoxaline, quinazoline, phthalazine, cinnoline, benzothiophene, and benzofuran. Other heteroaryl groups include those having from 5 to 8 ring members and from 1 to 3 heteroatoms, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, and isoxazole. Some other heteroaryl groups include those having from 9 to 12 ring members and from 1 to 3 heteroatoms, such as indole, isoindole, quinoline, isoquinoline, quinoxaline, quinazoline, phthalazine, cinnoline, benzothiophene, benzofuran and bipyridine. Still other heteroaryl groups include those having from 5 to 6 ring members and from 1 to 2 ring atoms including N, O or S, such as pyrrole, pyridine, imidazole, pyrazole, pyrazine, pyrimidine, pyridazine, thiophene, furan, thiazole, isothiazole, oxazole, and isoxazole.

Some heteroaryl groups include from 5 to 10 ring members and only nitrogen heteroatoms, such as pyrrole, pyridine, imidazole, pyrazole, triazole, pyrazine, pyrimidine, pyridazine, triazine (1,2,3-, 1,2,4- and 1,3,5-isomers), indole, isoindole, quinoline, isoquinoline, quinoxaline, quinazoline, phthalazine, and cinnoline. Other heteroaryl groups include from 5 to 10 ring members and only oxygen heteroatoms, such as furan and benzofuran. Some other heteroaryl groups include from 5 to 10 ring members and only sulfur heteroatoms, such as thiophene and benzothiophene. Still other heteroaryl groups include from 5 to 10 ring members and at least two heteroatoms, such as imidazole, pyrazole, triazole, pyrazine, pyrimidine, pyridazine, triazine (1,2,3-, 1,2,4- and 1,3,5-isomers), thiazole, isothiazole, oxazole, isoxazole, quinoxaline, quinazoline, phthalazine, and cinnoline.

“Heteroarylene” refers to a heteroaryl group, as defined above, linking at least two other groups. The two moieties linked to the heteroaryl are linked to different atoms of the heteroaryl. Heteroarylene groups can be substituted or unsubstituted.

The groups defined above can optionally be substituted by any suitable number and type of substituents. Representative substituents include, but are not limited to, halogen, haloalkyl, haloalkoxy, —OR′, ═O, —OC(O)R′, —(O)R′, —O₂R′, —ONR′R″, —OC(O)NR′R″, ═NR′, ═N—OR′, —NR′R″, —NR″C(O)R′, —NR′—(O)NR″R′″, —NR″C(O)OR′, —NH—(NH₂)═NH, —NR′C(NH₂)═NH, —NH—(NH₂)═NR′, —SR′, —S(O)R′, —S(O)₂R′, —S(O)₂NR′R″,—NR'S(O)₂R″, —N₃ and —NO₂. R′, R″ and R′″ each independently refer to hydrogen, unsubstituted alkyl, such as unsubstituted C₁₋₆ alkyl. Alternatively, R′ and R″, or R″ and R′″, when attached to the same nitrogen, are combined with the nitrogen to which they are attached to form a heterocycloalkyl or heteroaryl ring, as defined above.

“Crosslinker” refers to a chemical moiety that links the compound of the present invention, such as a first monomer unit on a first polymer chain, to another compound, such as a second monomer unit, on a second polymer chain. The crosslinkers useful in the present invention include, but are not limited to alkylene, haloalkylene, bis(benzylidene) cyclohexanone derivatives, and stilbene derivatives. One of skill in the art will appreciate that other types of crosslinkers are useful in the present invention.

“Linker” refers to a chemical moiety that links one part of the composition or monomer to another functional group. Linkers useful in the present invention can be up to 30 carbon atoms in length. The linkers useful in the present invention include, but are not limited to, alkylenes, haloalkylenes, amides, amines, esters, carbamates, ureas, thioethers, thiocarbamates, thiocarbonate and thioureas. One of skill in the art will appreciate that other types of bonds are useful in the present invention.

“Electrochemical cell” refers to a device capable of either generating electrical energy from chemical reactions or using electrical energy to cause chemical reactions. The electrochemical cell may comprise a positive electrode and a negative electrode.

“Positive electrode” refers to an electrode from which a conventional current leaves a polarized electrical device. In a galvanic cell, the positive electrode is the electrode at which the reduction reaction occurs.

“Negative electrode” refers to an electrode from which a conventional current enters into a polarized electrical device. In a galvanic cell, the negative electrode is the electrode at which the oxidation reaction occurs.

“Posolyte” refers to positive electrode material dissolved in an electrolyte. It is a synonym of catholyte.

“Negolyte” refers to negative electrode material dissolved in an electrolyte. It is a synonym of anolyte.

“Urethane” refers to a chemical moiety with the following formula:

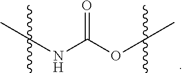 [SMILES: *NC(=O)O*]

“Amide” refers to a chemical moiety with the following formula:

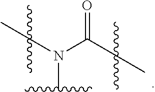 [SMILES: *C(=O)N(*)*]

“Sulfone” refers to a chemical moiety with the following formula:

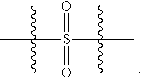 [SMILES: *S(*)(=O)=O]

“Ester” refers to a chemical moiety with the following formula:

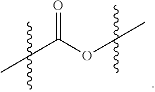 [SMILES: *OC(*)=O]

“Ether” refers to a chemical moiety with the following formula:

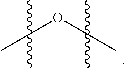 [SMILES: *O*]

“Organic solvent” refers to water-miscible or water-immiscible solvents capable of dissolving either or both of water-soluble and water-insoluble organic compounds. Organic solvents useful in the present invention include, but are not limited to, chloroform, dichloroethane, dichloromethane, carbon tetrachloride, acetone, diethylether, and alcohols. Examples of alcohols useful in the present invention include, but are not limited to, methanol, ethanol, propanol, and isopropanol. One of skill in the art will appreciate that other organic solvents are useful in the present invention.

### II. Compositions

The present invention provides compositions of Formula (J), (I) and (II).

In some embodiments, the present invention provides a composition comprising a polyamine polymer of Formula J:

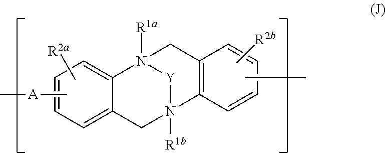

wherein: Y is absent or —CH₂—; R^{1a} and R^{1b} bare each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

The polyamine polymer of Formula (J) can be a secondary, tertiary or quaternary polyamine polymer. In some embodiments, the polyamine polymer is a secondary polyamine polymer. In some embodiments, the polyamine polymer is a tertiary polyamine polymer. In some embodiments, the polyamine polymer is a quaternary polyamine polymer.

In some embodiments, Y is —CH₂—. In some embodiments, the present invention provides a composition comprising a quaternary polyamine polymer of Formula I:

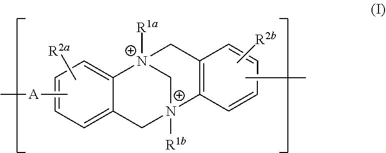

wherein: R^{1a} and R^{1b} are each independently absent, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

In some embodiments, Y is absent. In some embodiments, the present invention provides a composition comprising a quaternary polyamine polymer of Formula II:

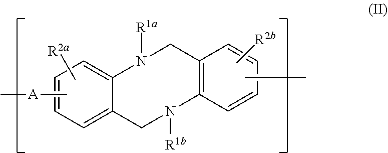

wherein: R^{1a} and R^{1b} are each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

R^{1a} and R^{1b} can be absent, or any suitable chemical moiety, including hydrophilic groups, hydrophobic groups, or amphiphilic groups; alternatively, R^{1a} and R^{1b} on different polymers can combine to form a crosslinker. In some embodiments, R^{1a} and R^{1b} can independently be absent, hydrogen, alkyl, alkenyl, alkynyl, or haloalkyl. In some embodiments, R^{1a} and R^{1b} can independently be absent, alkyl, alkenyl, alkynyl, or haloalkyl. In some embodiments, R^{1a} and R^{1b} are each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; alternatively, R^{1a} and R^{1b} on different polymers can combine to form a crosslinker. In some embodiments, R^{1a} and R^{1b} are each independently absent, C₁₋₆ alkyl, -L¹-S(O)₂O⁻, -L¹-C(O)O⁻, or -L¹-P(O)₂O⁻, such that at least one of R^{1a} and R^{1b} is C₁₋₆alkyl, -L¹-S(O)₂O⁻, -L¹-C(O)O⁻, or -L¹-P(O)₂O⁻; alternatively, R^{1a} and R^{1b} on different polymers can combine to form a crosslinker.

In some embodiments, R^{1a} and R^{1b} are each independently absent, hydrogen, C₁₋₃ alkyl, or -L¹-S(O)₂O⁻, and L¹ is a C₂₋₄ alkylene; alternatively, R^{1a} and R^{1b} on different polymers can combine to form a crosslinker, wherein the crosslinker is C₃₋₁₀ alkyl or C₃₋₁₀ haloalkyl. In some embodiments, R^{1a} and R^{1b} are each independently absent, C₁₋₃ alkyl, or -L¹-S(O)₂O⁻, and L¹ is a C₂₋₄ alkylene; alternatively, R^{1a} and R^{1b} on different polymers can combine to form a crosslinker, wherein the crosslinker is C₃₋₁₀ alkyl or C₃₋₁₀ haloalkyl.

In some embodiments, R^{1a} and R^{1b} are independently absent, hydrogen, methyl, ethyl, propyl, butyl, iso-butyl, sec-butyl, tert-butyl, pentyl, or hexyl. In some embodiments, R^{1a} and R^{1b} are independently absent, methyl, ethyl, propyl, butyl, iso-butyl, sec-butyl, tert-butyl, pentyl, or hexyl. In some embodiments, R^{1a} and R^{1b} are independently absent, hydrogen, methyl, ethyl, or propyl. In some embodiments, R^{1a} and R^{1b} are independently absent, methyl, ethyl, or propyl.

In some embodiments, each L¹ can be any suitable linker. In some embodiments, each L¹ is independently C₁₋₆ alkylene. In some embodiments, each L¹ can be methylene, ethylene, propylene, butylene, isobutylene, sec-butylene, pentylene, and hexylene. In some embodiments, L¹ is a C₂₋₄ alkylene. In some embodiments, L¹ is —CH₂CH₂CH₂—.

In some embodiments, R^{1a} and R^{1b} on different polymers combine to form a crosslinker, wherein the crosslinker is C₃₋₁₀ alkylene or C₃₋₁₀ haloalkylene. In some embodiments, the crosslinker is

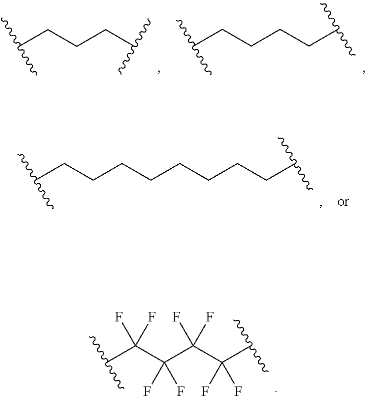 [SMILES: *CCC* ; *CCCC* ; *CCCCCCCC* ; *C(F)(F)C(F)(F)C(F)(F)C(*)(F)F]

In some embodiments, R^{1a} and R^{1b} are each independently absent, hydrogen, methyl, or —CH₂CH₂CH₂S(O)₂O⁻; alternatively, R^{1a} and R^{1b} on different polymers can combine to form a crosslinker, wherein the crosslinker is

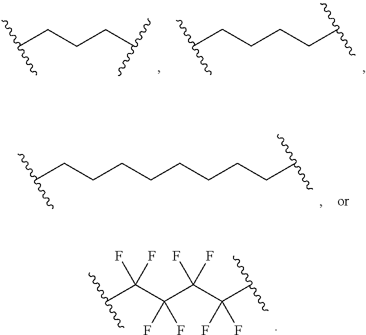 [SMILES: *CCC* ; *CCCC* ; *CCCCCCCC* ; *C(F)(F)C(F)(F)C(F)(F)C(*)(F)F]

In some embodiments, R^{1a} and R^{1b} bare each independently absent, methyl, or —CH₂CH₂CH₂S(O)₂O⁻; alternatively, R^{1a} and R^{1b} on different polymers can combine to form a crosslinker, wherein the crosslinker is

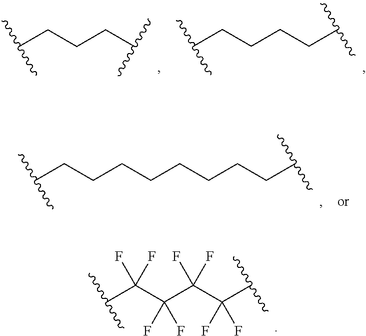 [SMILES: *CCC* ; *CCCC* ; *CCCCCCCC* ; *C(F)(F)C(F)(F)C(F)(F)C(*)(F)F]

In some embodiments, R^{1a} and R^{1b} on different polymers can combine to form a crosslinker, wherein the crosslinker is

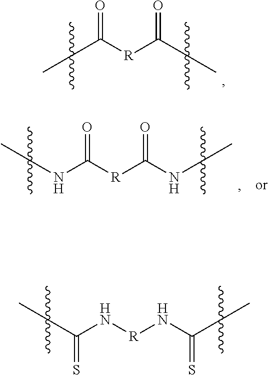

wherein R is C₂₋₁₀ alkylene, poly(ethylene glycol), arylene or heteroarylene.

In some embodiments, R^{1a} and R^{1b} are each independently absent, hydrogen, methyl, or —CH₂CH₂CH₂S(O)₂O⁻; alternatively, R^{1a} and R^{1b} on different polymers can combine to form a crosslinker, wherein the crosslinker is

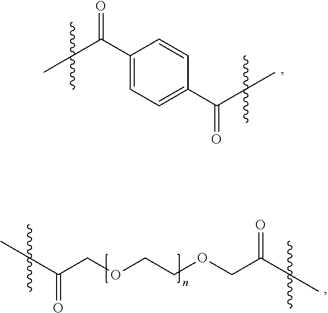

wherein n=1-12.

R^{2a} and R^{2b} can be any suitable chemical moiety, including hydrophilic groups, hydrophobic groups, or amphiphilic groups; alternatively R^{2a} and R^{2b} on different polymers can combined to form a crosslinker. In some embodiments, R^{2a} and R^{2b} can independently be alkyl, alkenyl, alkynyl, haloalkyl, S(O)₂O⁻, or C(O)O⁻. In some embodiments, R^{2a} and R^{2b} are each independently C₁₋₆ alkyl or C(O)O⁻; alternatively, R^{2a} and R^{2b} on different polymers can combine to form a crosslinker.

In some embodiments, R^{2a} and R^{2b} are each independently C₁₋₃ alkyl. In some embodiments, R^{2a} and R^{2b} are each independently methyl, ethyl, propyl, butyl, iso-butyl, sec-butyl, tert-butyl, pentyl, or hexyl. In some embodiments, R^{2a} and R^{2b} are each independently absent, methyl, ethyl, or propyl.

In some embodiments, R^{2a} and R^{2b} on different polymers combine to form a crosslinker, wherein the crosslinker is C₃₋₁₀ alkylene, or C₃₋₁₀ haloalkylene. In some embodiments, the crosslinker is

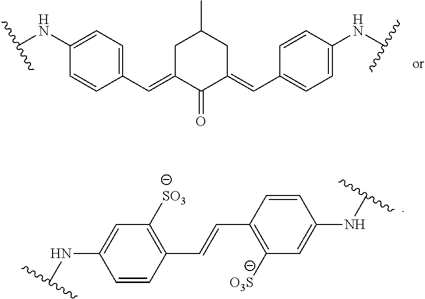

In some embodiments, R^{2a} and R^{2b} are each independently C₁₋₃ alkyl; alternatively, R^{2a} and R^{2b} on different polymers can combine to form a crosslinker, wherein the crosslinker is C₃₋₁₀ alkylene, C₃₋₁₀ haloalkylene,

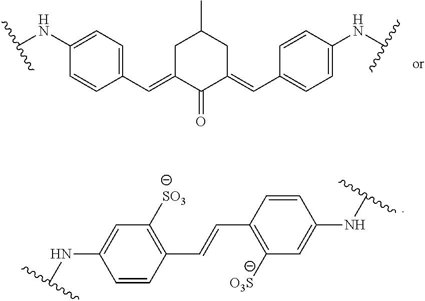

In some embodiments, R^{2a} and R^{2b} are each independently methyl; alternatively, R^{2a} and R^{2b} on different polymers can combine to form a crosslinker, wherein the crosslinker is

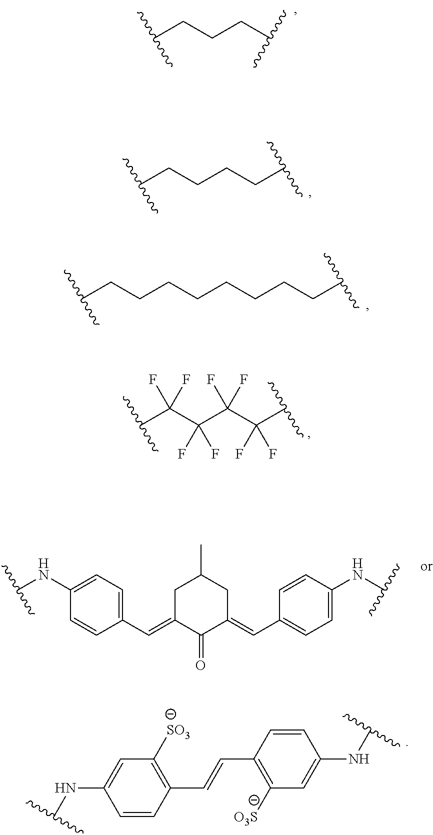

In some embodiments, A is a bond, optionally substituted C₁₋₆ alkylene, urethane, amide, sulfone, ester, ether, —O—, a linker, or combined with the adjacent rings to form an optionally substituted C₆₋₂₀ bicyclic cycloalkyl.

In some embodiments, A is a C₁₋₆ alkylene. In some embodiments, A is a methylene, ethylene, propylene, or butylene. In some embodiments, the C₁₋₆ alkylene can be substituted with any suitable number of halogen, haloalkyl, or haloalkoxy.

In some embodiments, A can be an urethane with the following formula:

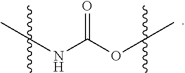 [SMILES: *NC(=O)O*]

In some embodiments, A can be an amide with the following formula:

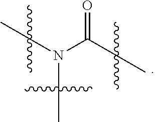 [SMILES: *C(=O)N(*)*]

In some embodiments, A can be a sulfone with the following formula:

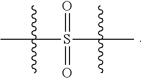 [SMILES: *S(*)(=O)=O]

In some embodiments, A can be an ester with the following formula:

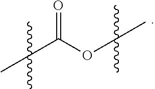 [SMILES: *OC(*)=O]

In some embodiments, A can be an ether with the following formula:

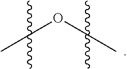 [SMILES: *O*]

In some embodiments, the linker is

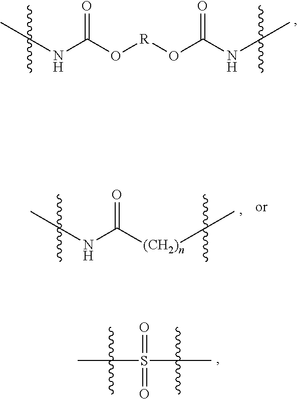

wherein R is a C₁₋₁₂ alkylene, and n is 0 to 20.

In some embodiments, A is a bond, methylene, ethylene, propylene, butylene, urethane, amide, sulfone, ester, ether,

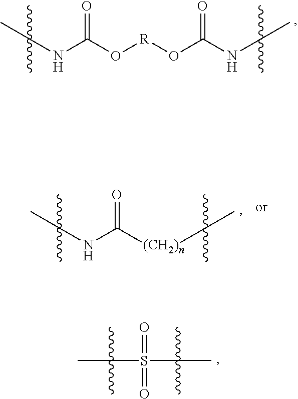

wherein R is a C₁₋₁₂ alkylene, and n is 0 to 20.

In some embodiments, A is a bond,

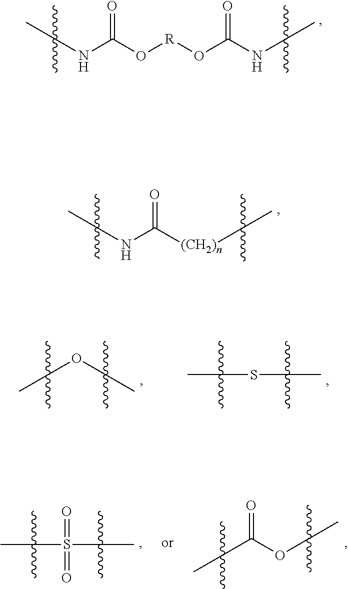

wherein R is a C₁₋₁₂ alkylene, and n is 0 to 20.

In some embodiments, the quaternary polyamine polymer is

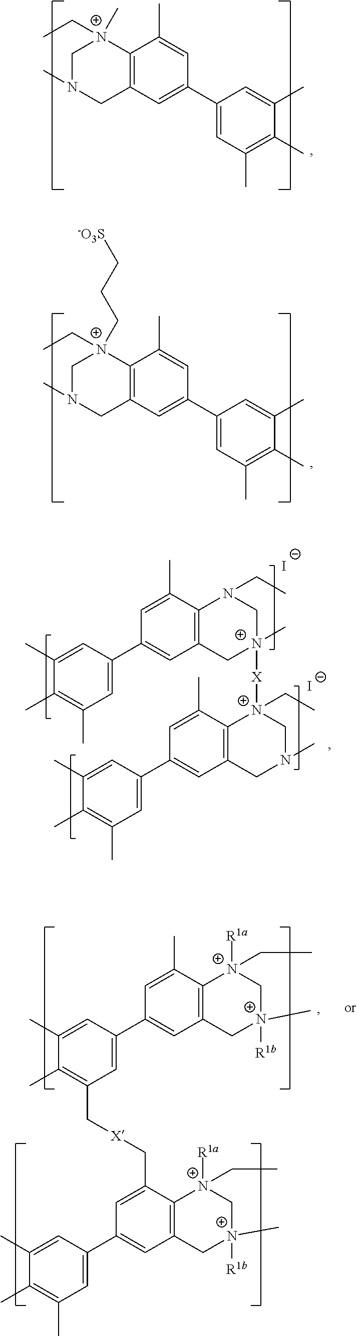

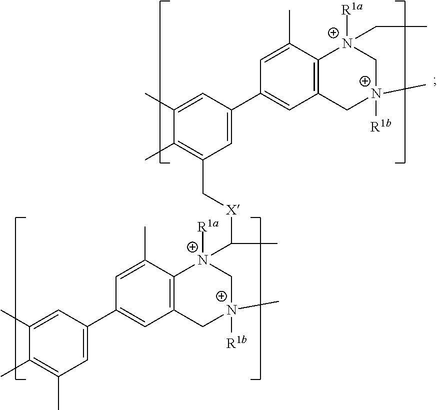

wherein: X is

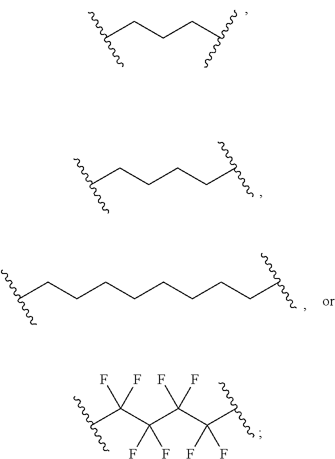 [SMILES: *CCC* ; *CCCC* ; *CCCCCCCC* ; *C(F)(F)C(F)(F)C(F)(F)C(*)(F)F]

and

### X′ is

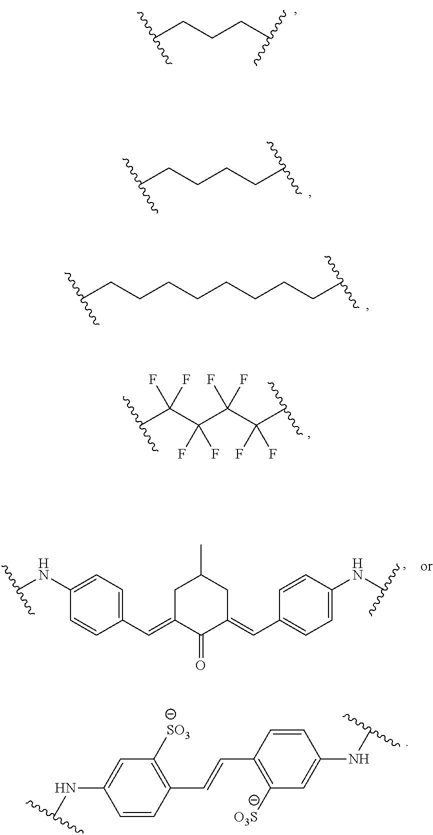

In some embodiments, the quaternary polyamine polymer is

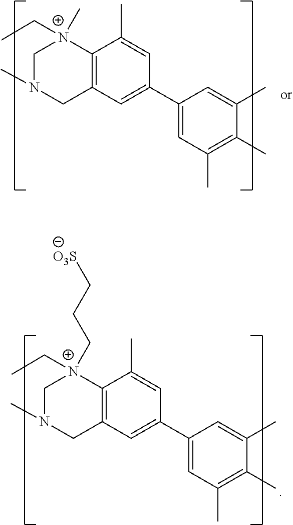

In some embodiments, the quaternary polyamine polymer is

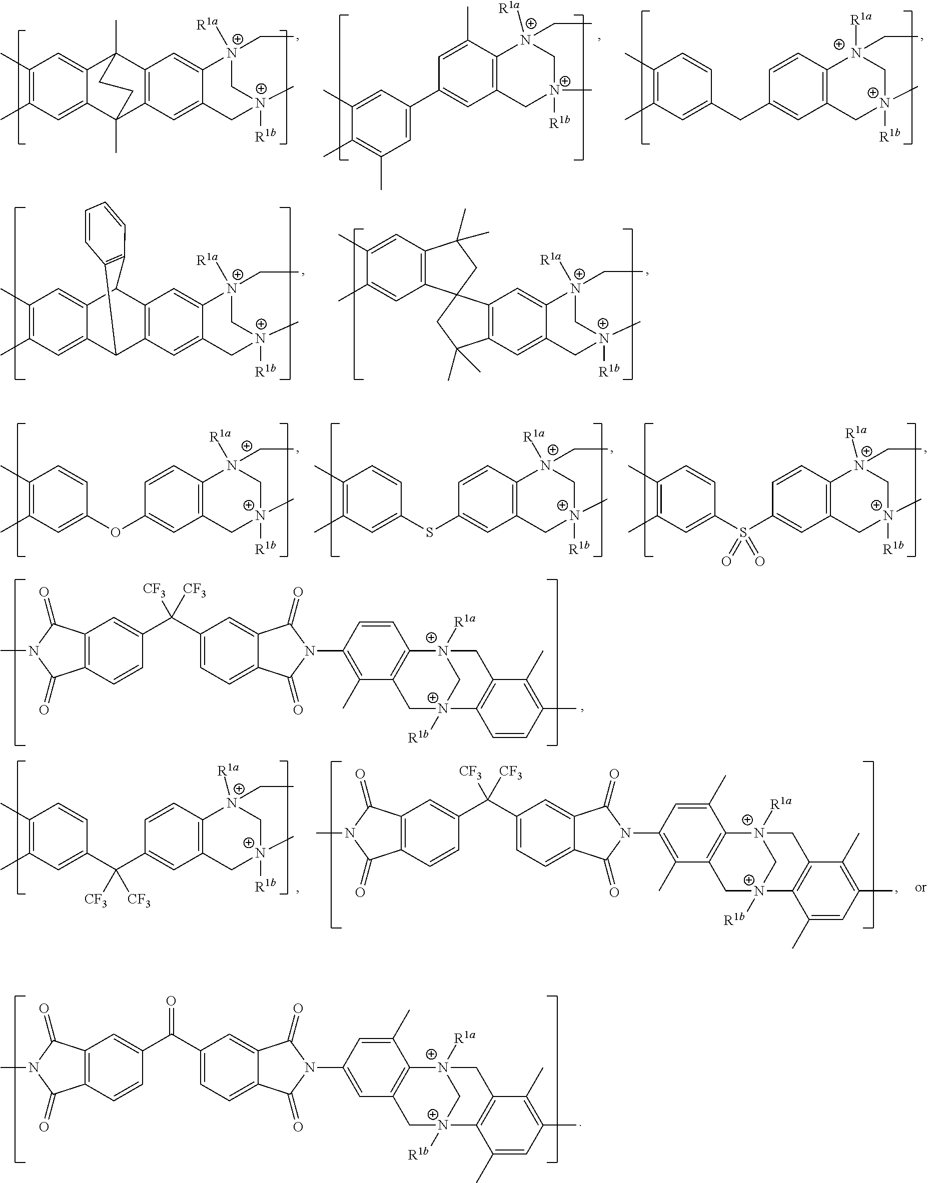

In some embodiments, the polyamine polymer is

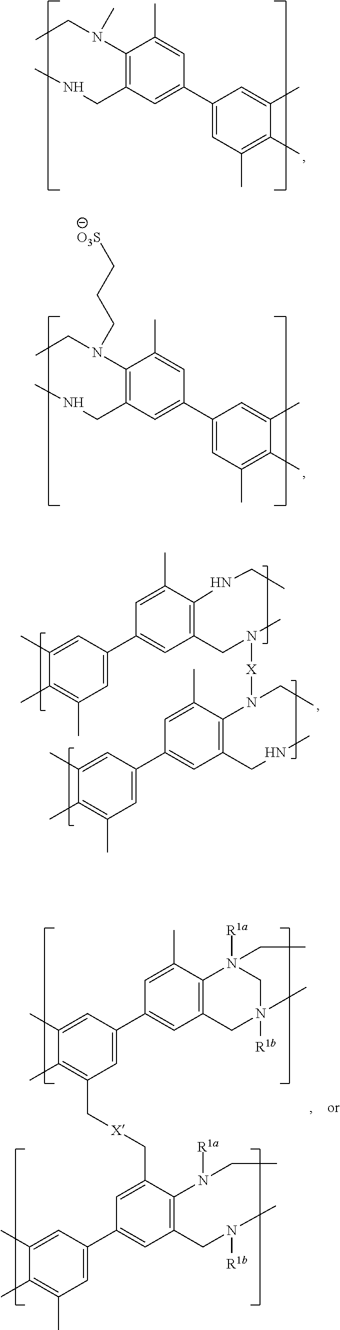

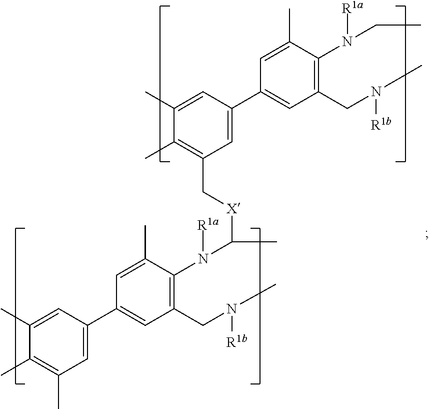

wherein X is

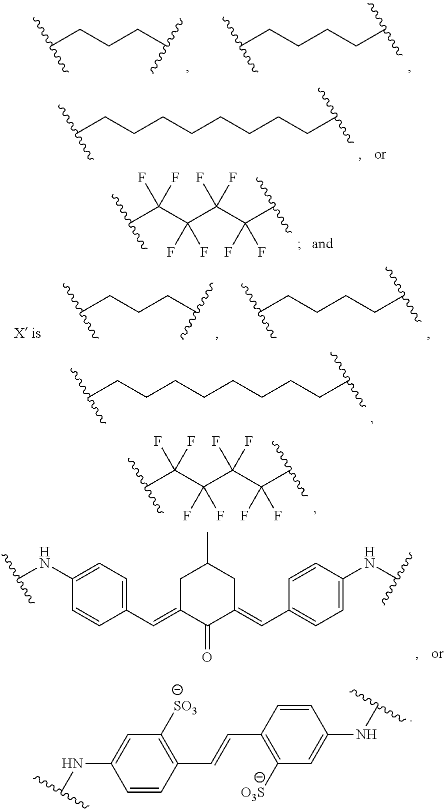

In some embodiments, the polyamine polymer is

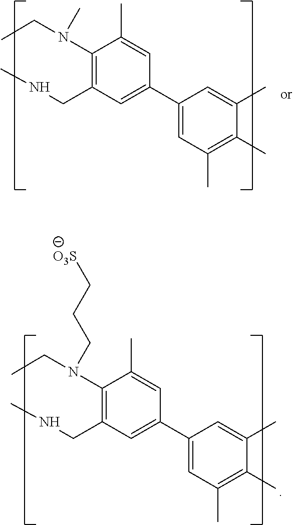

In some embodiments, the polyamine polymer is

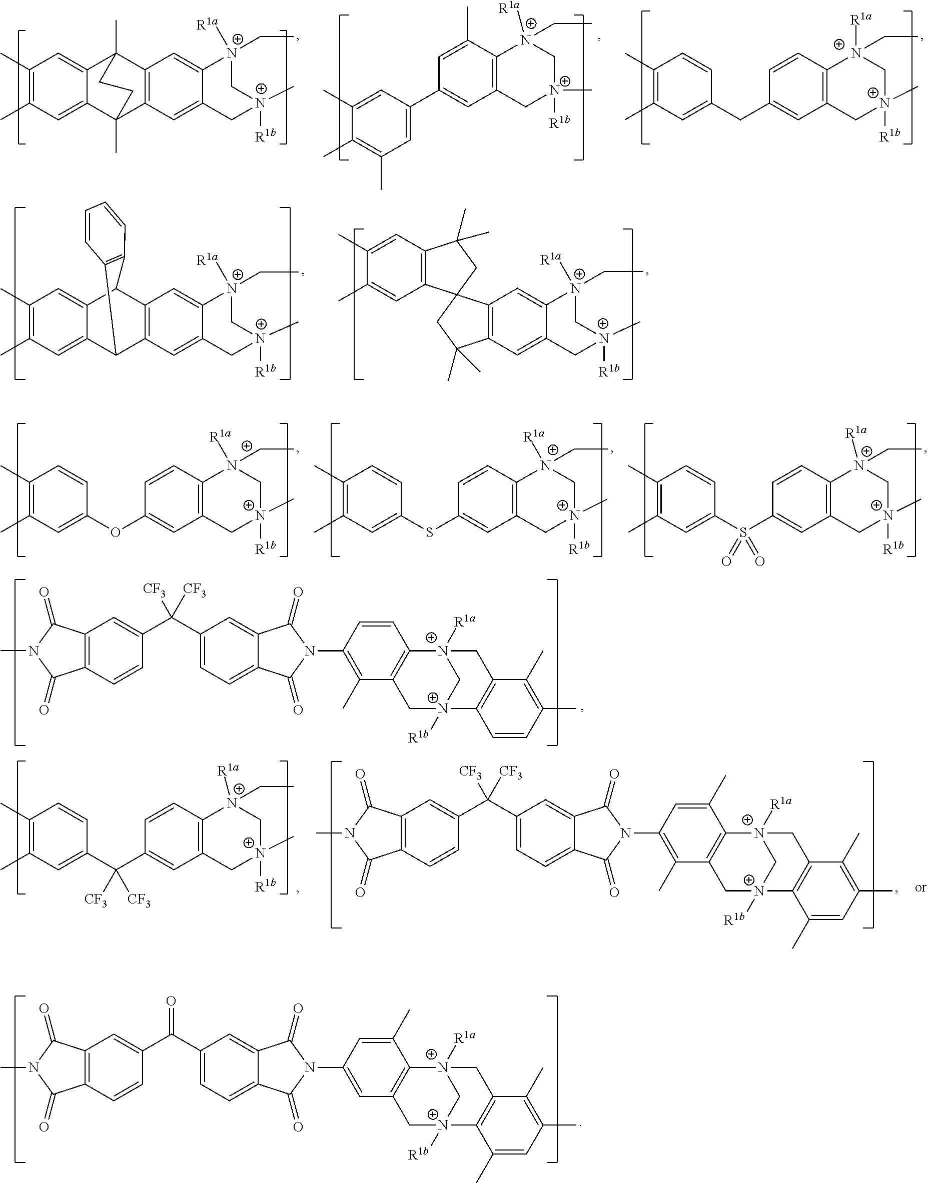

### III. Membranes for Aqueous Redox Flow Batteries

In some embodiments, the present invention provides a membrane comprising a polyamine polymer. In some embodiments, the present invention provides a membrane comprising a quaternary polyamine polymer.

The polyamine polymer can be a secondary, tertiary or quaternary polyamine polymer. In some embodiments, the polyamine polymer is a secondary polyamine polymer.

In some embodiments, the polyamine polymer is a tertiary polyamine polymer. In some embodiments, the polyamine polymer is a quaternary polyamine polymer.

In some embodiments, the polyamine polymer is a zwitterionic polyamine polymer.

In some embodiments, the quaternary polyamine polymer is a zwitterionic polyamine polymer. In some embodiments, the zwitterionic polyamine polymer can be an amino acid polymer, or Tröger's base polymer.

The membrane of the present invention may be permeable to positive ions, such as Li⁺, K⁺, Na⁺, Cs⁺, and/or NH₄⁺ ions, or negative ions, such as hydroxide ions. The membrane may be impermeable or effectively impermeable to active materials of the posolyte and negolyte such as sulfur, polysulfides, ferrocyanides, and/or permanganates. Herein “effectively impermeable” refers to a membrane that prevents crossover of at least 90%, such as at least 95%, at least 97%, at least 98%, or at least 99% of active materials for a time period ranging from about 1 month to about 1 year. In some embodiments, the membrane may be permeable to anions such as hydroxyl (OH⁻) ions.

The membrane of the present invention can have any suitable conductivity. In some embodiments, the conductivity of the membrane is at least 0.005 mS/cm, 0.01 mS/cm, 0.05 mS/cm, 0.10 mS/cm, 0.20 mS/cm, 0.30 mS/cm, 0.40 mS/cm, or 0.50 mS/cm. In some embodiments, the conductivity of the membrane is at least 0.005 mS/cm, 0.01 mS/cm, 0.05 mS/cm, or 0.10 mS/cm. In some embodiments, the conductivity of the membrane is at least 0.01 mS/cm.

The membrane of the present invention can have any suitable diffusive permeability of polyvalent ions and/or ionic transition metal complexes. In some embodiments, the membrane can have a diffusive permeability of less than 1×10⁻⁵ cm²/s, 1×10⁻⁶ cm²/s, 1×10⁻⁷ cm²/s, 1×10⁻⁸ cm²/s, 1×10⁻⁹ cm²/s, or 1×10⁻¹⁰ cm²/s. In some embodiments, the membrane can have a diffusive permeability of less than 1×10⁻⁶ cm²/s, 1×10⁻⁷ cm²/s, or 1×10⁻⁸ cm²/s. In some embodiments, the membrane has a diffusive permeability of polyvalent ions and/or ionic transition metal complexes is limited to less than 1×10⁻⁸ cm²/s.

In some embodiments, the membrane allows monoatomic and monovalent ions and/or the acid/base dissociation products of water to permeate the membrane such that the conductivity of the membrane is at least 0.01 mS/cm and the diffusive permeability of polyvalent ions and/or ionic transition metal complexes is limited to <1×10⁻⁸ cm²/s.

The membrane of the present invention can have any suitable ions which permeate the membrane. In some embodiments, the membrane can allow monoatomic and monovalent ions to permeate the membrane. Monoatomic and monovalent ions include, but are not limited to H⁺, Li⁺, Na⁺, K⁺, F⁻, Cl⁻, Br⁻, I⁻. In some embodiments, the ion can be the acid and base dissociation products of water, which are H₃O⁺ and ⁻OH. In some embodiments, the monoatomic and monovalent ions are independently H⁺, Li⁺, Na⁺, K⁺, F⁻, Cl⁻, Br⁻, or I⁻.

In some embodiments, the membrane can filter any suitable polyvalent ions and/or ionic transition metal complexes from permeating the membrane. Polyvalent ions include, but are not limited to permanganate, manganate, or polysulfide in its various forms such as S₂²⁻, S₄²⁻, S₈²⁻. In some embodiments, the polyvalent ions are independently S₂²⁻, S₄²⁻, S₈²⁻. In some embodiments, the polyvalent ions are independently S₂²⁻, S₄²⁻, S₈²⁻, MnO₄⁻, or MnO₄²⁻.

The membrane of the present invention can filter any suitable electrolytes in electrochemical applications of the present invention. In some embodiments, the membrane can filter electrolytes in an aqueous or non-aqueous environment. Aqueous environments include water. Non-aqueous environments include organic solvents excluding water. In some embodiments, the membrane filters aqueous or non-aqueous electrolytes in electrochemical applications.

Membranes of the present invention can comprise a quaternary polyamine polymer. In some embodiments, the quaternary polyamine polymer can comprise an amino acid polymer, Tröger's base polymer, or copolymers thereof. In some embodiments, the quaternary polyamine polymer comprises a Tröger's base polymer or copolymer thereof.

In some embodiments, the copolymers have the following structure:

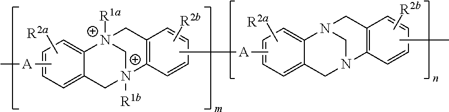

wherein subscripts m and n are each independently 0 to 1000, such that the sum of m and n is at least 10. In some embodiments, the ratio of subscript m to subscript n is about 100:1 to about 1:100. In some embodiments, the ratio of subscript m to subscript n is about 10:1 to about 1:10. In some embodiments, the subscript m to subscript n is about 1:1.

In some embodiments, the copolymers have the following structure:

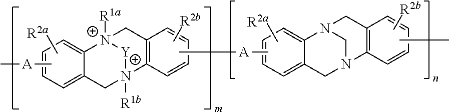

wherein subscripts m and n are each independently 0 to 1000, such that the sum of m and n is at least 10. In some embodiments, the ratio of subscript m to subscript n is about 100:1 to about 1:100. In some embodiments, the ratio of subscript m to subscript n is about 10:1 to about 1:10. In some embodiments, the subscript m to subscript n is about 1:1.

In some embodiments, the membrane of the present invention comprises a polyamine polymer comprising a repeat unit of Formula J:

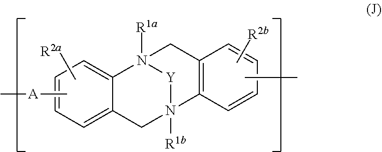

wherein: Y is absent or —CH₂—; R^{1a} and R^{1b} bare each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

In some embodiments, Y is —CH₂—. In some embodiments, the membrane of the present invention comprises a quaternary polyamine polymer comprising a repeat unit of Formula I:

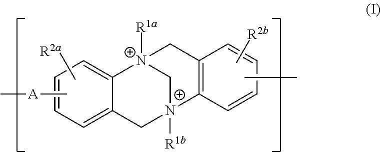

wherein: R^{1a} and R^{1b} are each independently absent, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

In some embodiments, Y is absent. In some embodiments, the membrane of the present invention comprises a polyamine polymer comprising a repeat unit of Formula II:

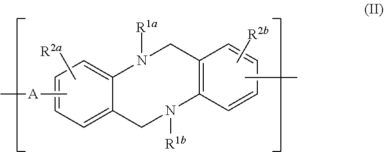

wherein: R^{1a} and R^{1b} are each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻; each L¹ is independently C₁₋₆ alkylene; alternatively, R^{1a} and R^{1b} on different polymers can combine to form a crosslinker; R^{2a} and R^{2b} are each independently C₁₋₆ alkyl or C(O) O⁻; alternatively, R^{2a} and R^{2b} on different polymers can combine to form a crosslinker; and A is a bond, optionally substituted C₁₋₆ alkylene, urethanes, amides, sulfones, esters, ethers, —O—, a linker, or combined with the adjacent rings to form an optionally substituted C₆₋₂₀ bicyclic cycloalkyl.

The membrane of the present invention comprises a polyamine polymer, wherein the polyamine polymer comprises the compositions as described above. The membrane of the present invention comprises a quaternary polyamine polymer, wherein the quaternary polyamine polymer comprises the compositions as described above. In some embodiments, the membrane of the present invention comprises a polyamine polymer comprising repeating units of Formula I wherein R^{1a} and R^{1b} are as described above. In some embodiments, the membrane of the present invention comprises a quaternary polyamine polymer comprising repeating units of Formula I wherein R^{1a} and R^{1b} are as described above. In some embodiments, the membrane of the present invention comprises a polyamine polymer comprising repeating units of Formula J, I, or II, wherein R^{1a} and R^{1b} are each independently absent, hydrogen, C₁₋₃ alkyl, or -L¹-S(O)₂O⁻, and L¹ is a C₂₋₄ alkylene; alternatively, R^{1a} and R^{1b} on different polymers can combine to form a crosslinker, wherein the crosslinker is C₃₋₁₀ alkylene or C₃₋₁₀ haloalkylene. In some embodiments, the membrane of the present invention comprises a quaternary polyamine polymer comprising repeating units of Formula J or I, wherein R^{1a} and R^{1b} are each independently absent, C₁₋₃ alkyl, or -L¹-S(O)₂O⁻, and L¹ is a C₂₋₄ alkylene; alternatively, R^{1a} and R^{1b} on different polymers can combine to form a crosslinker, wherein the crosslinker is C₃₋₁₀ alkylene or C₃₋₁₀ haloalkylene.

In some embodiments, the membrane of the present invention comprises a polyamine polymer comprising repeating units of Formula J, I or II, wherein R^{1a} and R^{1b} are each independently absent, hydrogen, methyl, or —CH₂CH₂CH₂S(O)₂O⁻; alternatively, R^{1a} and R^{1b} on different polymers can combine to form a crosslinker, wherein the crosslinker is

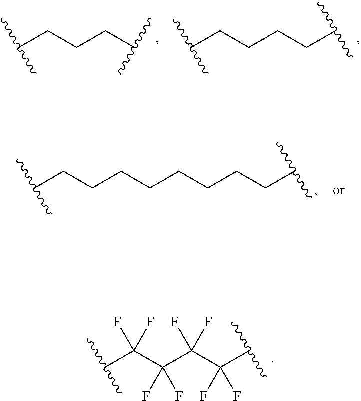

In some embodiments, the membrane of the present invention comprises a quaternary polyamine polymer comprising repeating units of Formula J or I, wherein R^{1a} and R^{1b} are each independently absent, methyl, or —CH₂CH₂CH₂S(O)₂O⁻; alternatively, R^{1a} and R^{1b} on different polymers can combine to form a crosslinker, wherein the crosslinker is

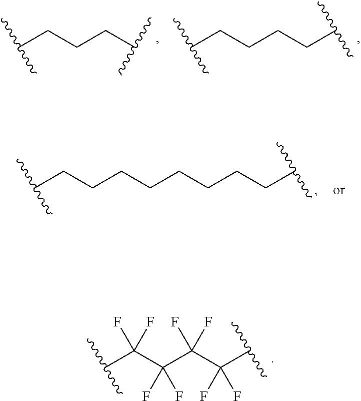

In some embodiments, the membrane of the present invention comprises a polyamine polymer comprising repeating units of Formula J, I or II, wherein R^{1a} and R^{1b} are each independently hydrogen, methyl, or —CH₂CH₂CH₂S(O)₂O⁻; alternatively, R^{1a} and R^{1b} on different polymers can combine to form a crosslinker, wherein the crosslinker is

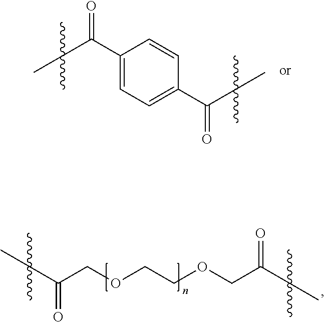

wherein n=1-12. In some embodiments, the membrane of the present invention comprises a polyamine polymer comprising repeating units of Formula J, I or II, wherein R^{1a} and R^{1b} on different polymers can combine to form a crosslinker, wherein the crosslinker is

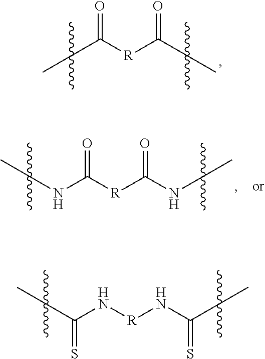

wherein R is C₂₋₁₀ alkylene, poly(ethylene glycol), arylene or heteroarylene.

In some embodiments, the membrane of the present invention comprises a polyamine polymer comprising repeating units of Formula J, I, or II, wherein R^{2a} and R^{2b} are as described above. In some embodiments, the membrane of the present invention comprises a quaternary polyamine polymer comprising repeating units of Formula J or I, wherein R^{2a} and R^{2b} are as described above. In some embodiments, the membrane of the present invention comprises a polyamine polymer comprising repeating units of Formula J, I, or II, wherein R^{2a} and R^{2b} are each independently C₁₋₃ alkyl; alternatively, R^{2a} and R^{2b} on different polymers can combine to form a crosslinker, wherein the crosslinker is C₃₋₁₀ alkylene, C₃₋₁₀ haloalkylene,

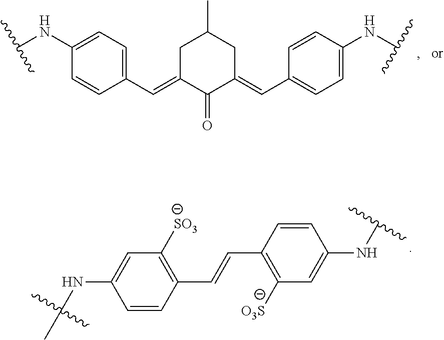

In some embodiments, the membrane of the present invention comprises a quaternary polyamine polymer comprising repeating units of Formula J or I, wherein R^{2a} and R^{2b} are each independently C₁₋₃ alkyl; alternatively, R^{2a} and R^{2b} on different polymers can combine to form a crosslinker, wherein the crosslinker is C₃₋₁₀ alkylene, C₃₋₁₀ haloalkylene,

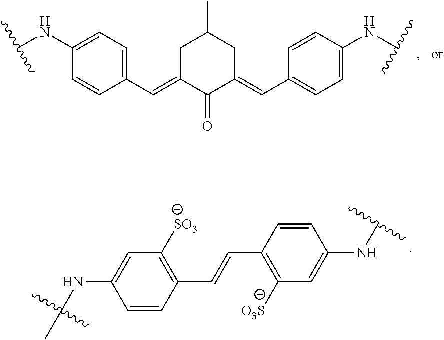

In some embodiments, the membrane of the present invention comprises a polyamine polymer comprising repeating units of Formula J, I, or II, wherein R^{2a} and R^{2b} are each independently methyl; alternatively, R^{2a} and R^{2b} on different polymers can combine to form a crosslinker, wherein the crosslinker is

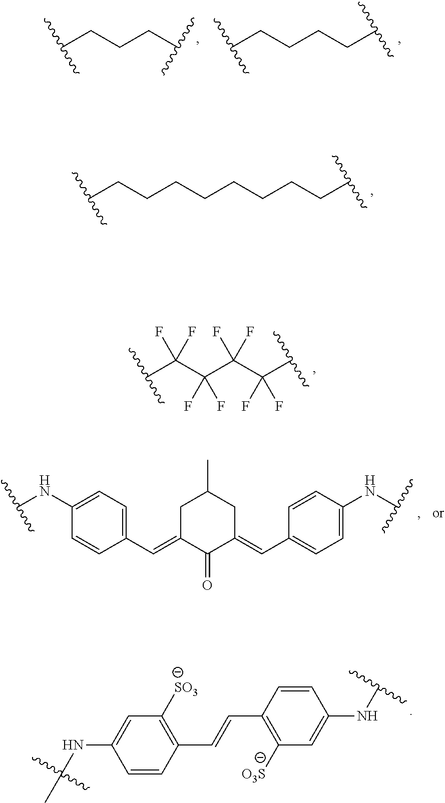

In some embodiments, the membrane of the present invention comprises a quaternary polyamine polymer comprising repeating units of Formula J or I, wherein R^{2a} and R^{2b} are each independently methyl; alternatively, R^{2a} and R^{2b} on different polymers can combine to form a crosslinker, wherein the crosslinker is

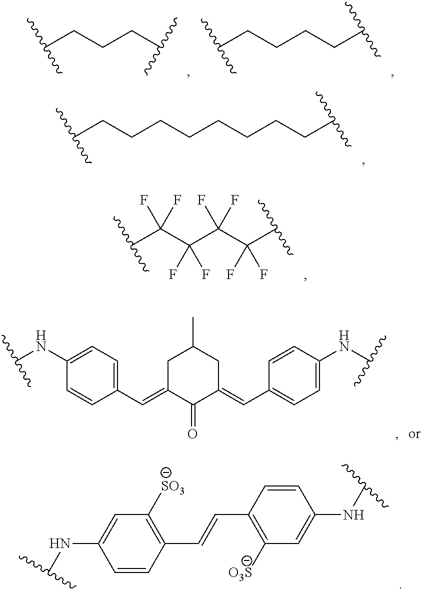

In some embodiments, the membrane of the present invention comprises a polyamine polymer comprising repeating units of Formula J, I, or II, wherein A is as described above. In some embodiments, the membrane of the present invention comprises a quaternary polyamine polymer comprising repeating units of Formula J or I, wherein A is as described above. In some embodiments, the membrane of the present invention comprises a polyamine polymer comprising repeating units of Formula J, I, or II, wherein A is a bond, methylene, ethylene, propylene, butylene, urethane, amide, sulfone, ester, ether,

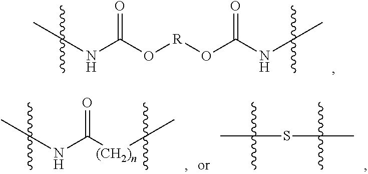

wherein R is a C₁₋₁₂ alkylene, and n is 0 to 20. In some embodiments, the membrane of the present invention comprises a quaternary polyamine polymer comprising repeating units of Formula J or I, wherein A is a bond, methylene, ethylene, propylene, butylene, urethane, amide, sulfone, ester, ether,

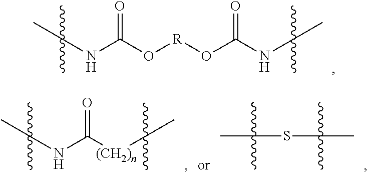

wherein R is a C₁₋₁₂ alkylene, and n is 0 to 20.

In some embodiments, the membrane of the present invention comprises a polyamine polymer comprising repeating units of Formula J, I, or II, wherein A is a bond, sulfone, ester, ether,

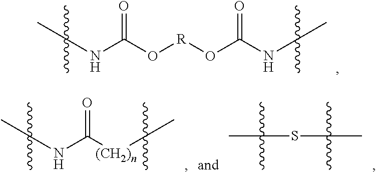

wherein R is a C₁₋₁₂ alkylene, and n is 0 to 20. In some embodiments, the membrane of the present invention comprises a quaternary polyamine polymer comprising repeating units of Formula J or I, wherein A is a bond, sulfone, ester, ether,

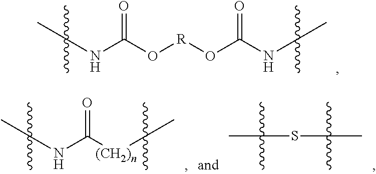

wherein R is a C₁₋₁₂ alkylene, and n is 0 to 20.

In some embodiments, the membrane of the present invention comprises a quaternary polyamine polymer, wherein the quaternary polyamine polymer is

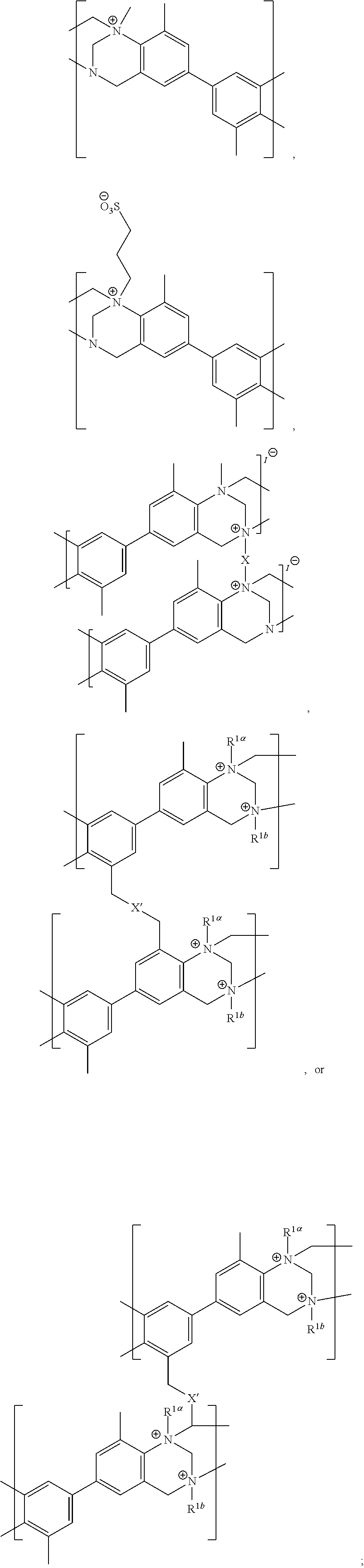

wherein X is

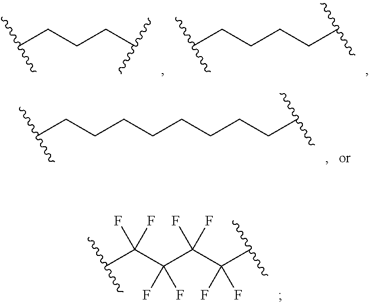 [SMILES: *CCC* ; *CCCC* ; *CCCCCCCC* ; *C(F)(F)C(F)(F)C(F)(F)C(*)(F)F]

### X′ is

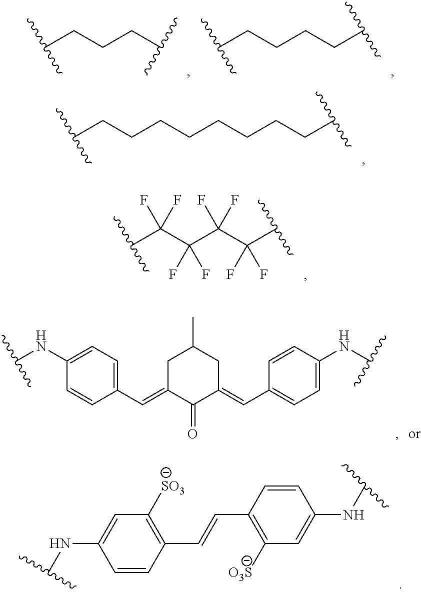

In some embodiments, the membrane of the present invention comprises a quaternary polyamine polymer, wherein the quaternary polyamine polymer is

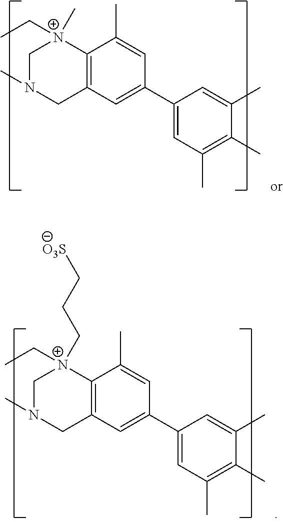

In some embodiments, the membrane of the present invention comprises a quaternary polyamine polymer, wherein the quaternary polyamine polymer is

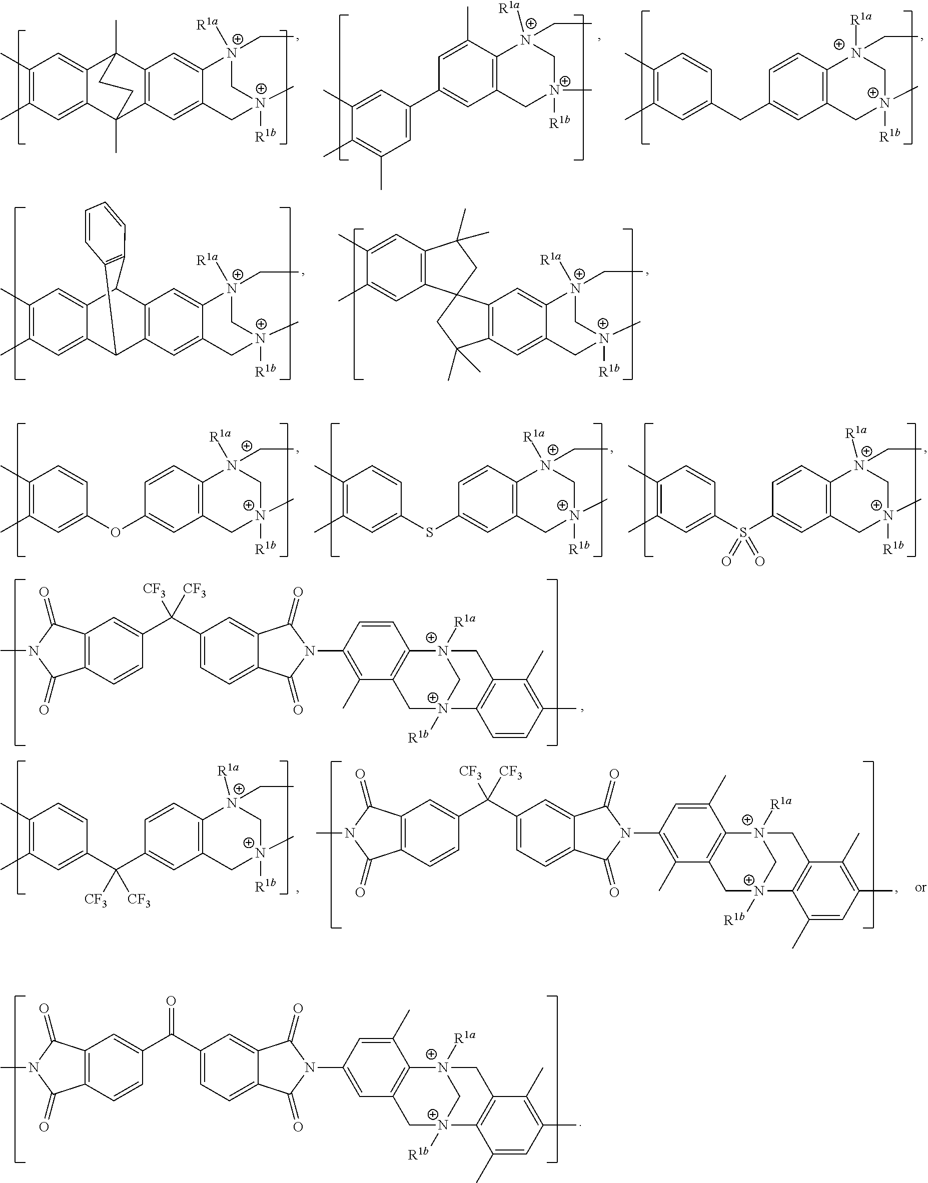

In some embodiments, the membrane of the present invention comprises a polyamine polymer, wherein the polyamine polymer is

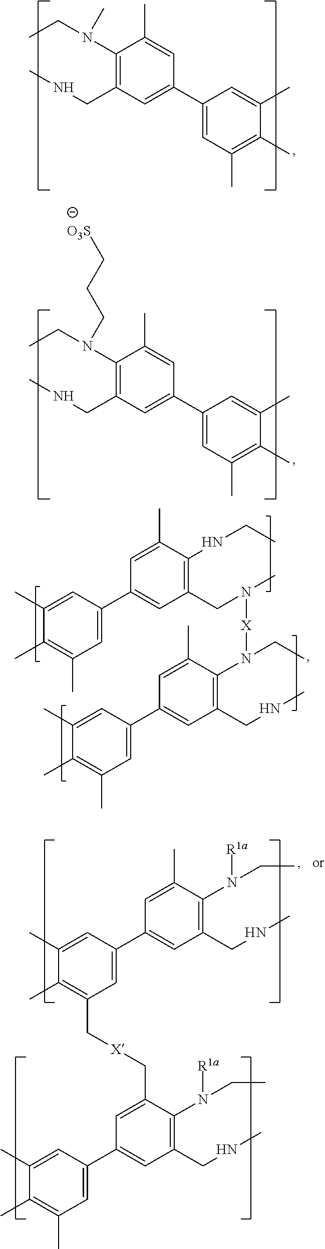

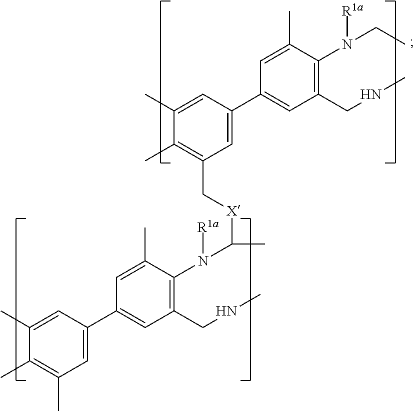

wherein: X is

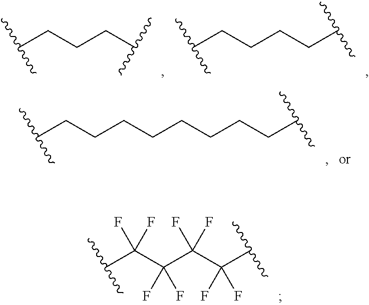 [SMILES: *CCC* ; *CCCC* ; *CCCCCCCC* ; *C(F)(F)C(F)(F)C(F)(F)C(*)(F)F]

### X′ is

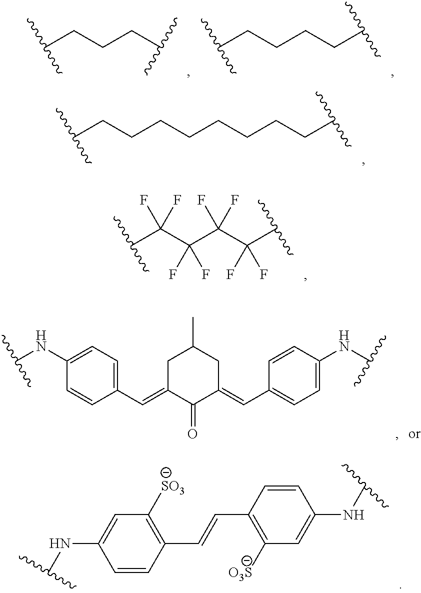

In some embodiments, the polyamine polymer is

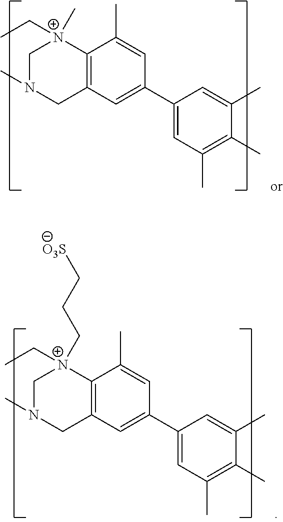

In some embodiments, the membrane of the present invention comprises a polyamine polymer, wherein the polyamine polymer is

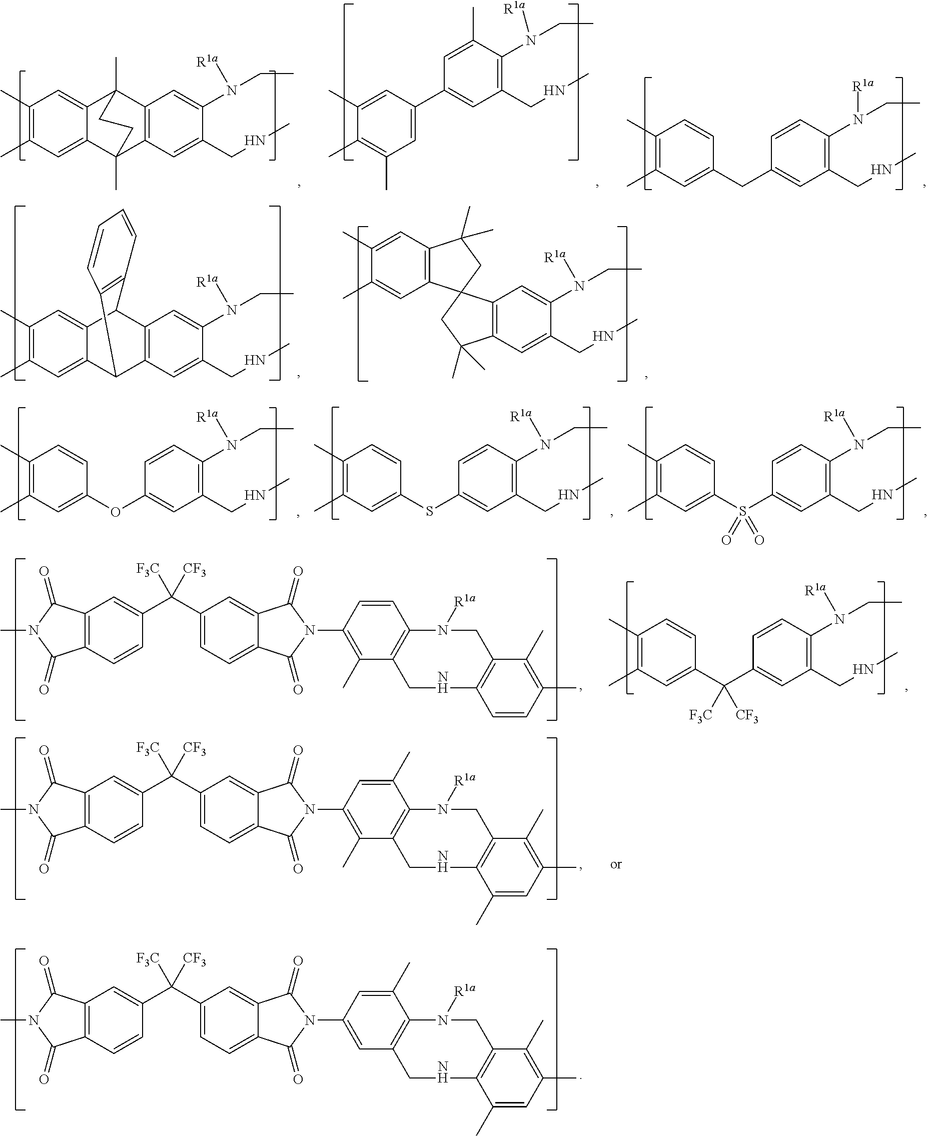

In some embodiments, the polyamine polymer membrane is a composite with a metal oxide. In some embodiments, the polyamine polymer membrane is a composite with manganese dioxide.

FIG. 7 is a schematic view of an aqueous electrochemical cell 700, such as an aqueous polysulfide-based electrochemical cell, according to various embodiments of the present disclosure. In some embodiments, the electrochemical cell 700 may be a cell architecture in which the anolyte and catholyte are static (non-flowing). In some embodiments, the electrochemical cell 700 may be a cell architecture for a flow battery in which the anolyte and catholyte are flowing. Referring to FIG. 7, the cell 700 includes a housing 710 in which are disposed a positive electrode 712 or cathode, a negative electrode 714 or anode, a membrane 716 disposed between the positive electrode 712 and the negative electrode 714, a posolyte 722 or catholyte, and a negolyte 724 or anolyte.

The housing 710 may be formed of a polymer, such as high-density polyethylene, polypropylene, or the like. The housing 710 may include a first chamber in which the posolyte 722 is disposed, and a second chamber in which the negolyte 724 is disposed. In some embodiments, the housing 110 may be configured to contain from about 600 liters (L) to about 1200 L of the posolyte 722, such as about 900 L, and from about 1000 L to about 1500 L of the negolyte 724, such as about 1250 L. In other words, the cell 100 may include a first volume of the posolyte 722 and a second volume of the negolyte 724, with the second volume ranging from about one times to about two times, such as about 1.3 times to about 1.7 times, the first volume. In some embodiments, the housing 110 may be configured to contain from about 3500 L to about 4000 L of the posolyte 722, such as about 3750 L, and from about 1000 L to about 1500 L of the negolyte 724, such as about 1250 L. In other words, the cell 100 may include a first volume of the posolyte 722 and a second volume of the negolyte 724, with the first volume ranging from about 2 times to about four times, such as about three times, the second volume.

The cell 700 may include one or more gaskets 730 configured to at least partially seal the positive electrode 712, negative electrode 714, membrane 716, posolyte 722, and negolyte 724 in the housing 710. For example, the gaskets 730 may be formed of a rubber material, such as ethylene propylene diene monomer (EPDM) or the like. When the positive electrode 712, negative electrode 714, membrane 716, posolyte 722, and negolyte 724 may be sealed in the housing 710, the cell 700 may be a static cell. When the posolyte 722 and negolyte 724 flow into and out of the housing 710, the cell 700 may be a flowing cell.

The membrane 116 may be formed of a dielectric material, or a porous material, that is permeable to positive ions, such as Li⁺, K⁺, Na⁺, Cs⁺, and/or NH₄⁺ ions, or negative ions, such as hydroxide ions. The membrane 116 may be impermeable or effectively impermeable to active materials of the posolyte and negolyte 722, 724, such as sulfur, polysulfides, ferrocyanides, and/or permanganates. Herein “effectively impermeable” refers to a membrane that prevents crossover of at least 90%, such as at least 95%, at least 97%, at least 98%, or at least 99% of active materials for a time period ranging from about 1 month to about 1 year. In some embodiments, the membrane 116 may be permeable to anions such as hydroxyl (OH⁻) ions.

A positive electrode current collector 718 may be electrically connected to the positive electrode 712, and a negative electrode current collector 720 may be electrically connected to the negative electrode 714. The current collectors 718, 720 may be formed of a conductive material, such as stainless steel, carbon, titanium, combinations thereof, or the like. The thickness of current collectors 718, 720 may range from about 0.05 cm to about 0.5 cm, such as from about 0.1 cm to about 0.3 cm, or about 0.2 cm.

The positive electrode 712 may include a conductive layer having a high surface area, such as a carbon felt layer or nickel foam layer, and may be disposed between the positive electrode current collector 718 and the membrane 716. The positive electrode 712 may be configured to facilitate electrochemical reactions with the active materials of the posolyte 722. The positive electrode 712 may be non-flowing or flowing. In certain embodiments the posolyte 722 may be quiescent. In certain other embodiments, the posolyte 722 may be stirred to promote more rapid mass-transport.

The negative electrode 714 may include a conductive high surface area layer, such as a nickel foam or nickel felt layer, and may be disposed between the negative electrode current collector 720 and the membrane 716. The negative electrode 714 may be configured to facilitate electrochemical reactions with the active materials of the negolyte 724. The negative electrode 714 may be non-flowing or flowing. In certain embodiments the negolyte 724 may be quiescent. In certain other embodiments, the negolyte 724 may be stirred to promote more rapid mass-transport.

The posolyte and negolyte 722, 724 may include alkaline slurries, suspensions, solutions, or mixtures of solids and solutions. The posolyte and negolyte 722, 724 may both include an electropositive element, such as Li⁺, K⁺, Na⁺, or combinations thereof. For example, it has been found that including multi-valent electropositive elements, such as a combination of Li⁺, K⁺, and/or Na⁺, may increase cell potential and decrease the crossover of redox ions, such as polysulfide, permanganate, and/or ferrocyanide compounds. When the posolyte and negolyte 122, 124 are fully soluble, the ionic conductivity is maximized, allowing for the thickness of the negolyte and posolyte chambers to be maximized. When the posolyte 722 and negolyte 724 are slurries, comprised of mixtures of solid and liquid phases, the energy density per unit volume is increased, but at the cost of diminished ion-phase transport.

An alkaline agent may be added to the posolyte and negolyte 722, 724 in an amount sufficient to provide a pH of at least 9, such as a pH ranging from about 9 to about 14, such as a pH ranging from about 13 to about 14. In some embodiments, the alkaline agent may be, for example, a strong base such as NaOH, LiGH, KOH, or the like. In some embodiments, the alkaline agent may be a mixture of such strong bases, such as a mixture of NaOH and LiGH, or a mixture of NaOH and KOH, or a mixture of NaOH, LiGH, and KOH. In some embodiments, dissociation of the alkaline agent may provide the electropositive element. In other embodiments, a salt comprising the electropositive element may be added to the posolyte and negolyte 722, 724.

The posolyte 722 may include a positive electrode active material (e.g., a material configured to adsorb and desorb working ions such as Li⁺, Na⁺, and K⁺) dissolved in an electrolyte, such as aqueous electrolyte, and the negolyte 724 may include an negative electrode active material dissolved in an electrolyte, such as an aqueous electrolyte.

For example, the negative electrode active material may include a sulfide or polysulfide compound or salts thereof. For example, the negative electrode active material may include lithium polysulfides (Li₂Sₓ, where x=1 to 8), sodium polysulfides (Na₂Sₓ, where x=2 to 8) and/or potassium polysulfides (K₂Sₓ), where x=1 to 8.

The negolyte 724 may have an negative electrode active material concentration ranging from about 4M to about 14M, such as from about 5M to about 12M, or from about 7M to about 10M. At annegolyte active material concentration of 2.5M (S₂²⁻), the negolyte capacity density may be about 67.0 Ah/L. However, the present disclosure is not limited to any particular concentration of negative electrode active material.

The posolyte 722 may have a positive electrode active material concentration ranging from about 0.5 mol/L (M) to about 14M. However, the positive electrode active material concentration may vary depending on the particular active material utilized and/or particular electrochemical cell and/or system applications. Accordingly, the present disclosure is not limited to any particular active material concentration.

Various embodiments of the present invention include electrochemical cells that include membranes that have certain characteristics. The following discussion of membranes is provided to illustrate various aspects of the invention and the membranes discussed herein may be applied to any of the embodiment cells and/or stacks described herein incorporated by reference. Membranes of the present disclosure may, in some embodiments, have a thickness of about 500 microns or less, about 200 microns or less, about 100 microns or less, about 50 microns or less, or about 25 microns or less. Suitable membranes may be capable of operating in electrochemical cell with a current efficiency of at least about 80%, at a current density of 10 mA/cm, when the membrane has a thickness of 100 microns or less. More preferably, the electrochemical system is capable of operating at a current efficiency of at least 90%, when the membrane has a thickness of about 50 microns or less, a current efficiency of at least 95% when the membrane has a thickness of about 25 microns or less, and a current efficiency of at least 98% when the membrane has a thickness of about 10 microns or less. Suitable membranes include those membranes in which the electrochemical system is capable of operating at a voltage efficiency of at least 60% with a current density of about 10 mA/cm. More preferably, suitable membranes include those membranes in which the electrochemical system is capable of operating at a voltage efficiency of at least 70%, at least 80% or at least 90%.

Membranes are generally categorized as either solid or porous. Solid membranes can be made from organic materials, such as polymer, or inorganic materials, such as ceramic and metal oxide, and typically comprise one or more types of ion-exchangeable functional groups, wherein the functional groups facilitates mobile ion transport through the body of the membrane. The facility with which ions conduct through the membrane can be characterized by a resistance, typically an area resistance in units of Q cm². The area resistance is a function of inherent membrane conductivity and the membrane thickness. Thin membranes are desirable to reduce inefficiencies incurred by ion conduction and therefore can serve to increase voltage efficiency of the energy storage device. Active material crossover rates are also a function of membrane thickness, and typically decrease with increasing membrane thickness. Crossover represents a current efficiency loss that is generally balanced with the voltage efficiency gains by utilizing a thin membrane. The active material present in the first electrolyte and the active material present in the second electrolyte are separated by the membrane. The diffusion rate of active materials in either the first electrolyte or the second electrolyte should be about 1×10⁻⁸ mol/(cm² sec) or less, about 1×10⁻¹⁰ mol/(cm² sec) or less, about 1×10⁻¹² mol/(cm² sec) or less, or 1×10⁻¹⁴ mol/(cm² sec) or less. Other embodiments of this invention include situations where the first electrolyte and second electrolyte are intermixed.

In some embodiments, the membranes may be porous membranes. Porous membranes are non-conductive membranes which allow working ions transfer between two electrodes via open channels filled with electrolyte. This permeability increases the probability of active materials passing through porous membrane from one electrode to another causing cross-contamination and/or reduction in cell energy efficiency. The degree of this cross-contamination depends on, among other features, the size (the effective diameter and channel length), and character (hydrophobicity/hydrophilicity) of the pores, the nature of the electrolyte, and the degree of wetting between the pores and the electrolyte. The pore size distribution is generally sufficient to substantially prevent the crossover of active materials between the two electrolyte solutions.

Suitable porous membranes may have an average pore size distribution of between about 0.001 nm and 10 microns. Preferably, the average pore size distribution should be between about 0.01 nm and 100 nm. The pore size distribution in a porous membrane can be substantial. In other words, a porous membrane may contain pores with a very small diameter (approximately less than 1 nm) and may contain pores with a very large diameter (approximately greater than 100 nm). The larger pore sizes can lead to a higher amount of active material crossover. The ability for a porous membrane to substantially prevent the crossover of active materials will depend on the relative difference in size between the average pore size and the active material. For example, when the active material is an ionic group in the form of a hydrated complex, the average diameter of the hydrated complex is about 50% greater than the average pore size of the porous membrane. On the other hand, if the porous membrane has substantially uniform pore sizes, it is preferred that the average diameter of the hydrated complex be about 20% larger than the average pore size of the porous membrane.

In some embodiments, the membrane of the present invention exhibits selective permeation by size sieving, wherein the particulates which are sieved can be differentiated by either molecular weight, Van der Waals radius, kinetic diameter, or hydrodynamic radius.

In some embodiments, the membrane of the present invention comprises pores allowing the separation of gases (including but not limited to H₂, O₂, N₂, CO₂, CH₄, H₂S) by Van der Waals radius or kinetic diameter, wherein smaller gas molecules permeate the membrane at rates at least 2 times faster than larger gas molecules.

In some embodiments, the membrane comprises pores allowing small molecular weight (<900 daltons) components in a fluid to permeate the membrane while limiting the permeation of middle and large molecular weight (>900 daltons) components.

In some embodiments, the present invention provides an electrochemical cell, comprising: a membrane of the present invention; a positive electrode; and a negative electrode.

In some embodiments, the present invention provides An electrochemical cell comprising: a) a posolyte comprising a positive electrode active material dissolved in an electrolyte; b) a negolyte comprising a polysulfide compound dissolved in an electrolyte; c) an ion-permeable membrane configured to electrically insulate the negolyte from the posolyte; and d) wherein the membrane comprises: (i) a polymer; (ii) a protective layer disposed on a posolyte side of the polymer and configured to reduce oxidation of the polymer by the positive electrode active material; and (iii) wherein the protective layer comprises manganese oxide.

In some embodiments, the present invention provides an electrochemical cell comprising: a) a posolyte comprising a positive electrode active material dissolved in an electrolyte; b) an negolyte comprising a polysulfide compound dissolved in an electrolyte; c) an ion-permeable membrane configured to electrically insulate the negolyte from the posolyte; and d) wherein the membrane comprises an anion exchange membrane (AEM), a cation exchange membrane (CEM), a zwitterionic membrane, a porous membrane with average pore diameter smaller than 10 nanometers, a polybenzimidazole-based membrane, a polysulfone-based membrane, a polyetherketone-based membrane, a membrane including polymers of intrinsic microporosity (PIM), or a combination thereof.

In some embodiments, the present invention provides an electrochemical cell comprising: a) a posolyte comprising a positive electrode active material dissolved in an electrolyte; wherein the positive electrode active material comprises a manganese-based compound; b) a negolyte comprising a polysulfide compound dissolved in an electrolyte; c) an ion-permeable membrane configured to electrically insulate the negolyte from the posolyte; and d) wherein the membrane comprises: (i) a composite membrane comprising an inorganic material and an organic material; and (ii) wherein the organic material comprises a polyether ether ketone (PEEK), a polysulfone, a polystyrene, a polypropylene, a polyethylene, or any combination thereof.

According to various embodiments of the present disclosure, membranes may comprise any suitable polymer, typically an ion exchange resin, for example, comprising a polymeric anion or cation exchange membrane, or combination thereof. The mobile phase of such a membrane may comprise, and/or is responsible for the primary or preferential transport (during operation of the battery) of at least one mono-, di-, tri-, or higher valent cation and/or mono-, di-, tri-, or higher valent anion, other than protons or hydroxide ions.

Suitable solid cationic exchange polymers include use of one or more of the following polymers: cross-linked halogenated alkylated compound with a polyamine, a cross-linked aromatic polysulfone type polymer with a polyamine, perfluoriniated hydrocarbon sulfonate ionomers, sulfonated polyether ether ketone (S-PEEK), sulfonated poly(phthalazinone ether ketone), sulfonated phenolphthalein poly(ether sulfone), sulfonated polyimides, sulfonated polyphosphazene, sulfonated polybenzimidazole, aromatic polymers containing a sulfonic acid group, sulfonated perfluorinated polymer, fluorinated ionomers with sulfonate groups, carboxylate groups, phosphate groups, boronate acid groups, polyaromatic ethers with sulfonate or carboxylate groups, poly(4-vinyl pyridine, poly(2-vinyl pyridine), poly(styrene-b-2-vinylpyridine), poly(vinyl pyrrolidine), poly(1-methyl-4-vinylpyridine), poly(2,2′-m-phenylene)-5,5′-bibenzimi dazole poly(2,2′-(m-phenylene)-5,5′-bibenzimidazole, poly(2,5-benzimidazole), polyacrylate, polymethacrylate, or combinations thereof. Suitable solid anionic exchange membranes include the use of one or more of the following polymers: polydiaryl dimethyl ammonium, poly(methacryloyloxyethyl triethylammonium), poly(diallylammonium), or combinations thereof.

In some embodiments, substantially non-fluorinated membranes that are modified with sulfonic acid groups (or cation exchanged sulfonate groups) may also be used. Such membranes include those with substantially aromatic backbones, e.g., poly-styrene, polyphenylene, bi-phenylsulfone, or thermoplastics such as polyetherketones or polyethersulfones. Membranes may also include polyesters, poly(ether-ketone-ether-ketone-ketone), poly(vinyl chloride), vinyl polymers, substituted vinyl polymers, alone or in combination of any previously described solid or porous polymer

Membranes according to various embodiments may also comprise reinforcement materials for greater stability. Reinforcement materials can be implemented in the membrane as mesh, thin layers, woven, or dispersion. Suitable reinforcement materials include nylon, cotton, polyesters, crystalline silica, crystalline titania, amorphous silica, amorphous titania, rubber, asbestos wood or combination thereof.

According to various embodiments of the present disclosure, membranes may include polymer-inorganic composite membranes. Because such membranes contain no inherent ionic conduction capability, such membranes are typically impregnated with additives in order to introduce porous structure. These membranes typically include a mixture of a polymer and an inorganic filler, and have an open porosity. Suitable polymers include those chemically compatible with the electrolytes of the presently described systems, including high density polyethylene, polypropylene, polyvinylidene difluoride (PVDF), or polytetrafluoroethylene (PTFE). Suitable inorganic fillers may include silicon carbide matrix material, titanium dioxide, silicon dioxide, zinc phosphide, and cerium dioxide, and may be supported internally with a substantially non-ionomeric structure, including mesh structures or the like.

Suitable membranes also comprise continuous composite membranes. Continuous composite membranes comprise at least a material that has a continuous or discontinuous structure and a filler material that has a continuous or discontinuous structure. Suitable materials having a continuous or discontinuous structure may comprise one or more of polyethylene, polypropylene, poly(tetrafluoroethylene), poly(vinyl chloride), or a combination thereof. Suitable filler material may comprise nonwoven fibers or naturally occurring substances. Suitable nonwoven fibers may include fibers formed of nylon, cotton, polyesters, crystalline silica, amorphous silica, amorphous titania, crystalline titania, or a combination thereof. Suitable naturally fibers may be formed of rubber, asbestos, wood, or combinations thereof. The continuous composite membranes may also be porous. Suitable porosity may range from about 1% to about 50% volume fraction.

Suitable membranes may also comprise at least two layers of the above described membranes. For instance, a suitable membrane comprises a porous layer and a solid layer. For instance, a suitable membrane may comprise a polymeric solid layer and inorganic solid layer. For instance, a suitable membrane may comprise two layers capable of selective ion transport, such as any of the above mentioned solid cationic or anionic polymers. Other layers are included within the scope of this invention that may enhance or reduce properties such as conduction, strength, thickness, selectivity, permeability, or the like.

There may be a significant difference in the concentration of active material species in the positive and negative electrolytes in a cell. Despite the presence of the membrane, some finite flux of active materials species across a membrane may occur due to these concentrations differences, since substantially all membranes exhibit some permeability. When these species crossover the membrane, a loss of energy efficiency occurs, since charged species are self-discharging through direct interaction. However, the potential for electrolyte regeneration exists, if a cell employs different active material compounds.

Accordingly, suitable membranes may be configured to be effectively impermeable to active materials. Herein, “effectively impermeable” refers to preventing crossover of at least about 90% of at least one of the active materials, for a time period of about year or longer. Preferably, the membranes of the present disclosure are capable of preventing crossover at least about 99.0% of active materials, such as at least about 99.9% of active materials, for a period of about a year or more.

In various embodiments, an anion exchange membrane with small pore size may be used in an aqueous polysulfide battery containing a polysulfide negolyte active material. The membrane permits transition of a small anion, such as a hydroxide (OH⁻) anion, between the posolyte and negolyte chambers. This membrane blocks cations, such as sodium ions, due to its charge repelling features, and blocks large anions, such as permanganate anions, due to its small pore size. For example, the membrane may be a porous membrane having an average pore size of about 10 nm or less.

The membrane can be used with a permanganate positive electrode active materials or other suitable positive electrode active materials, such as sodium or lithium sulfate compounds. Various embodiment anion exchange membrane differs from the cation exchange membrane membranes that permit transition of alkali cations (e.g., sodium and/or lithium cations) between the posolyte and the negolyte chambers.

For example, various embodiments provide composite membrane membranes that include multiple polymeric membranes that are physically or chemically bonded together. The polymeric membranes can be ion exchange membranes, such as anion exchange membranes (AEM), cation exchange membranes (CEM), etc., or porous membranes such as nanofiltration membranes, ultrafiltration membranes, reverse osmosis membranes, polybenzimidazole-based membranes (PBI), membranes including polymers of intrinsic microporosity (PIM), etc., or the combinations thereof.

In some embodiments, a membrane may include one membrane layer including both electrophilic groups, such as anion exchange groups, and nucleophilic groups, such as cation exchange groups. For example, a membrane may include one or more bipolar membranes. In some embodiments, a membrane may include organic and inorganic compounds. For example, the membrane may be a blended or multi-layered membrane.

Most commercially available membrane membranes, such as hydrocarbon membranes, are not compatible with permanganate compound active materials, due to the oxidative nature of aqueous permanganate compounds (AqMn) with respect to hydrocarbons. Accordingly, various embodiments provide membrane membranes configured to transfer hydroxide ions, while resisting oxidation by AqMn compounds.

For example, various embodiments provide hydrocarbon membranes coated with a thin layer of an organic or inorganic film that is resistant to oxidation by AqMn compounds. Coating methods may include solution casting, co-extrusion, surface cross linking, and spin coating, for example. Organic film materials may include polyether ether ketones (PEEK), polysulfones, polystyrenes, polypropylenes, polyethylenes, or the like. The coated organic layer should be thin enough to still let working ions pass through while the manganese species are blocked.

For example, a PEEK reinforced AEM, such as a Fumasep FAA-3-PK-130 membrane may be suitable for successfully blocking AqMn. In particular, while not wishing to be bound to a particular theory, it is believed that such a membrane may become being covered in MnO₂ after operating in an ex-situ cell, but is still able to prevent AqMn crossover. It is predicted that if this protective coating is not present, the membrane polymer may be easily oxidized in the AqMn electrolyte.

Accordingly, in some embodiments, an AEM may be coated with a thin layer of MnO₂ to protect the membrane from the oxidative AqMn, while limiting the potential increase in resistance. For example, the membrane may be coated on at least one side with MnO₂, to prevent AqMn species from reaching membrane polymers that are susceptible to oxidation. The MnO₂ may be permeable to hydroxide ions, while blocking AqMn.

In some embodiments, the present invention provides an electrochemical cell, comprising: a membrane of the present invention; a positive electrode; and a negative electrode. In one example, an electrochemical cell includes a posolyte, a negolyte, and a membrane of the present invention disposed between the posolyte and negolyte. The posolyte solution includes a ferricyanide, ferrocyanide, permanganate, manganate, sulfur, and/or polysulfide compound, and the negolyte includes a sulfide and/or polysulfide compound. These electrochemical cells may be embodied in various physical architectures, including static (non-flowing) architectures or in flow battery (flowing) architectures.

In some embodiments, the positive electrode active material or/and the negative electrode active material comprises a sulfur-based compound. In some embodiments, the sulfur-based compound comprises sulfur (S₈), lithium (poly)sulfide (Li₂Sₓ, where x=1 to 8), sodium (poly)sulfide (Na₂Sₓ, where x=1 to 8), potassium (poly)sulfides (K₂Sₓ, where x=1 to 8), or a combination thereof. In some embodiments, the positive electrode active material or/and the negative electrode active material comprises a transition metal sulfide. In some embodiments, the positive electrode active material comprises an iron-cyanide based compound, and the electrochemical cell is a static cell. In some embodiments, the iron-cyanide based compound comprises a ferrocyanide compound, ferricyanide compound, or a combination thereof. In some embodiments, the iron-cyanide based compound comprises: ferrocyanide anions [Fe(CN)₆]⁴⁻, ferricyanide anions [Fe(CN)₆]³⁻, or a combination thereof; and cations comprising Li⁺, K⁺, Na⁺, or combinations thereof. In some embodiments, the positive electrode active material may comprise a manganese-based compound that may comprise a permanganate compound, a manganate compound, or a combination thereof. In some embodiments, the manganese-based compound comprises potassium permanganate (KMnO₄), potassium manganate (K₂MnO₄), sodium permanganate (NaMnO₄), sodium manganate (Na₂MnO₄), lithium permanganate (LiMnO₄), lithium manganate (Li₂MnO₄), or any combination or mixture thereof. In some embodiments, the positive electrode active material comprises a mixture of KMnO₄ and NaMnO₄. In some embodiments, the positive electrode active material comprises a manganese-based compound, iron-cyanide based compound, or a sulfur-based compound, and the posolyte and the negolyte are aqueous solutions having a pH at or above 10. In some embodiments, the positive electrode active material comprises a manganese-based compound, and the posolyte and the negolyte are aqueous solutions having a pH at or above 13. In some embodiments the concentration of the manganese-based compound is >1M (mol/L concentration), such as 2M or 5M. In some embodiments the concentration of the iron-cyanide based compound is >1M (mol/L concentration), such as 2M or 5M. In some embodiments the concentration of the sulfur-based compound is >1M (mol/L concentration), such as 2M or 5M or 10M.

Metals useful in the positive electrodes of the present invention include, but are not limited to, transition metals such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. In some embodiments, the metals for the positive electrode include Ti, V, Cr, Mn, Fe, Co, and Cu.

Metals useful in the negative electrodes of the present invention include, but are not limited to, transition metals such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. In some embodiments, the metals for the negative electrode include Sc, Ti, V, Cr, Mn, Fe, Co, Ni, Cu, and Zn.

### IV. Examples

### Example 1: Ortho-Tolyl Troger's Base Polymer (o-Tol TB)

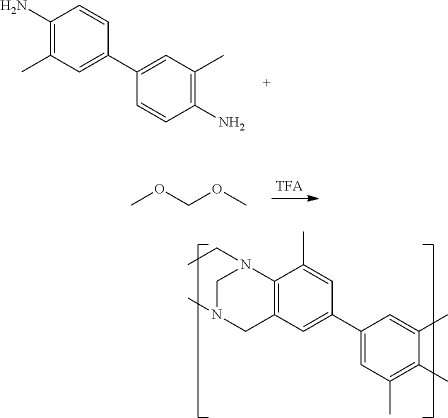

To a 250 mL two-neck round bottom flask with 10.00 g (47.10 mmol) o-tolidine was added 20.84 mL (245.5 mmol) dimethoxymethane. The system was sparged with nitrogen and cooled to 0° C. in an ice bath, then treated by the dropwise addition of 80 mL trifluoroacetic acid. The flask was allowed to warm slowly to room temperature and stirred under nitrogen for 96 hours. The viscous amber solution was slowly poured into a concentrated ammonium hydroxide solution to precipitate the product as a pink continuous string. The precipitate was filtered, dissolved in chloroform, then re-precipitated from methanol and treated with 100 mL ammonium hydroxide until the polymer turned tan in color. The tan polymer was dissolved and re-precipitated twice more from chloroform and methanol. The solid residues were rinsed with acetone, then dried under vacuum. ¹H NMR (500 MHz, Chloroform-d) δ 7.19 (s, 2H), 6.92 (s, 2H), 4.64 (d, J=16.9 Hz, 2H), 4.36 (s, 2H), 4.06 (d, J=16.9 Hz, 2H), 2.44 (s, 5H).

### Example 2: Dimethyl Diamino TB Polymer

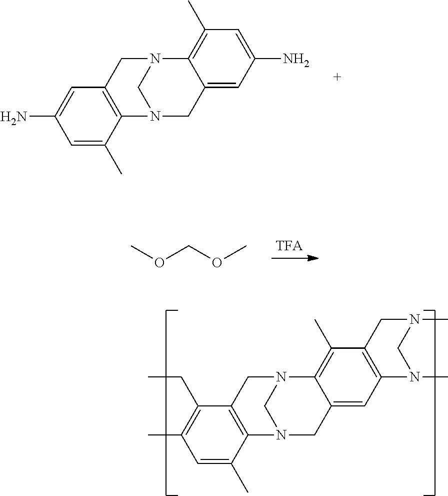

To a 250 mL two-neck round bottom flask with 3.00 g (10.7 mmol) dimethyl diamino troger's base was added 4.73 mL (53.5 mmol) dimethoxymethane. The system was sparged with nitrogen and cooled to 0° C. in an ice bath, then treated by the dropwise addition of 80 mL trifluoroacetic acid. The flask was allowed to warm slowly to room temperature and stirred under nitrogen for 96 hours. The viscous solution was slowly poured into a concentrated ammonium hydroxide solution to precipitate the product. The precipitate was filtered, dissolved in chloroform, then re-precipitated from methanol. This process was repeated 3 times. The solid residues were rinsed with acetone, then dried under vacuum. ¹H NMR (500 MHz, Chloroform-d) δ 6.86 (s, 2H), 4.40-3.97 (m, 6H), 3.86 (m, 4H), 3.61 (br. s, 2H), 2.35 (s, 6H).

### Example 3: o-Tol Sulfonyl TB Polymer

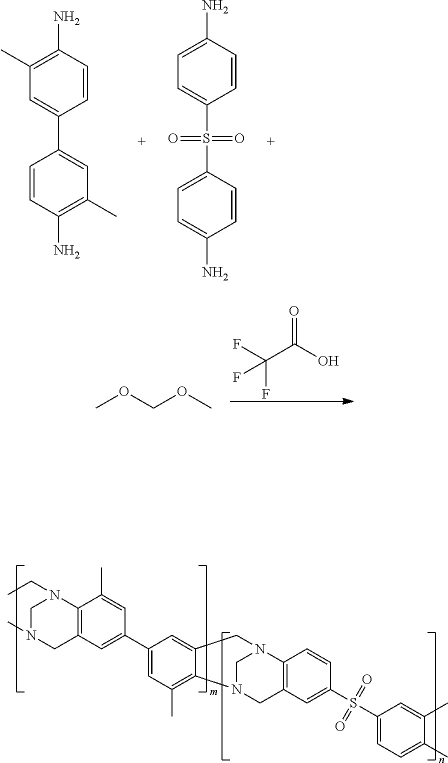

To a 250 mL two-neck round bottom flask with 3.00 g (10.7 mmol) o-tolidine and 0.88 g (3.53 mmol) 4,4′-sulfonyldianiline was added 5.38 mL (70.7 mmol) dimethoxymethane. The system was sparged with nitrogen and cooled to 0° C. in an ice bath, then treated by the dropwise addition of 24 mL trifluoroacetic acid. The flask was allowed to warm slowly to room temperature and stirred under nitrogen for 96 hours. The viscous solution was slowly poured into a concentrated ammonium hydroxide solution to precipitate the product as a white powder. The precipitate was filtered, dissolved in chloroform, then re-precipitated from methanol. This process was repeated 3 times. The solid residues were rinsed with acetone, then dried under vacuum. ¹H NMR (500 MHz, Chloroform-d) δ 7.69 (d, J=31.2 Hz, 2H), 7.19 (m, 4H), 6.91 (m, 4H), 4.63 (d, 4H), 4.35 (s, 4H), 4.05 (d, J=16.9 Hz, 5H).

### Example 4: Sulfonated o-Tol TB Polymer

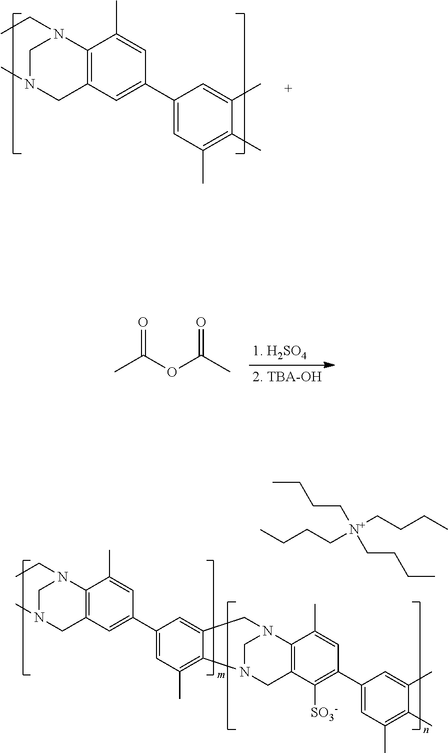

To three vials were added 100 mg (0.40 mmol) o-Tol TB polymer of Example 1 (69 kDa MW) and 5 mL of 1,2-dichloroethane. The vials were heated while stirring to 50° C. In three separate small vials, the following volumes of acetic anhydride were added to 1 mL each of 1,2-dichloroethane: Vial 1=25 μL; Vial 2=50 μL; Vial 3=100 μL. The vials were placed in a cooled ice bath, then the following indicated volumes of sulfuric acid (97%) were added (Vial 1=12.4 μL; Vial 2=24.8 μL; Vial 3=49.6 μL). The resulting acetyl sulfate solutions from each vial were taken up in a syringe and added, dropwise, to the stirred solutions of PIM-3. The reaction was stirred at 50° C. for 2.5 hours. The sulfonic acid o-Tol TB polymer products from each vial were separately ion-exchanged by precipitating the product solution into a solution of 0.3 M tetrabutylammonium hydroxide in methanol. The NMR for the product of Vial 3 is provided. ¹H NMR (500 MHz, Chloroform-d) δ 7.18 (s, 1.6H), 6.90 (s, 1.6H), 4.62 (d, J=15.3 Hz, 2H), 4.34 (s, 2H), 4.04 (d, J=16.9 Hz, 2H), 1.63 (s, 8H).

### Example 5: Propane Sulfonate o-Tol TB Polymer

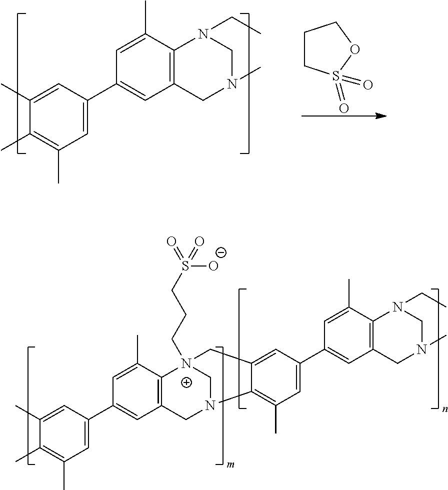

o-Tol TB polymer of Example 1 (2.16 g) was dissolved in 45 mL N-methyl-2-pyrrolidone and heated to 80° C. under a nitrogen atmosphere. After complete dissolution of the polymer, the solution was treated with propane sultone (2.29 mL, 3 eq.). The reaction was stirred at 80 C under nitrogen for 24 hours, cooled to room temperature and poured slowly into water. The polymer immediately precipitated from solution and was filtered and washed several times with water, then rinsed in acetone and washed several times in acetone to remove water. The sample was dried under vacuum overnight. Copolymer composition: m=1, n=9. ¹H NMR (500 MHz, DMSO-d6, 100° C.) δ 7.20 (s, 2H), 7.05-6.87 (m, 2H), 4.54 (d, 2H), 4.25 (s, 2H), 3.99 (d, 2H), 3.50 (t, 0.2H), 2.52-2.49 (m, 0.2H), 2.37 (s, 6H), 1.84-1.76 (m, 0.2H).

### Example 6: Sulfo-Propyl o-Tol TB Polymer

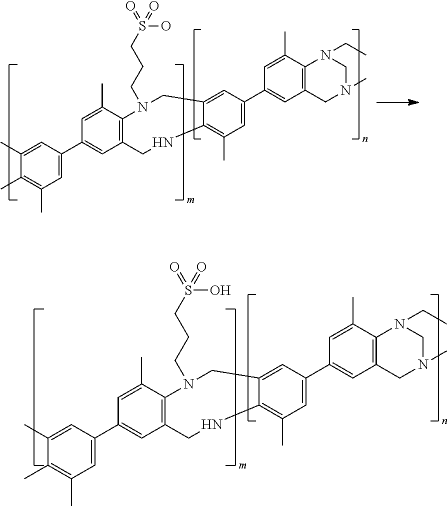

The zwitterionic o-Tol TB polymer (Example 5) dissolved in a suitable solvent is poured into a stirred solution of 0.3 M tetrabutylammonium hydroxide in methanol. ¹H NMR (500 MHz, Chloroform-d, 60° C.) δ 7.17 (s, 2H), 6.88 (s, 2H), 4.61 (d, J=16.9 Hz, 2H), 4.33 (s, 1H), 4.03 (d, J=17.0 Hz, 2H), 3.44-3.35 (t, 0.1H), 2.39 (t, 0.1H), 2.18 (s, 0.6H), 2.08-1.98 (m, OH). Alternatively, the zwitterionic o-Tol TB polymer is suspended as a solid in solution with pH>10.

### Example 7: Methyl Sulfate Methylated o-Tol TB Polymer

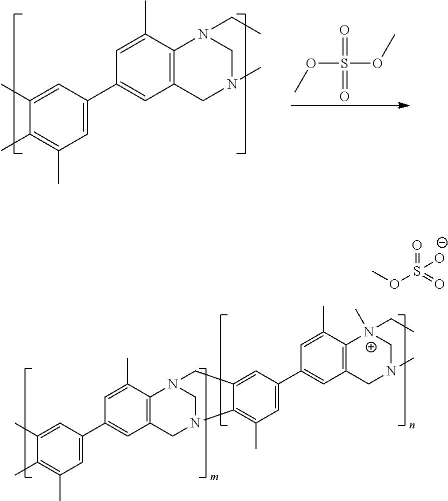

o-Tol TB polymer of Example 1 (10.0 g) was dissolved in 200 mL N-methyl-2-pyrrolidone and heated to 80° C. under a nitrogen atmosphere. After complete dissolution of the polymer, the solution was treated with dimethyl sulfate (11.46 mL, 3 eq.). The reaction was stirred at 80 C under nitrogen for 24 hours, cooled to room temperature and the very viscous solution was poured into water, and broken up with a blade. The wet polymer was rinsed in acetone and crushed to a fine powder slurry in acetone, then filtered to remove the acetone and dried under vacuum. Copolymer composition: m=1, n=2. XPS Anal: 33% quaternary ammonium, 67% tertiary amine. ¹H NMR (500 MHz, DMSO-d6, 60° C.) δ 7.79-7.00 (m, 6H), 5.67-4.77 (m, 6H), 4.77-3.98 (m, 6H), 3.74 (s, 6H), 2.87-2.78 (s, 6H), 2.40 (s, 18H).

### Example 8: Neutral Methyl o-Tol TB Polymer

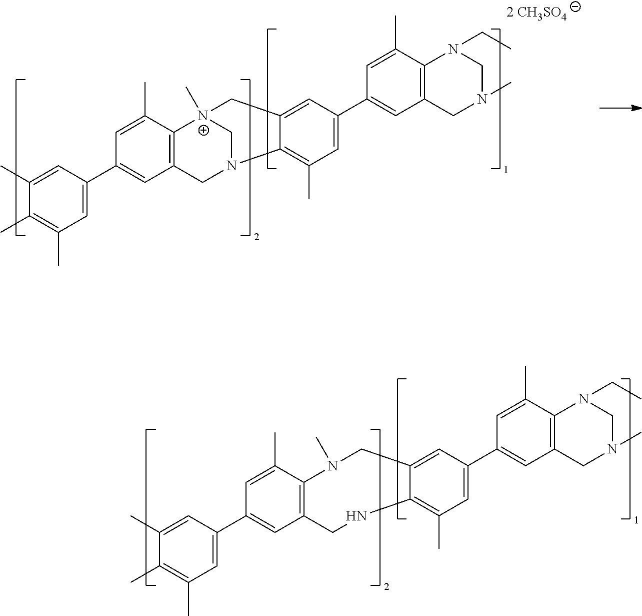

The methylated o-Tol TB polymer of Example 7 was dissolved in a suitable solvent is poured into a stirred solution of 0.3 M tetrabutylammonium hydroxide in methanol. Alternatively, the methylated o-Tol TB polymer is suspended as a solid in solution with pH>10. ¹H NMR (500 MHz, Chloroform-d) δ 7.27-6.86 (m, 6H), 4.72-4.33 (m, 5H), 4.14 (d, 2H), 2.67 (s, 2H), 2.48 (d, 1H), 2.43-2.33 (m, 2H), 2.29-2.21 (m, 2H).

### Example 9: Membranes

The membrane can exist as a stand-alone film or as a coating on a porous or otherwise ion-conductive substrate, wherein the purpose of the substrate is to either impart additional mechanical durability; or to impart chemical durability, for example to an electrolyte which is shown to be reactive toward the Tröger's base polymer membrane; or to impart an additional ion-sieving effect; or to simplify the manufacturing process. The TB membrane may be coated onto the substrate or may be cast independently and pressed against or laminated to the substrate.

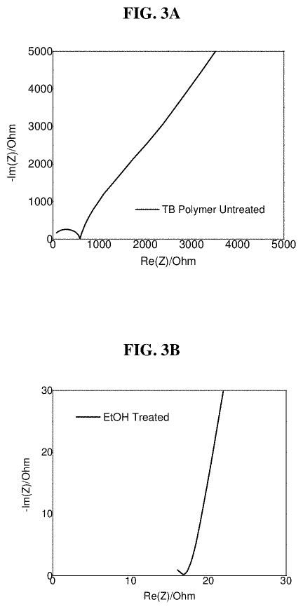

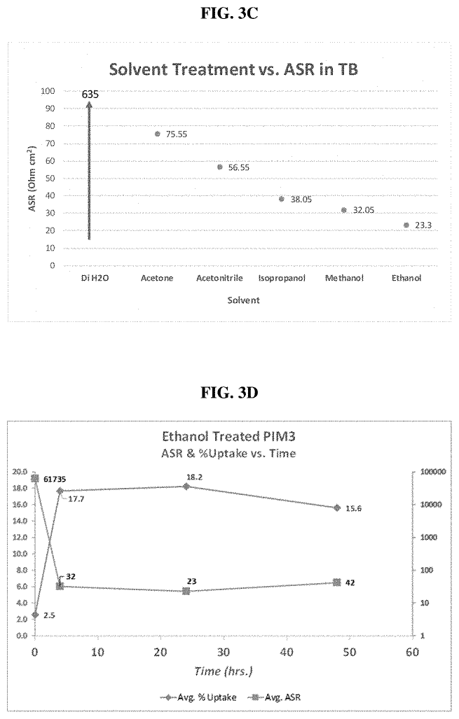

To enhance ion conductivity in an aqueous environment, the TB membrane is subjected to an organic solvent pre-treatment wherein the membrane is incubated in a solution of organic solvent in which the TB membrane is not soluble. This incubation may occur at room temperature, up to reflux temperature, at ambient or elevated pressure for a period of time from a span of minutes to several days. In one embodiment, the membrane is soaked for a period of 4 to 24 hours in reagent alcohol (ethanol) at reflux. This process has the surprising effect of locking the membrane pores into a metastable “open” configuration, significantly enhancing the permeability of ions through the membrane, which is evident from potentiometric electrochemical impedance spectroscopy (PEIS) measurements in an ex situ cell with stainless steel blocking electrodes using the electrolyte 2 M NaOH in water (FIG. 3B). The pores remain open even when the membrane is removed from alcohol solvent and placed in 2 M NaOH or other alkaline aqueous electrolyte, and the ASR as measured by PEIS remains stable in the electrolyte, indicating that the pores remain open in this metastable configuration as long as the membrane remains hydrated. When dehydrated either by air-drying or under vacuum, this metastable configuration is lost, as indicated by a failure of the membranes to fully rehydrate, measured by PEIS and by water uptake, and the membrane must be re-opened by refluxing again in reagent alcohol.

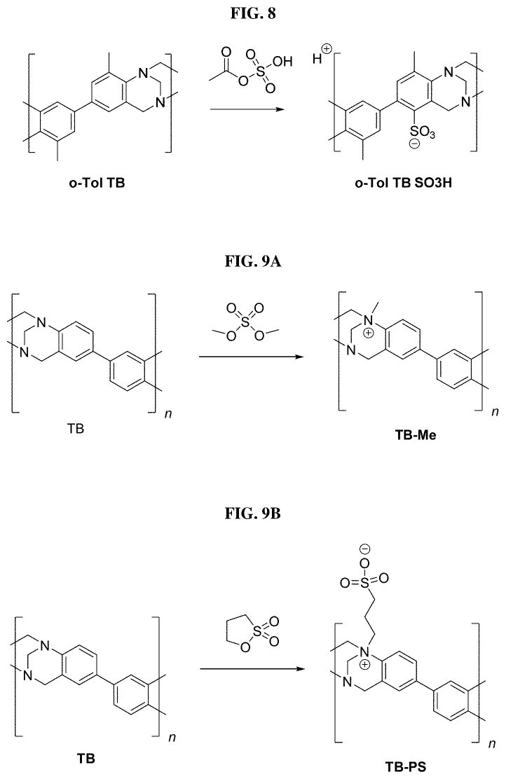

One method by which the conductivity of the membrane can be increased is by the sulfonation of the TB polymer, generating a sulfonic acid derivative of the polymer which is anionic in alkaline aqueous electrolyte. Sulfonation can be achieved by homogeneous or heterogeneous reaction of the polymer. In another embodiment, the polymer was dissolved in dichloroethane under nitrogen and heated to 50° C. to dissolve the polymer completely. In a separate flask, a dichloroethane solution of acetic anhydride was treated with concentrated sulfuric acid, forming acetyl sulfate. The acetyl sulfate solution was slowly added to the solution of TB polymer and the reaction was stirred for 2.5 hours (FIG. 8), forming a very viscous solution which was quenched by pouring into methanol. The precipitated polymer in its sulfonic acid (TB-SO₃H) form has limited solubility in organic solvents; it can be ion exchanged by stirring the solid polymer in a concentrated solution of tetrabutylammonium (TBA) hydroxide. The TB-SO₃TBA membrane is soluble in organic solvents such as chloroform and may be cast into membranes via solution processing methods such as coating or casting. The extent of sulfonation can be controlled by varying the equivalents of acetyl sulfonate added to the polymer solution, and/or by changing the reaction duration, temperature, or solvent. In an alternative route to preparation of the TB-SO₃X (where X can be a proton H or another cation such as tetrabutylammonium), pre-fabricated polymer membranes were treated directly with fuming sulfuric acid.

Enhancement of the conductivity of the membrane can likewise be obtained by alkylating the tertiary amines in the polymer backbone, of which there are two per monomeric unit, either quantitatively or in part (FIG. 9). When combined with the solvent treatment, by refluxing the alkylating agent, for example dimethyl sulfate, with the alcohol solvent in the presence of the membranes, a dramatic decrease in ASR (corresponding to an increase in water uptake and permeability) is observed. The resulting cationic polymer has a free anion for every alkylated amine; when the alkylating agent is dimethyl sulfate, this ion is sulfate. When it is methyl iodide, the ion is iodide. The counter-ion can be ion-exchanged by immersing the membrane in a solution with the appropriate ion, for example in sodium hydroxide solution to increase hydroxide conductivity. The electrolyte uptake % (EU) of the cationic TB membrane after treatment in refluxing reagent alcohol for 24 hours in the presence of 3 equivalents dimethyl sulfate is 33%.

The behavior of the cationic polymer may be considered obvious, as it is well demonstrated in the literature that quaternized ammonium groups increase hydroxide conductivity relative to neutral polymer species in alkaline aqueous electrolyte. However, it was surprising that alkylating this same position with propane sultone, and thus forming a zwitterion, increased the ionic conductivities to an even greater extent than was observed in the cationic polymer. The TB membrane, when refluxed in reagent alcohol in the presence of propane sultone, expands in dimension significantly. The extent of alkylation of the polymer with the zwitterionic group (and the resulting effect on ion-selectivity) can be changed by varying the equivalents of alkylating agent, the duration of the reaction, the temperature of reaction, and/or the solvent in which the reaction takes place (Table 1). After removing the membrane from solution, rinsing it in ethanol to remove residual alkylating agent, then removing organic solvent by soaking the membrane in DI water, then finally incubating it in 2 M NaOH, membranes demonstrate an EU up to 102% relative to dry weights, indicating that the membrane becomes very hydrophilic in its zwitterionic form.

TABLE 1
Heterogeneous reaction screening for propane sultone-
treated membranes with and without diiodobutane crosslinker.

| | Equiv. | Time | | Thickness | ASR | S₂²⁻P_{eff} |
|---|---|---|---|---|---|---|
| Solvent | PS | (h) | Crosslinker | (mm) | (W · cm²) | (cm²/s) |
| EtOH | 0 | 4 | — | 50 | 25.5 | 6.7E−10 |
| EtOH | 3 | 24 | — | 50 | 0.3 | 3.5E−18 |
| EtOH | 3 | 4 | — | 50 | 55 | NT |
| EtOH | 3 | 24 | 1 hr Bu | 50 | 0.78 | 3.6E−8 |
| EtOH | 3 | 24 | 2 hr Bu | 50 | 0.98 | NT |
| MeCN | 3 | 24 | 1 hr Bu | 50 | 67 | NT |
| MeCN | 3 | 24 | 2 hr Bu | 50 | 53 | NT |
| EtOH | 3 | 24 | — | 167 | 1.32 | >1E−8 |
| EtOH | 1 | 24 | — | 167 | 1.96 | >1E−8 |

NT: not tested

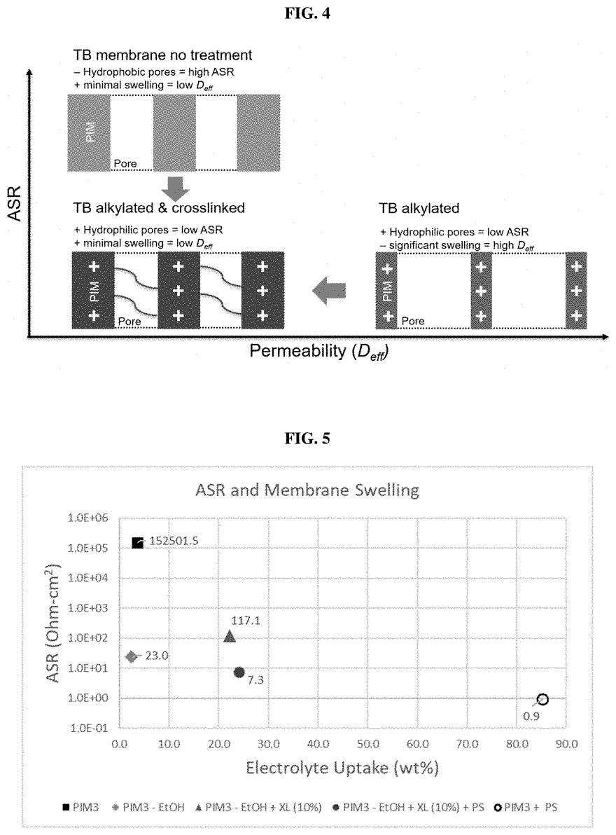

The dimensional increase observed from the EU study reflects significant enlargement of the membrane pores, which mitigates the membrane's intrinsic ion selectivity (by allowing large hydrated ions to pass through). In order to prevent this, the membranes may be crosslinked, to lock pores as much as possible into their pre-hydrated dimensionality (FIG. 4). In this embodiment, the membrane has a controlled pore size which is similar to its dry state but has zwitterionic groups pendant to the polymer backbone which create a channel through which small migrating ions such as hydroxide may pass, while large polyatomic ions are blocked due to pore size. The zwitterionic polymer may be cast into a membrane and then crosslinked, or the crosslinked membrane may be treated with propane sultone or another pro-zwitterionic alkylating agent.

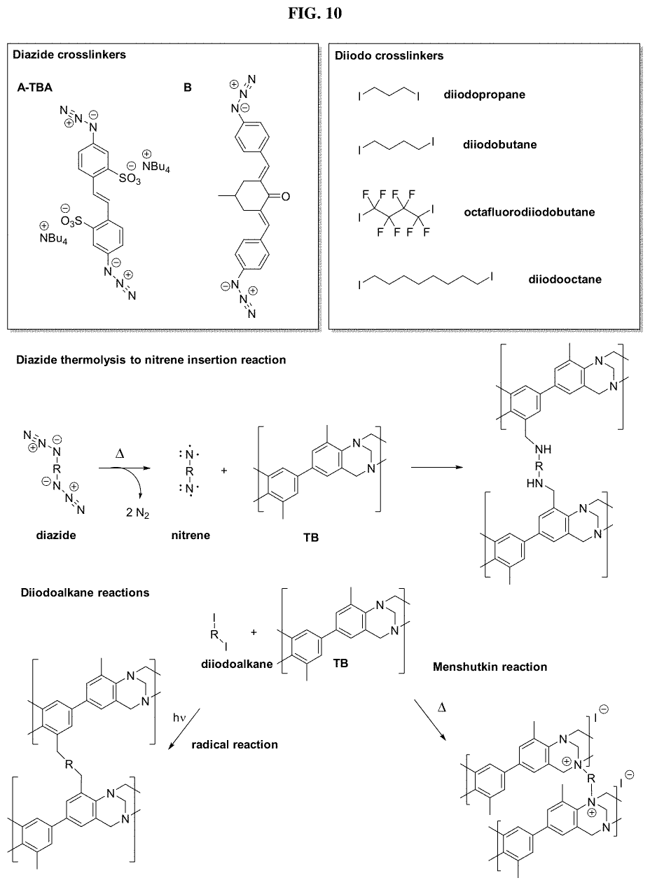

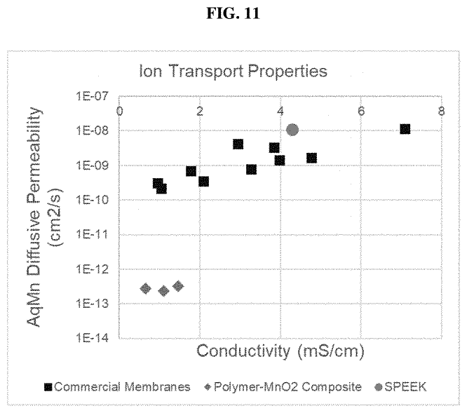

The crosslinking agent may be applied by solvent treatment of the membrane or by blending into the polymer ink during casting or coating and activated either thermally, chemically, or optically (as with UV-curing processes) (FIG. 10). Diiodoalkane reagents, where the hydrocarbon chain length has been varied from three to eight (propane to octane), have been utilized to crosslink TB polymers. In one embodiment, the diiodoalkane reagent was applied as an additive to an ethanol solution wherein the membrane was refluxed for a period of time from 4 to 24 hours. The resulting material is quaternized at the tertiary amines according to FIG. 10. In another embodiment, the same diiodoalkane reagents can be blended into the polymer ink during the membrane fabrication process. The membrane can then be cured by UV irradiation, causing the halo-alkyl bond to cleave homolytically and inducing a radical reaction wherein the iodo radical abstracts a hydrogen from any saturated C—H group on the polymer, then this site recombines with an alkyl radical, forming a C—C bond (FIG. 10). In FIG. 10 showing the UV-radical reaction route, the site of reaction is a benzylic C—H group, but reactivity is not limited to this position. Other radical-type crosslinking reactions can be induced by the addition of diazido reagents, which can be initiated either thermally or by UV irradiation, as has been shown in the literature. In FIG. 5, various combinations of membrane treatment processes including alkylation with propane sultone, solvent treatment with reagent alcohol, and thermal crosslinking with diazido crosslinkers are shown. It can be seen that alkylation of o-Tol TB with the pro-zwitterionic alkylating agent propane sultone, to form TB-PS, significantly decreased the ASR (from >150,000 Ω cm² in the case of untreated TB to 0.91 Ω cm² in the case of TB-PS) and increased the swelling (measured by weight % electrolyte uptake), and that swelling can be dramatically reduced by crosslinking.

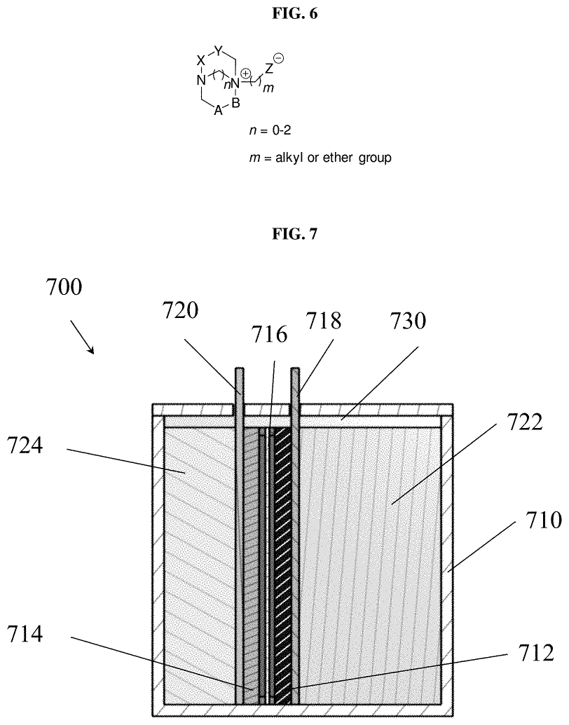

While TB polymers are used as example materials, any polymer containing tertiary amines may be alkylated to yield a zwitterionic polymer with sulfobetaine or carboxybetaine functionalities. For the purposes of membrane or polyelectrolyte materials, a second required characteristic of the material is that it must be ionically conductive, with higher conductivity for charge-balancing ions than for redox ions or ions otherwise derived from the negative electrode or positive electrode materials, the latter of which must be isolated to their respective half-cells in order to maintain battery capacity and prolong the cycle life. Polymers composed of the general structure of rigid, tertiary-amine containing polymeric unit (FIG. 6) may be alkylated with zwitterionic groups at one or both nitrogen sites. The zwitterionic functionality Z, depicted here on only one of the two amine sites, can be composed of an alkyl sulfonic acid (sulfobetaine), phosphoric acid (phosphobetaine), carboxylic acid (carboxybetaine), or ether of the same. X and Y are carbon atoms belonging to a first aromatic moiety and A and B are carbon atoms belonging to a second aromatic moiety. The alkyl bridge between the two tertiary amine groups may be comprised of a methylene (—CH₂—) or ethyl (—CH₂—CH₂—) group.

Some embodiments undergo ring-opening chemical reactions induced at the quaternary ammonium site of the alkylated TB after a period of exposure to alkaline electrolyte. These examples result in a conversion of zwitterionic moieties to anionic, and cationic moieties to neutral, as the cationic quaternary ammonium site is converted to a tertiary amine and the bridging group of the TB is removed (Formula I, wherein Y is absent). In alternative preparations, the ring-opened derivatives were prepared directly from solution by pouring into 0.3 M tetrabutylammonium hydroxide solution, by immersion of the powdered polymer into 2 M NaOH, and by immersion of the membrane into 2 M NaOH. In one example, a solution of 10 g zwitterionic TB in N-methyl-2-pyrrolidone solution was poured into 0.3 M tetrabutylammonium hydroxide and the precipitate was recovered and washed several times with methanol then acetone. The solid polymer was dried overnight under vacuum and then analyzed by x-ray photoemission spectroscopy. Analysis of the nitrogen signal indicated complete conversion of the quaternary ammonium groups to tertiary amines. In another example, 20 mg of solid cationic methylated TB polymer powder (67% quaternary ammonium by x-ray photoemission spectroscopy) was immersed in 2 M NaOH solution overnight. The powder was filtered and washed several times with water, then with methanol to remove residual water. The powder was then dried overnight under vacuum and analyzed by x-ray photoemission spectroscopy and showed no residual quaternary ammonium signals, indicating alkylated moieties had undergone complete conversion to the ring-opened derivative.

In some applications of the membrane, the electrolyte solution is capable of reacting spontaneously with the polymer. To mitigate reaction with the polymer by the electrolyte, a layer of MnO₂ may be fabricated on the membrane surface or embedded within the membrane to yield a polymer-MnO₂ composite.

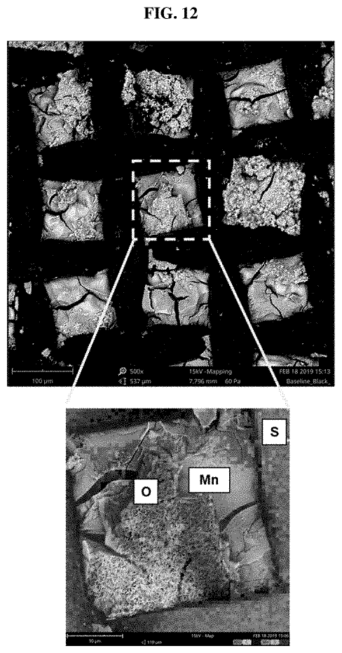

In one example, a solution of 1.5 M NaMnO4 and 2 M NaOH was prepared and placed in one chamber of an H-cell while the other chamber was filled with a solution of 2 M NaOH and 1.2 M Na2CO3. Between the two chambers was placed a PEEK-reinforced Fumasep FAA-3-PK-130 anion exchange membrane and a polybenzimidazole (PBI) non-ionic membrane, with the FAA-3-PK-130 membrane interfacing with the permanganate side of the cell. After 500 hours, no permanganate crossover was observed in the blank, carbonate containing side of the cell. The cell was disassembled, and it was seen that both FAA-3-PK-130 membrane and PBI membrane remained complete. On the surface of the FAA-3-PK-130 membrane facing toward permanganate electrolyte was a layer of MnO2. The membrane was dried and analyzed by energy dispersive X-ray spectroscopy, wherein it was observed that the formed MnO2 layer consisted mainly of manganese and oxygen elements as shown in FIG. 12.

In one example, a solution of 1.5 M NaMnO₄ and 2 M NaOH was prepared and placed in one chamber of an H-cell while the other chamber was filled with a solution of 2 M NaOH and 1.2 M Na₂CO₃. Between the two chambers was placed a PEEK nanofiltration membrane and TB-PS, with the PEEK membrane interfacing with the permanganate side of the cell. After 1000 hours, no permanganate crossover was observed in the blank, carbonate containing side of the cell. The cell was disassembled, and it was seen that the PEEK membrane had cracked whereas the TB membrane remained complete. On the surface of the TB-PS membrane was a layer of MnO₂. The membrane was dried and analyzed by scanning electron microscopy, wherein it was observed that the polymer layer comprised 170 micrometers of the film and the MnO₂ layer comprised 30 micrometers of the film, such that the composite was approximately 200 micrometers in thickness and 2.5 cm² in area.

In an alternative preparation of the polymer-MnO₂ composite, a 100 cm² square of TB-PS membrane was laid flat onto glass, then 10 mL of 0.1 M NaMnO₄ solution in water was blade-coated onto the membrane. A thin MnO₂ layer formed rapidly and excess permanganate solution was rinsed away with deionized water between steps. This process was repeated 9 times, until successive coatings yielded no visible change in the composition of the membrane surface.

It is also possible to yield ion-selective polymer-MnO₂ composites from a bound slurry of MnO₂ particles. In one example, 30 mg/mL sPEEK (sulfonated poly ether ether ketone) solution in dimethylformamide solution was prepared and 20 wt % amorphous MnO₂ was added. 3 mL of the black slurry was drop-cast onto warm glass and dried under mild heating on a hot plate. The resulting black film was 45 micrometers in thickness and 16 cm² in area.

The ion-selectivity of the polymer-MnO₂ composites was validated by comparing conductivity in 2 M NaOH and diffusive permeability in H-cells, wherein one chamber of the cell is filled with a solution of 1.5 M NaOH and 2 M NaOH and the other chamber of the cell is filled with a solution of 2 M NaOH and 1.2 M NaHCO₃ and a membrane was disposed between the two cells for a duration between 623 and 1020 hours. The ion selectivity values were compared against a large number of stable commercial perfluorosulfonic acid membranes and membrane composites, showing that the polymer-MnO₂ composites significantly outperformed these commercial membranes in selectivity (FIG. 11).

In addition to alkaline aqueous electrochemical applications, TB membranes and copolymers thereof modified by the above procedures may be applied to organic electrochemical applications i.e., Li-ion batteries, Li metal batteries, and other commercial and emerging battery applications where a membrane with a combination of size-sieving and electrostatic screening properties would benefit the device.

The membrane may also be employed as a polyelectrolyte. It has been shown in the literature that zwitterionic porous polyelectrolytes show superior anti-fouling properties when used in wastewater treatment, water purification, or environmental remediation applications compared to cationic or anionic porous polyelectrolytes. TB polymers and polyelectrolytes can be envisioned as having further utility toward separation or purification applications in fuel cells, in water desalination, and in hydrometallurgy.

They can further be envisioned as having utility in in vivo or in vitro separations applications, as in particular, zwitterionic and anionic polymers have biomimetic character. TB membranes modified by the above procedures may be applied as coatings on devices for blood glucose monitoring, for example, where hydrophilicity and biocompatibility are particular requirements and certain small analytes (such as glucose) must be allowed to permeate the membrane while large proteins (such as serum albumin), blood cells, and small molecules (such as acetaminophen) must be excluded from permeating the device. They may also be applied as coatings on medical implants.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A membrane comprising a polyamine polymer.

2. The membrane of claim 1, wherein the polyamine polymer is a zwitterionic quaternary polyamine polymer.

3. The membrane of claim 1, wherein the membrane allows monoatomic and monovalent ions and/or the acid/base dissociation products of water to permeate the membrane such that the conductivity of the membrane is at least 0.01 mS/cm and the diffusive permeability of polyvalent ions and/or ionic transition metal complexes is limited to less than 1×10⁻⁸ cm²/s.

4. The membrane of claim 3, wherein the monoatomic and monovalent ions are independently H⁺, Li⁺, Na⁺, K⁺, F⁻, Cl⁻, Br⁻, or I⁻.

5. The membrane of claim 3, wherein the polyvalent ions are independently S₂²⁻, S₄²⁻, S₈²⁻, MnO₄⁻, or MnO₄²⁻.

6. The membrane of claim 1, wherein the membrane filters aqueous or non-aqueous electrolytes in electrochemical applications.

7. The membrane of claim 1, wherein the polyamine polymer comprises a Tröger's base polymer or copolymer thereof.

8. The membrane of claim 1, wherein the polyamine polymer comprises a repeat unit of Formula J: 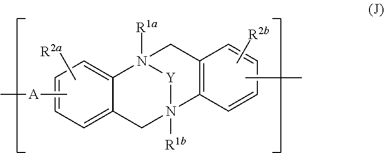
wherein:
Y is absent or —CH₂—;
R^{1a} and R^{1b} are each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻;
each L¹ is independently C₁₋₆ alkylene;
alternatively, R^{1a} and R^{1b} on different polymers can combine to form a crosslinker;
R^{2a} and R^{2b} are each independently C₁₋₆ alkyl or C(O)O⁻;
alternatively, R^{2a} and R^{2b} on different polymers can combine to form a crosslinker; and
A is a bond, optionally substituted C₁₋₆ alkylene, urethane, amide, sulfone, ester, ether, a linker, or combined with the adjacent rings to form an optionally substituted C₆₋₂₀ bicyclic cycloalkyl.

9. The membrane of claim 8, wherein:
R^{1a} and R^{1b} are each independently absent, hydrogen, C₁₋₃ alkyl, or -L¹-S(O)₂O⁻, and L¹ is a C₂₋₄ alkylene;
alternatively, R^{1a} and R^{1b} on different polymers can combine to form a crosslinker, wherein the crosslinker is C₃₋₁₀ alkylene or C₃₋₁₀ haloalkylene.

10. The membrane of claim 8, wherein:
R^{1a} and R^{1b} are each independently absent, hydrogen, methyl, or —CH₂CH₂CH₂S(O)₂O⁻;
alternatively, R^{1a} and R^{1b} on different polymers can combine to form a crosslinker, wherein the crosslinker is

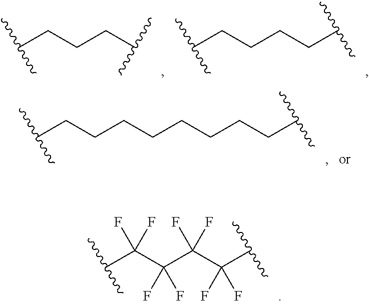 [SMILES: *CCC* ; *CCCC* ; *CCCCCCCC* ; *C(F)(F)C(F)(F)C(F)(F)C(*)(F)F]

11. The membrane of claim 8, wherein:
R^{1a} and R^{1b} on different polymers can combine to form a crosslinker, wherein the crosslinker is 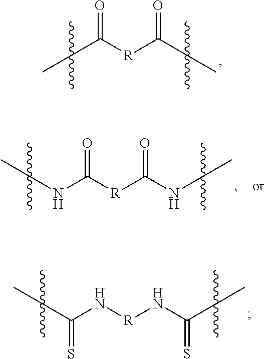
and
wherein R is C₂₋₁₀ alkylene, poly(ethylene glycol), arylene or heteroarylene.

12. The membrane of claim 8, wherein
R^{1a} and R^{1b} are each independently hydrogen, methyl, or —CH₂CH₂CH₂S(O)₂O⁻;
alternatively, R^{1a} and R^{1b} on different polymers can combine to form a crosslinker, wherein the crosslinker is 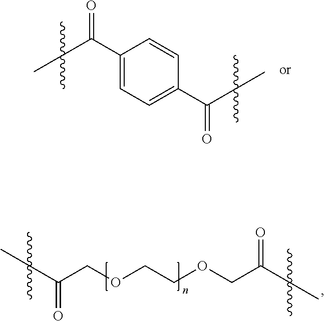
wherein n=1-12.

13. The membrane of claim 8, wherein:
R^{2a} and R^{2b} are each independently C₁₋₃ alkyl;
alternatively, R^{2a} and R^{2b} on different polymers can combine to form a crosslinker, wherein the crosslinker is C₃₋₁₀ alkylene, C₃₋₁₀ haloalkylene,

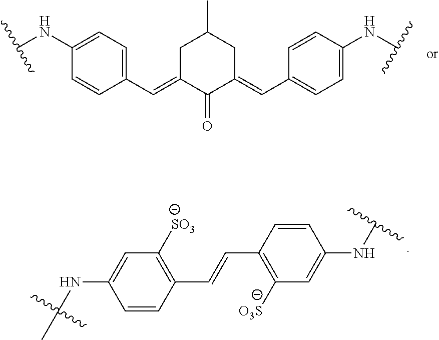

14. The membrane of claim 8, wherein:
R^{2a} and R^{2b} are each independently methyl;
alternatively, R^{2a} and R^{2b} on different polymers can combine to form a crosslinker, wherein the crosslinker is

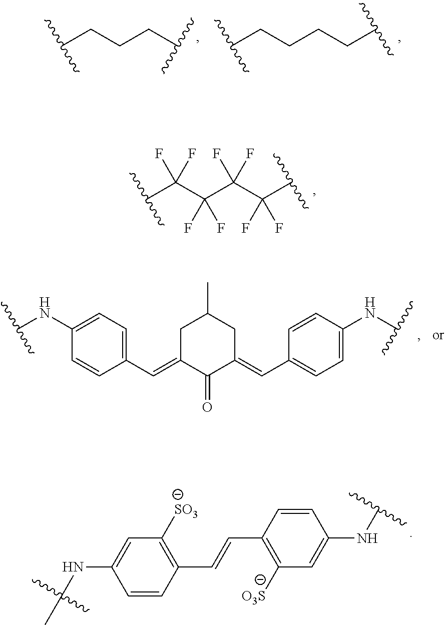

15. The membrane of claim 8, wherein A is a bond, methylene, ethylene, propylene, butylene, urethane, amide, sulfone, ester, ether, 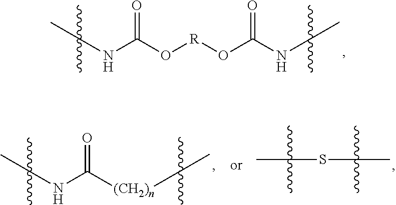
wherein R is a C₁₋₁₂ alkylene, and n is 0 to 20.

16. The membrane of claim 8, wherein A is a bond, sulfone, ester, ether, 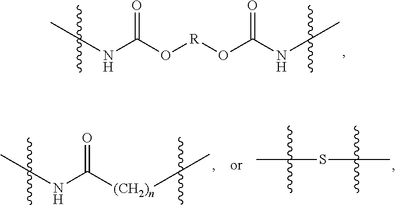
and
wherein R is a C₁₋₁₂ alkylene, and n is 0 to 20.

17. The membrane of claim 1, wherein the polyamine polymer is 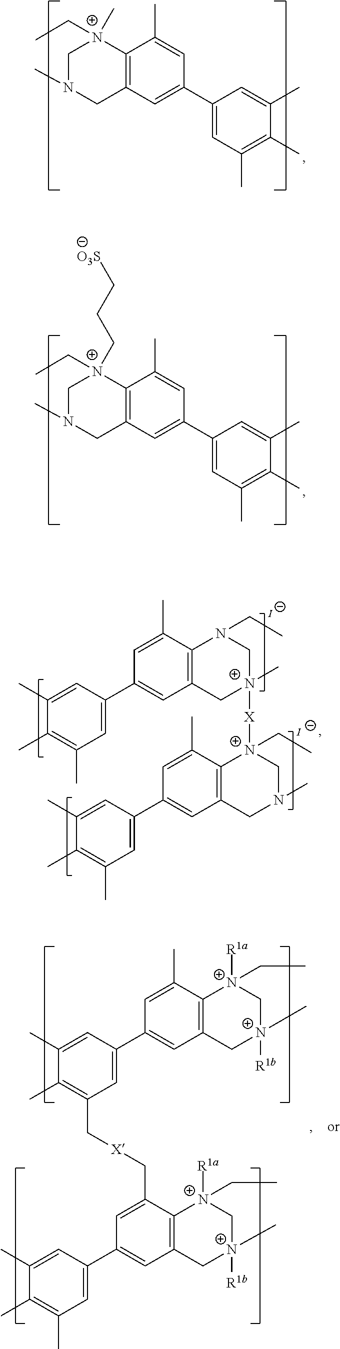 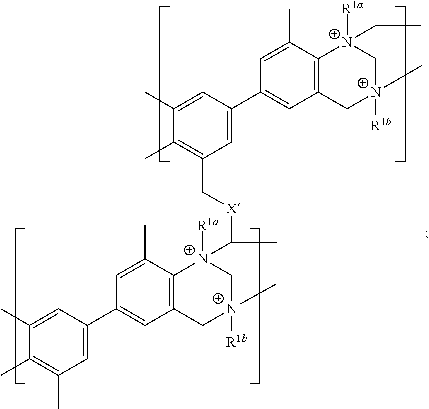
wherein:
X is 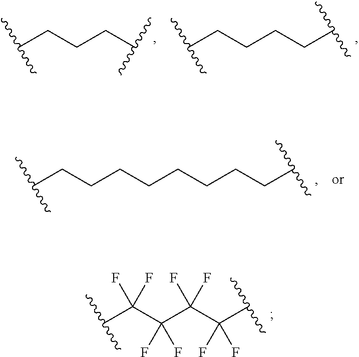 [SMILES: *CCC* ; *CCCC* ; *CCCCCCCC* ; *C(F)(F)C(F)(F)C(F)(F)C(*)(F)F]
and
X′ is

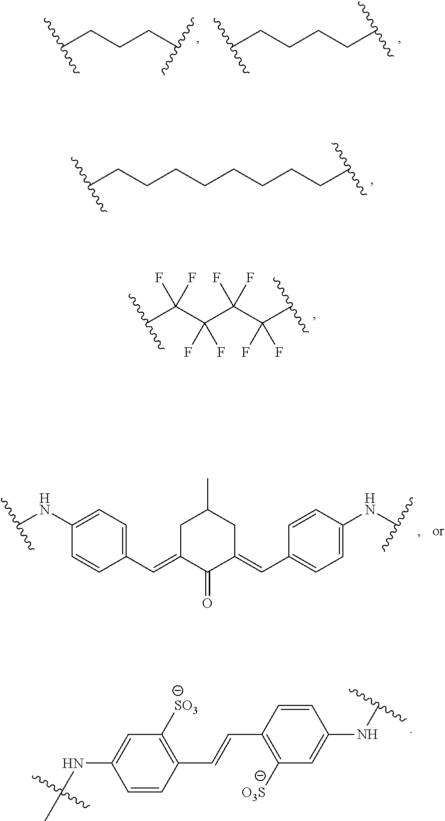

18. The membrane of claim 1, wherein the polyamine polymer is

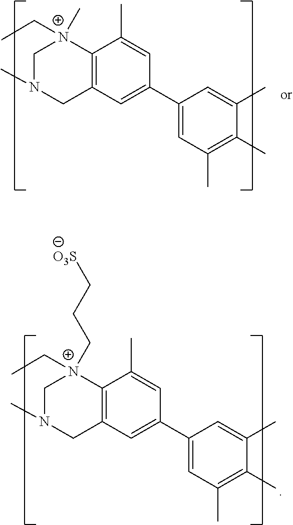

19. The membrane of claim 1, wherein the polyamine polymer is

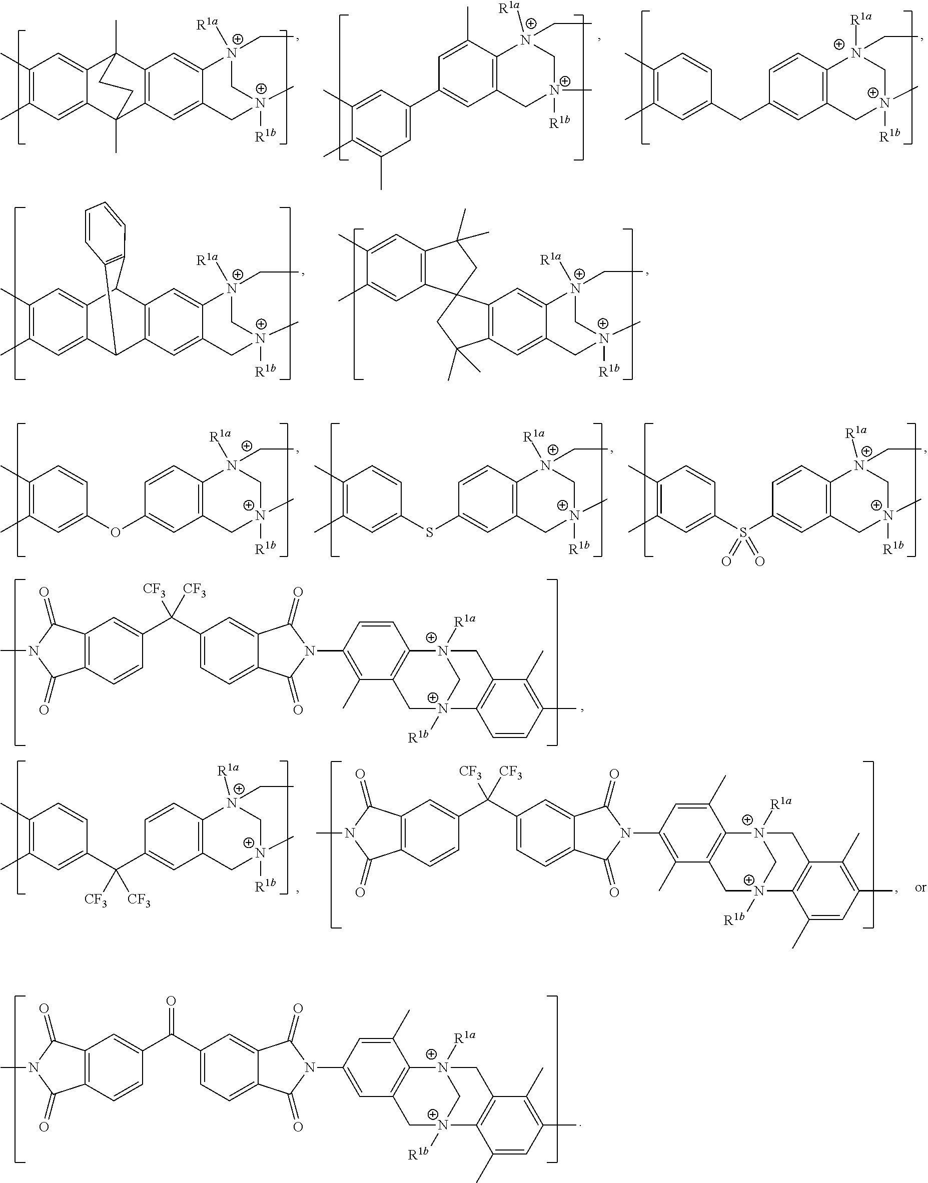

20. The membrane of claim 1, wherein the polyamine polymer is 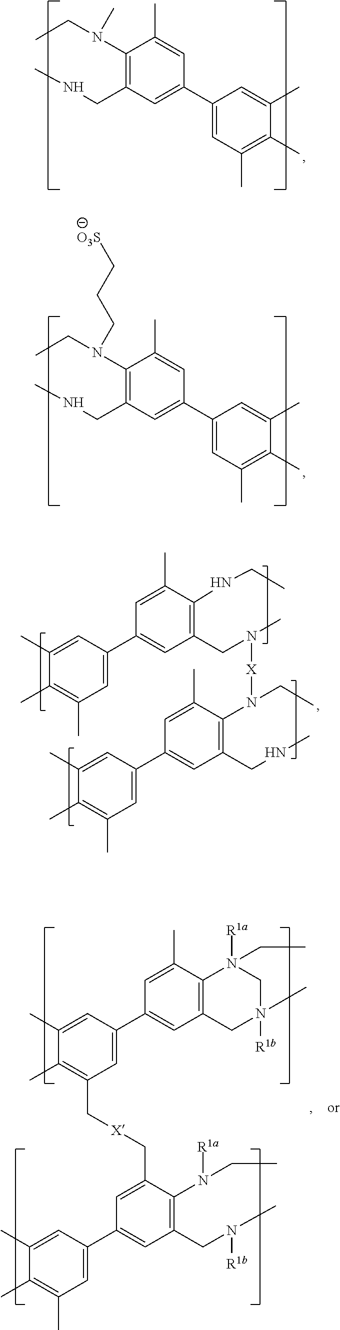 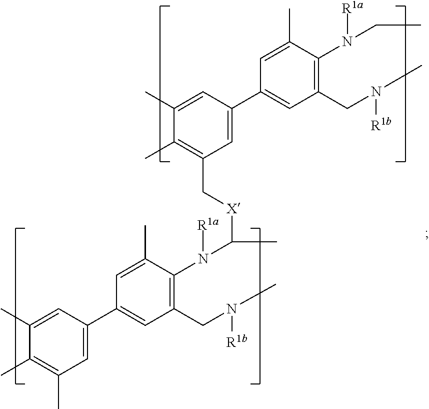
wherein
X is 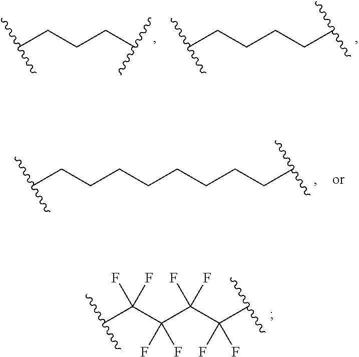 [SMILES: *CCC* ; *CCCC* ; *CCCCCCCC* ; *C(F)(F)C(F)(F)C(F)(F)C(*)(F)F]
and
X′ is

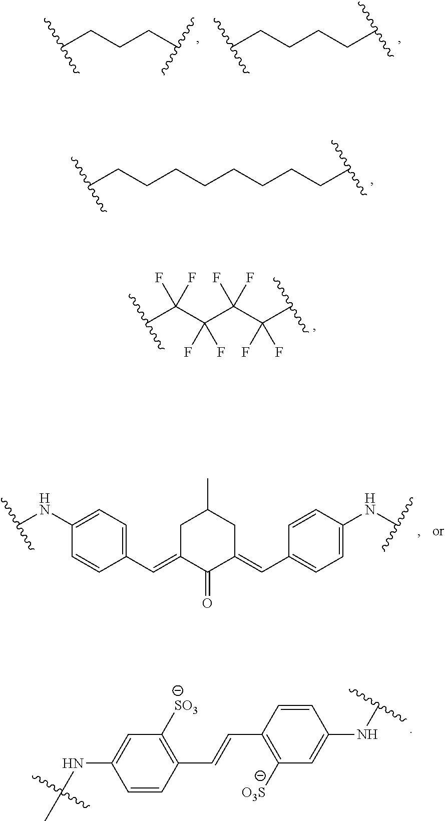

21. The membrane of claim 1, wherein the polyamine polymer is

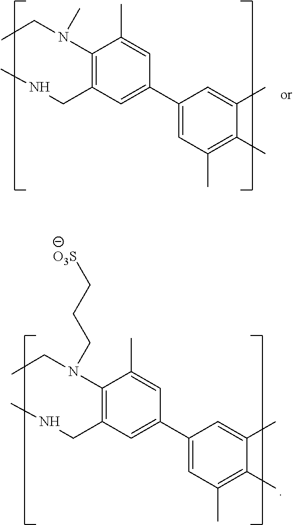

22. The membrane of claim 1, wherein the polyamine polymer is

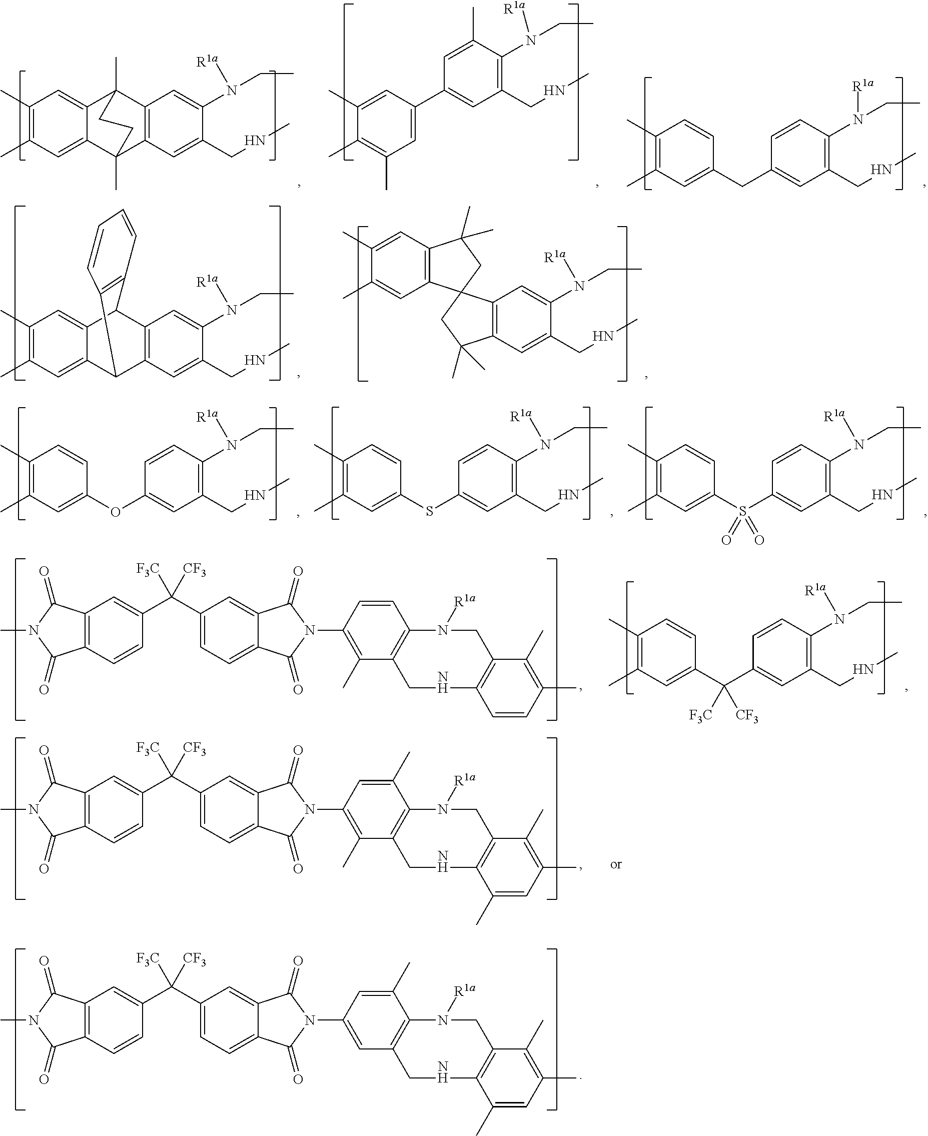

23. The membrane of claim 1, wherein the polyamine polymer membrane is a composite with a metal oxide.

24. The membrane of claim 1, wherein the polyamine polymer membrane is a composite with manganese dioxide.

25. A composition comprising a polyamine polymer of Formula J: 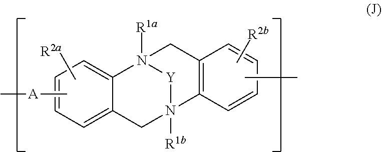
wherein:
Y is absent or —CH₂—;
R^{1a} and R^{1b} are each independently absent, hydrogen, C₁₋₆ alkyl, -L¹-S(O)₂O⁻, -L¹-C(O)O⁻, or -L¹-P(O)₂O⁻, such that at least one of R^{1a} and R^{1b} is C₁₋₆ alkyl, -L¹-S(O)₂O⁻, -L¹-C(O)O⁻, or -L¹-P(O)₂O⁻;
each L¹ is independently C₁₋₆ alkylene;
alternatively, R^{1a} and R^{1b} on different polymers can combine to form a crosslinker;
R^{2a} and R^{2b} are each independently C₁₋₆ alkyl or C(O)O⁻;
alternatively, R^{2a} and R^{2b} on different polymers can combine to form a crosslinker; and
A is a bond, optionally substituted C₁₋₆ alkylene, urethane, amide, sulfone, ester, ether, a linker, or combined with the adjacent rings to form an optionally substituted C₆₋₂₀ bicyclic cycloalkyl.

26. The composition of claim 25, wherein:
R^{1a} and R^{1b} are each independently absent, hydrogen, C₁₋₃ alkyl, or -L¹-S(O)₂O⁻, and L¹ is a C₂₋₄ alkylene;
alternatively, R^{1a} and R^{1b} on different polymers can combine to form a crosslinker, wherein the crosslinker is C₃₋₁₀ alkylene or C₃₋₁₀ haloalkylene.

27. The composition of claim 25, wherein:
R^{1a} and R^{1b} are each independently absent, hydrogen, methyl, or —CH₂CH₂CH₂S(O)₂O⁻;
alternatively, R^{1a} and R^{1b} on different polymers can combine to form a crosslinker, wherein the crosslinker is

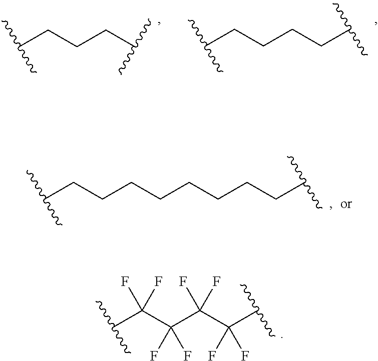 [SMILES: *CCC* ; *CCCC* ; *CCCCCCCC* ; *C(F)(F)C(F)(F)C(F)(F)C(*)(F)F]

28. The composition of claim 25, wherein:
R^{1a} and R^{1b} on different polymers combine to form a crosslinker, wherein the crosslinker is 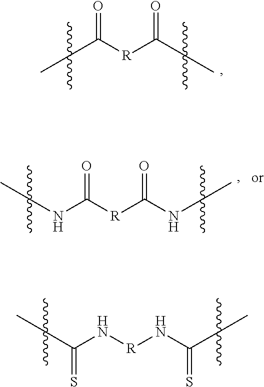
wherein R is C₂₋₁₀ alkyl, poly(ethylene glycol), aryl or heteroaryl.

29. The composition of claim 25, wherein:
R^{1a} and R^{1b} are each independently a hydrogen atom, methyl, or —CH₂CH₂CH₂S(O)₂O⁻;
alternatively, R^{1a} and R^{1b} on different polymers can combine to form a crosslinker, wherein the crosslinker is 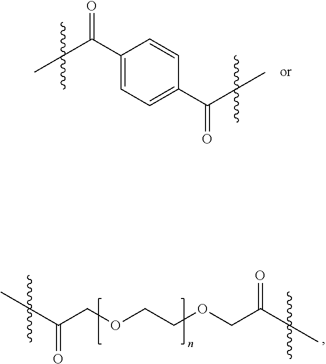
wherein n=1-12.

30. The composition of claim 25, wherein:
R^{2a} and R^{2b} are each independently C₁₋₃ alkyl;
alternatively, R^{2a} and R^{2b} on different polymers can combine to form a crosslinker, wherein the crosslinker is C₃₋₁₀ alkylene, C₃₋₁₀ haloalkylene,

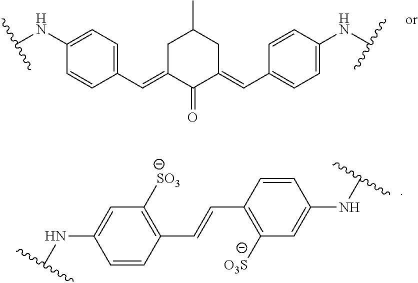

31. The composition of claim 25, wherein:
R^{2a} and R^{2b} are each independently methyl;
alternatively, R^{2a} and R^{2b} on different polymers can combine to form a crosslinker, wherein the crosslinker is

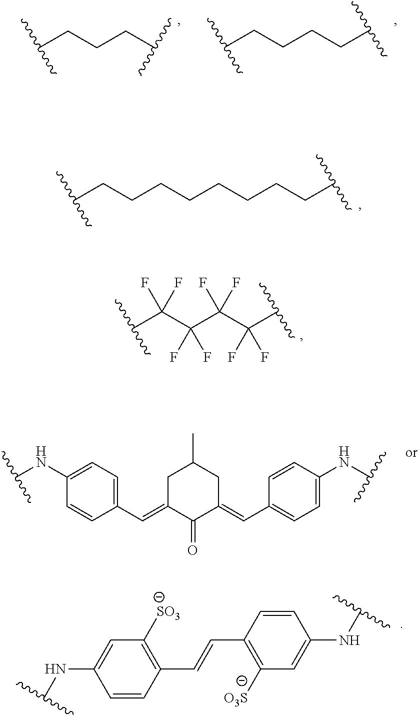

32. The composition of claim 25, wherein A is a bond, methylene, ethylene, propylene, butylene, urethane, amide, sulfone, ester, ether, 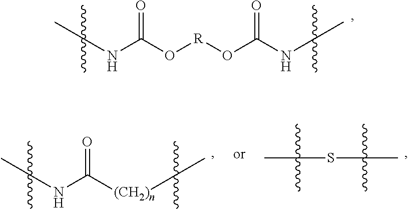
and
wherein R is a C₁₋₁₂ alkylene, and n is 0 to 20.

33. The composition of claim 25, wherein A is a bond, sulfone, ester, ether, 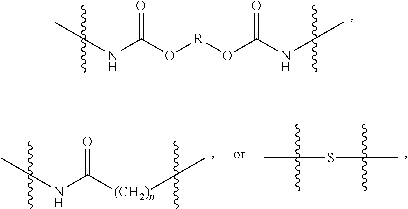
and
wherein R is a C₁₋₁₂ alkylene, and n is 0 to 20.

34. The composition of claim 25, wherein the polyamine polymer is 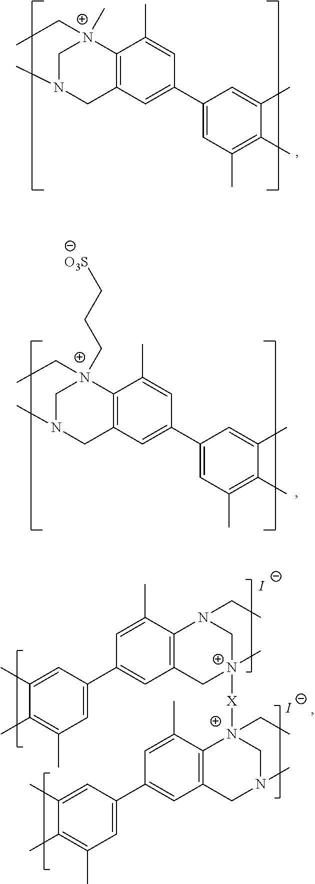 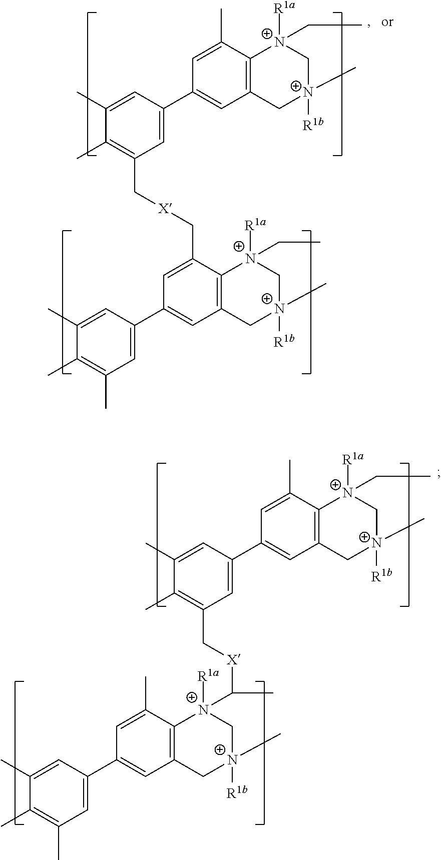
and
wherein
X is 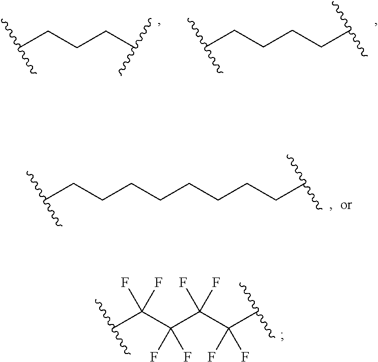 [SMILES: *CCC* ; *CCCC* ; *CCCCCCCC* ; *C(F)(F)C(F)(F)C(F)(F)C(*)(F)F]
and
X′ is

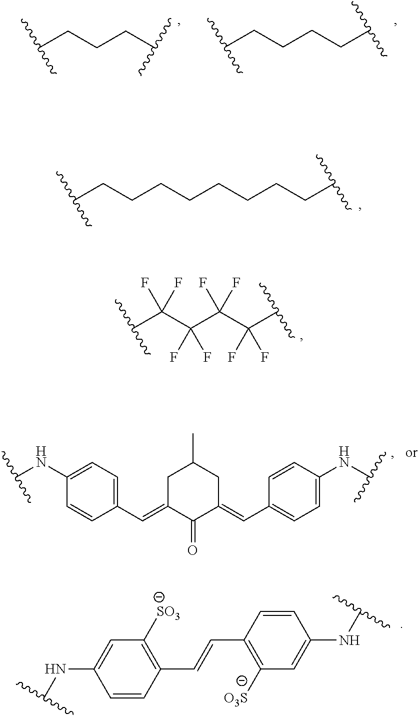

35. The composition of claim 25, wherein the polyamine polymer is

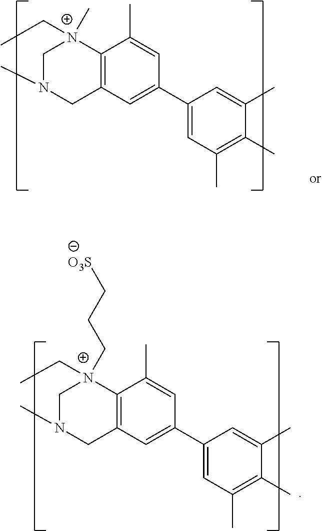

36. The composition of claim 25, wherein the polyamine polymer is

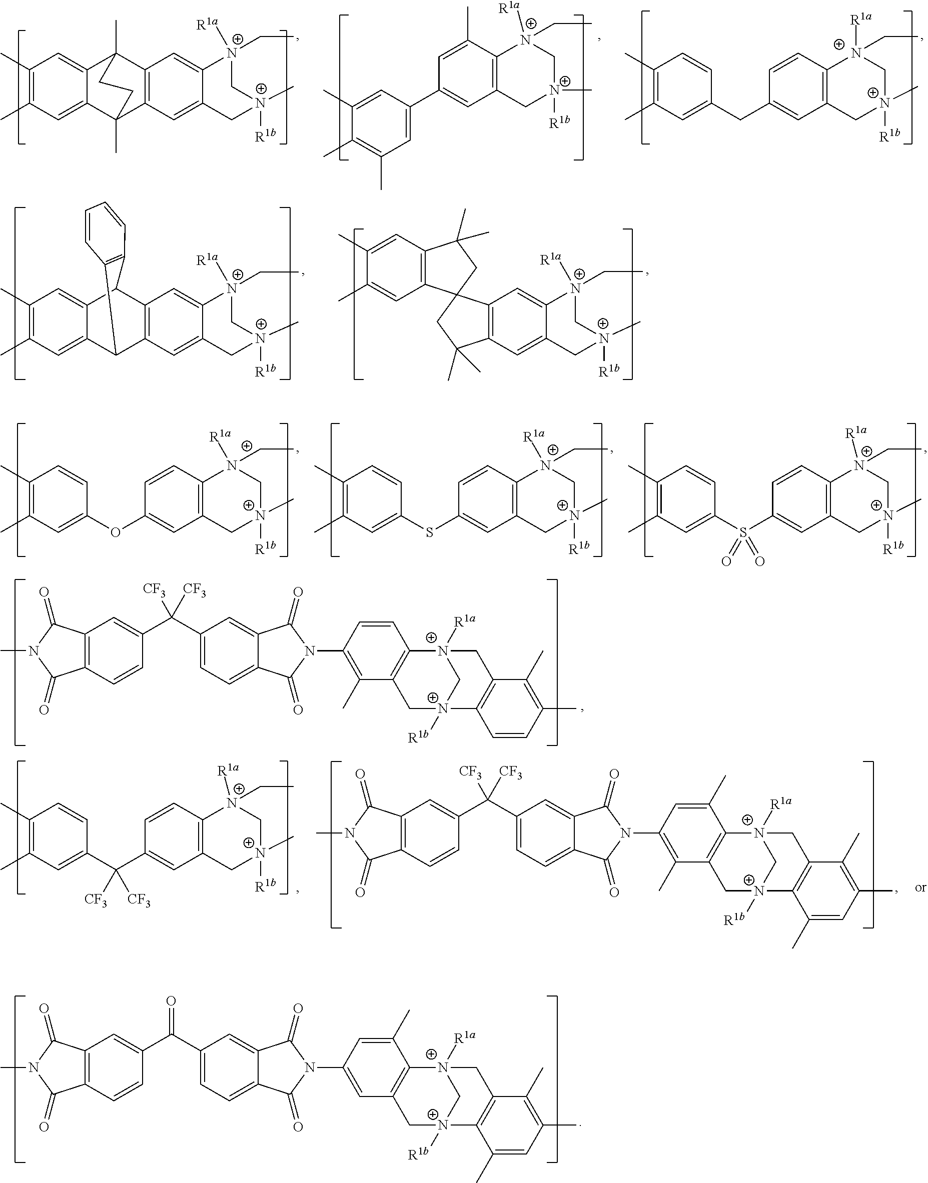

37. The composition of claim 25, wherein the polyamine polymer is 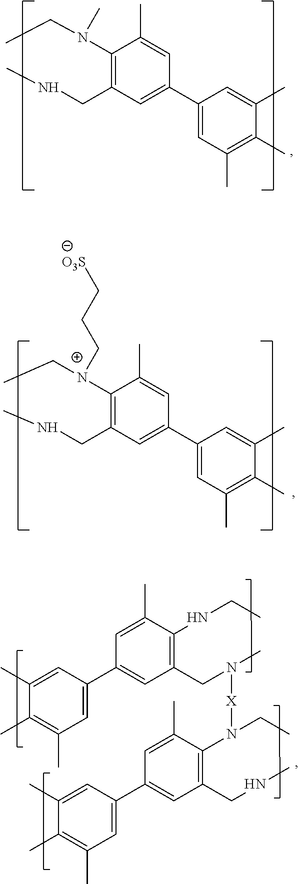 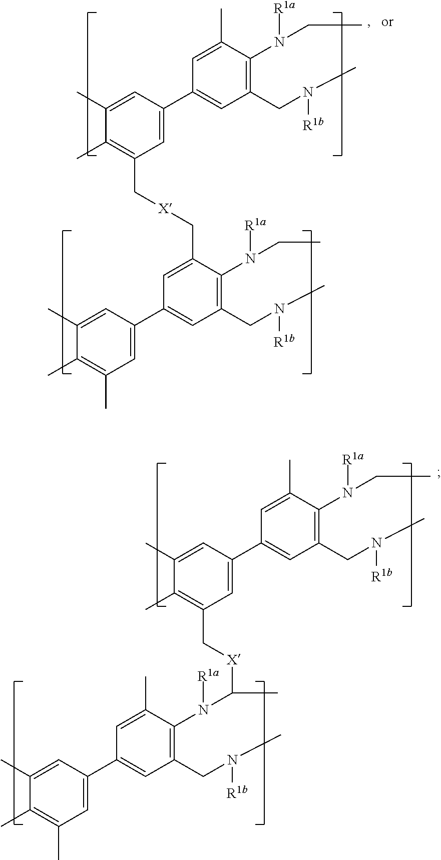
wherein:
X is 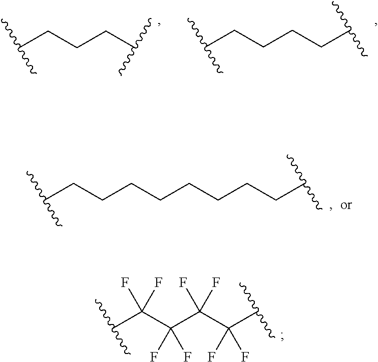 [SMILES: *CCC* ; *CCCC* ; *CCCCCCCC* ; *C(F)(F)C(F)(F)C(F)(F)C(*)(F)F]
and
X′ is

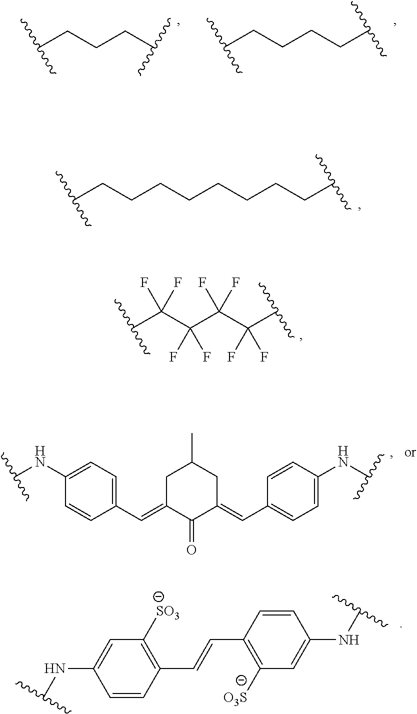

38. The composition of claim 25, wherein the polyamine polymer is

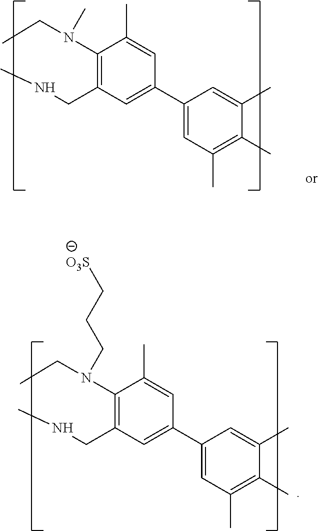

39. The composition of claim 25, wherein the polyamine polymer is

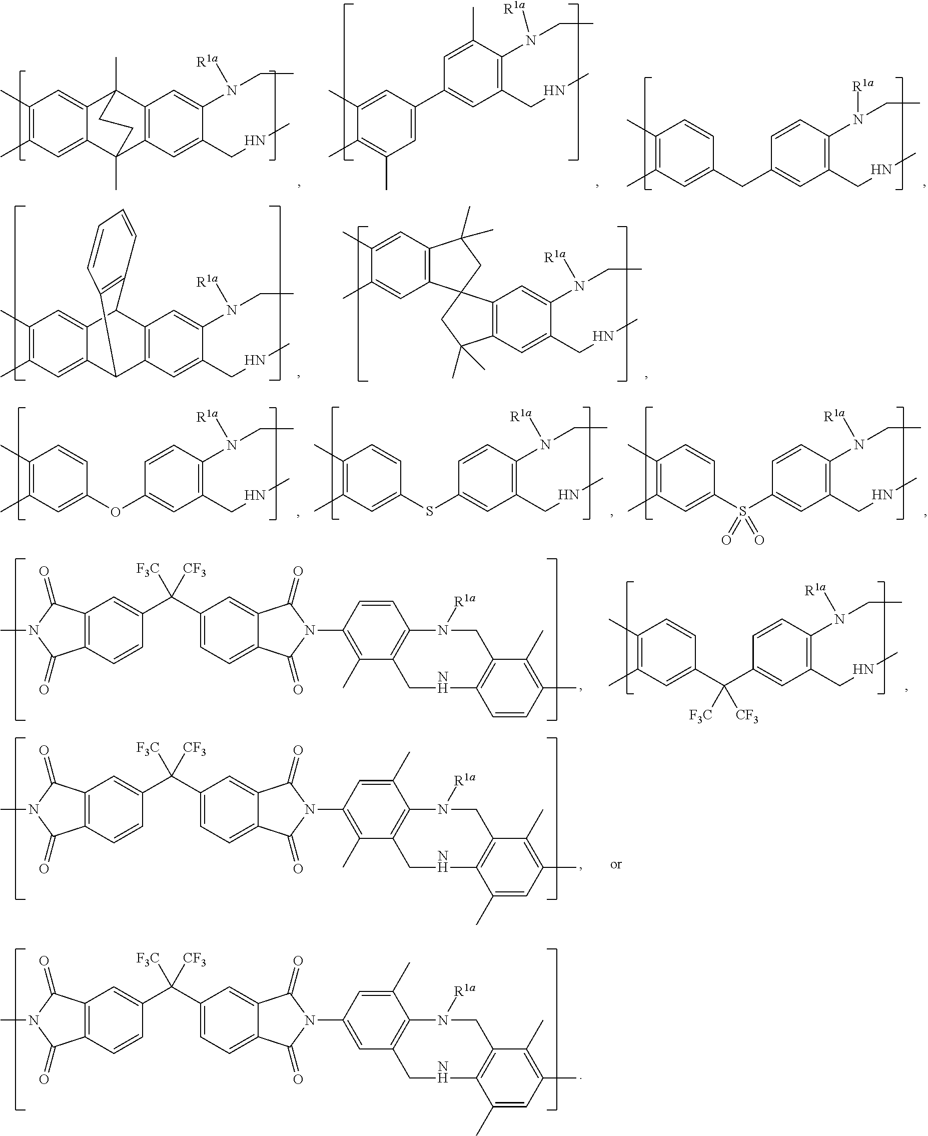

40. (canceled)

41. An electrochemical cell comprising:
a) a posolyte comprising a positive electrode active material dissolved in an electrolyte;
b) a negolyte comprising a polysulfide compound dissolved in an electrolyte;
c) an ion-permeable membrane configured to electrically insulate the negolyte from the posolyte; and
d) wherein the membrane comprises:
(i) a polymer;
(ii) a protective layer disposed on a posolyte side of the polymer and configured to reduce oxidation of the polymer by the positive electrode active material; and
(iii) wherein the protective layer comprises manganese oxide.

42. An electrochemical cell comprising:
a) a posolyte comprising a positive electrode active material dissolved in an electrolyte;
b) an negolyte comprising a polysulfide compound dissolved in an electrolyte;
c) an ion-permeable membrane configured to electrically insulate the negolyte from the posolyte; and
d) wherein the membrane comprises an anion exchange membrane (AEM), a cation exchange membrane (CEM), a zwitterionic membrane, a porous membrane with average pore diameter smaller than 10 nanometers, a polybenzimidazole-based membrane, a polysulfone-based membrane, a polyetherketone-based membrane, a membrane including polymers of intrinsic microporosity (PIM), or a combination thereof.

43. An electrochemical cell comprising:
a) a posolyte comprising a positive electrode active material dissolved in an electrolyte; wherein the positive electrode active material comprises a manganese-based compound;
b) a negolyte comprising a polysulfide compound dissolved in an electrolyte;
c) an ion-permeable membrane configured to electrically insulate the negolyte from the posolyte; and
d) wherein the membrane comprises:
(i) a composite membrane comprising an inorganic material and an organic material; and
(ii) wherein the organic material comprises a polyether ether ketone (PEEK), a polysulfone, a polystyrene, a polypropylene, a polyethylene, or any combination thereof.
